(19) United States
(12) Patent Application Publication
(10) Pub. No.: US 2024/0397159 A1
(43) Pub. Date: Nov. 28, 2024

(54) SERVER AND METHOD

(71) Applicant: 17LIVE Japan Inc., Tokyo (JP)

(72) Inventors: Takeru KURASHIGE, Tokyo (JP); Ayano HASEGAWA, Tokyo (JP)

(21) Appl. No.: 18/524,701

(22) Filed: Nov. 30, 2023

(30) Foreign Application Priority Data
May 23, 2023 (JP) 2023-084724
Jun. 9, 2023 (JP) 2023-095587

(51) Int. Cl. H04N 21/478; G06Q 30/0207; G06Q 30/0601; H04N 21/2187; H04N 21/4784

(52) U.S. Cl. CPC H04N 21/47815; G06Q 30/0222; G06Q 30/0601; H04N 21/2187; H04N 21/4784

(57) ABSTRACT

Live commerce can be livened up by relating the e-commerce function and the livestreaming function in live commerce. A server is provided for providing a livestream where a livestreamer presents and takes an order for an item for sale and receives a gift from a viewer. The server includes a circuitry configured to enable a viewer to use a special gift different from a regular gift on condition that the viewer performs an operation to order an item for sale.

### CROSS-REFERENCE TO RELATED APPLICATIONS

This application is based on and claims the benefit of priority from Japanese Patent Applications Serial Nos. 2023-084724 (filed on May 23, 2023) and 2023-095587 (filed on Jun. 9, 2023), the contents of which are hereby incorporated by reference in its entirety.

### TECHNICAL FIELD

The present disclosure relates to a server and a method.

### BACKGROUND

Live commerce (also referred to as livestream shopping) is a new style of customer service and sales based on combination of livestreaming and e-commerce (EC).

Live commerce can offer users opportunities to experience shopping at brick-and-mortar shops irrespective of where the users are actually are (see International Publication No. WO 2021/106034 (“the '034 Publication”) and Japanese Patent Application Publication No. 2019-109785 (“the '785 Publication”), and “About Live Commerce”, SHOWROOM Inc, URL: https://support.showroom-live.com/hc/ja/articles/900006084866-% E3%83% A9% E3%82% A4% E3%83%96% E3%82% B3% E3%83%9E % E3%83% BC % E3%82% B9% E3%81% AB % E3%81% A4% E3%81%84% E3%81% A6).

According to the technology described in “About Live Commerce”, SHOWROOM Inc, URL: https://support.showroom-live.com/hc/ja/articles/900006084866-% E3%83% A9% E3%82% A4% E3%83%96% E3%82% B3% E3%83%9E % E3%83% BC % E3%82% B9% E3%81% AB % E3%81% A4% E3%81%84% E3%81% A6, once a viewer completes a purchase of a product in a livestream delivered by a liver, the livestream screen show effects and comment logs. This can notify the liver of that the viewer has purchased the product.

According to the conventional live commerce, a single livestreamer delivers a livestream to sell products.

According to the technology disclosed in “About Live Commerce”, SHOWROOM Inc, URL: https://support.showroom-live.com/hc/ja/articles/900006084866-% E3%83% A9% E3%82% A4% E3%83%96% E3%82% B3% E3%83%9E % E3%83% BC % E3%82% B9% E3%81% AB % E3%81% A4% E3%81%84% E3%81% A6, however, the e-commerce function is independent of the function of livening up livestreams such as the gifting function. Since the e-commerce function stands alone, this conventional technology does not fully exploit the characteristics of the live commerce, i.e., the fact that the e-commerce is taking place in livestreams.

The present disclosure has been made in view of the above, and one object of the disclosure is to provide a technique for livening up the live commerce by relating the e-commerce function and the livestreaming function in the live commerce.

The inventors of the present invention have also located the following issues. Livestreaming can connect livestreamers without being obstructed by the fact that they are physically located at separate places (see, for example, “How to use the ‘VS Function’!”, 17LIVE Corporation, URL: https://jp.17.live/userguide/19206/and “Free group call feature “Group Call” that allows up to 6 people to participate is finally available!, 17LIVE Corporation, URL: https://jp.17.live/news/11655/). Live commerce has not been able to take full advantage of this feature of livestreaming.

### SUMMARY

The present disclosure has been made in view of the above, and one object of the disclosure is to provide a technique for making live commerce more enjoyable by promoting interactions between livestreamers in live commerce.

One aspect of the disclosure relates to a server. The server provides a livestream where a livestreamer presents and takes an order for an item for sale and receives a gift from a viewer. The server includes a circuitry configured to enable a viewer to use a special gift different from a regular gift on condition that the viewer performs an operation to order an item for sale.

Another aspect of the disclosure relates to a non-transitory computer-readable storage medium storing a computer program. The computer program is provided for use in a terminal of a viewer watching a livestream where a livestreamer presents and takes an order for an item for sale and receives a gift from the viewer. The computer program is configured to cause the terminal to implement functions of: receiving an operation performed to order an item for sale; and notifying, in response to receiving the operation performed to order the item for sale, the viewer that the viewer is enabled to use a special gift different from a regular gift.

Another aspect of the disclosure relates to a non-transitory computer-readable storage medium storing a computer program. The computer program is provided for use in a terminal of a viewer watching a livestream where a livestreamer presents and takes an order for an item for sale and receives a gift from the viewer. The computer program is configured to cause the terminal to implement functions of: receiving an instruction to use a gift; and notifying, in response to receiving the instruction to use the gift, the viewer that the viewer is given a coupon available for an item for sale presented in a livestream.

Another aspect of the disclosure relates to a server. The server is provided for a livestream system where a first livestream and a second livestream are delivered by a same livestreamer at different times, the first livestream being designed to present and take an order for an item for sale, the first and second livestreams being different from each other. The server includes a circuitry configured to grant to a viewer, in either the first or second livestream, a digital item that is available in the other livestream.

Another aspect of the disclosure relates to a non-transitory computer-readable storage medium storing a computer program. The computer program is provided for use in a terminal of a viewer watching a first livestream where a livestreamer presents and takes an order for an item for sale. The computer program is configured to cause the terminal to implement functions of: receiving an operation performed to order an item for sale; and notifying, in response to receiving the operation performed to order the item for sale, the viewer that the viewer is given a gift available in a second livestream different from the first livestream but delivered by the livestreamer who delivers the first livestream.

Another aspect of the disclosure relates to a non-transitory computer-readable storage medium storing a computer program. The computer program is provided for use in a terminal of a viewer watching a second livestream where a livestreamer receives a gift from the viewer. The computer program is configured to cause the terminal to implement functions of: receiving an instruction to use a gift; and notifying, in response to receiving the instruction to use the gift, the viewer that the viewer is given a coupon available for an item for sale presented in a first livestream different from the second livestream but delivered by the livestreamer who delivers the second livestream.

One aspect of the disclosure relates to a non-transitory computer-readable storage medium storing a computer program. The computer program causes a terminal to implement a function of displaying a livestreaming screen including: a first area displaying a video image of a first livestream associated with a first item for sale; a second area displaying a video image of a second livestream associated with a second item for sale that is same as or equivalent to the first item for sale; a third area displaying a first benchmark and a second benchmark in association with each other, the first benchmark indicating a volume of orders placed for the first item for sale via the first livestream, the second benchmark indicating a volume of orders placed for the second item for sale via the second livestream; and an object for ordering the first or second item for sale.

Another aspect of the disclosure relates to a server. The server includes: a unit for relaying video data relating to a first livestream associated with a first item for sale from a first livestreamer terminal to a viewer terminal and relaying video data related to a second livestream associated with a second item for sale that is same as or equivalent to the first item for sale from a second livestreamer terminal to the viewer terminal; a unit for updating a first benchmark if an operation to order the first item for sale via the first livestream is detected and updating a second benchmark if an operation to order the second item for sale via the second livestream is detected; and a unit for determining, if a predetermined end condition is satisfied, a result of a competition based on the first and second benchmarks.

Another aspect of the disclosure relates to a non-transitory computer-readable storage medium storing a computer program. The computer program causes a terminal to implement a function of displaying on a display a screen including: a first area displaying a plurality of video images of a plurality of livestreamers in a predetermined layout; and an object for ordering an item for sale.

Another aspect of the disclosure relates to a server. The server includes: a unit for receiving a request, from a terminal of a livestreamer over a network, to request that an invitation is to be transmitted to another livestreamer to allow the other livestreamer and the livestreamer to deliver a livestream together via a same screen; and a unit for designating an item for sale associated with the same screen.

Another aspect of the disclosure relates to a server. The server includes: a unit for delivering a livestream associated with an item for sale; and a unit for generating a leaderboard based on a benchmark indicating a volume of orders for an item for sale via a livestream by ranking livestreamers for each item for sale or each seller of an item for sale.

It should be noted that the components described throughout this disclosure may be interchanged or combined. The components, features, and expressions described above may be replaced by devices, methods, systems, computer programs, recording media containing computer programs, etc. Any such modifications are intended to be included within the spirit and scope of the present disclosure.

### Advantageous Effects

The present disclosure can liven up live commerce by relating the e-commerce function and the livestreaming function in live commerce. In addition, the present disclosure can make live commerce more enjoyable by promoting interactions between livestreamers in live commerce.

### BRIEF DESCRIPTION OF THE DRAWINGS

FIG. 1 schematically illustrates a configuration of a live commerce system according to a first embodiment.

FIG. 2 is a block diagram showing functions and configuration of a livestreamer mobile terminal shown in FIG. 1.

FIG. 3 is a block diagram showing functions and configuration of a livestreamer control terminal shown in FIG. 1.

FIG. 4 is a block diagram showing functions and configuration of a viewer terminal shown in FIG. 1.

FIG. 5 is a block diagram showing functions and configuration of a LC server shown in FIG. 1.

FIG. 6 is a data structure diagram of an example of a livestreaming information holding unit of FIG. 5.

FIG. 7 is a data structure diagram of an example of a comment history holding unit of FIG. 5.

FIG. 8 is a data structure diagram of an example of a sent effect history holding unit of FIG. 5.

FIG. 9 is a data structure diagram of an example of a user information holding unit of FIG. 5.

FIG. 10 is a data structure diagram of an example of a gift information holding unit of FIG. 5.

FIG. 11 is a data structure diagram of an example of a share history holding unit of FIG. 5.

FIG. 12 is a data structure diagram of an example of an add-to-cart history holding unit of FIG. 5.

FIG. 13 is a data structure diagram of an example of a coupon information holding unit of FIG. 5.

FIG. 14 is a flow chart showing a series of steps performed in the LC server when a special gift is given to a viewer in an LC livestream.

FIG. 15 is a representative screen image of a livestreaming screen on a display of a viewer terminal of a viewer.

FIG. 16 is a representative screen image of the livestreaming screen having a gift area superimposed thereon, which is shown on the display of the viewer terminal.

FIG. 17 is a representative screen image of the livestreaming screen having a pop-up notification superimposed thereon, which is shown on the display of the viewer terminal.

FIG. 18 is a representative screen image of the livestreaming screen having a gift area superimposed thereon, which is shown on the display of the viewer terminal.

FIG. 19 is a representative screen image of the livestreaming screen having an effect superimposed thereon, which is shown on the display of the viewer terminal.

FIG. 20 is a representative screen image of the livestreaming screen having a pop-up notification superimposed thereon, which is shown on the display of the viewer terminal.

FIG. 21 is a block diagram showing an example of hardware configuration of an information processing device according to the first embodiment.

FIG. 22 shows a concept of a live commerce system relating to a modification example.

FIG. 23 is a data structure diagram of an example of a livestreaming information holding unit of a managing server relating to the modification example.

FIG. 24 is a data structure diagram of an example of a user information holding unit of the managing server relating to the modification example.

FIG. 25 is a representative screen image of a livestreaming screen of an LC livestream appearing on the display of a viewer terminal of a viewer in the modification example.

FIG. 26 is a representative screen image of the livestreaming screen of the LC livestream appearing on the display of the viewer terminal of the viewer in the modification example.

FIG. 27 is a representative screen image of a livestreaming room screen of a non-LC livestream appearing on the display of a viewer terminal of a viewer in the modification example.

FIG. 28 is a representative screen image of the livestreaming room screen of the non-LC livestream having a gift area superimposed thereon, which appears on the display of the viewer terminal of the viewer, in the modification example.

FIG. 29 is a representative screen image of the livestreaming room screen of the non-LC livestream having an effect superimposed thereon, which appears on the display of the viewer terminal of the viewer, in the modification example.

FIG. 30 is a representative screen image of the livestreaming room screen of the non-LC livestream appearing on the display of the viewer terminal of the viewer in the modification example.

FIG. 31 is a representative screen image of the livestreaming room screen of the non-LC livestream having a notification image superimposed thereon, which appears on the display of the viewer terminal of the viewer, in the modification example.

FIG. 32 is a representative screen image of the livestreaming screen of the LC livestream appearing on the display of the viewer terminal of the viewer in the modification example.

FIG. 33 schematically illustrates a configuration of a live commerce system according to a second embodiment.

FIG. 34 is a block diagram showing functions and configuration of a user terminal of FIG. 33.

FIG. 35 is a block diagram showing functions and configuration of an LC server shown in FIG. 33.

FIG. 36 is a data structure diagram of an example of a livestreaming information holding unit of FIG. 35.

FIG. 37 is a data structure diagram of an example of a user information holding unit of FIG. 35.

FIG. 38 is a data structure diagram of an example of a VS information holding unit of FIG. 35.

FIG. 39 is a data structure diagram of an example of an event information holding unit of FIG. 35.

FIG. 40 is a data structure diagram of an example of a sales history holding unit of FIG. 35.

FIG. 41 is a data structure diagram of an example of a leaderboard information holding unit of FIG. 35.

FIG. 42 is a flowchart showing a series of steps performed for a VSLC livestream.

FIG. 43 is a representative screen image of a VSLC livestream setting screen displayed on the display of a user terminal of a livestreamer.

FIG. 44 is a representative screen image of a simultaneous LC livestream screen displayed on the display of a user terminal of a viewer of a VSLC livestream.

FIG. 45 is a representative screen image of the simultaneous LC livestream screen having an object indicating a result of a competition superimposed thereon, which appears on the display of the user terminal of the viewer of the VSLC livestream.

FIG. 46 is a representative screen image of an LC livestream screen appearing on a display of a user terminal of a viewer.

FIG. 47 is a representative screen image of a leaderboard display screen appearing on the display of a user terminal of a user.

FIG. 48 is a representative screen image of a group call LC livestream setting screen appearing on the display of a user terminal of a livestreamer.

FIG. 49 is a representative screen image of a simultaneous LC livestream screen appearing on the display of a user terminal of a viewer of a group call LC livestream.

### DESCRIPTION OF THE PREFERRED EMBODIMENTS

Like elements, components, processes, and signals throughout the figures are labeled with same or similar designations and numbering, and the description for the like elements will not be hereunder repeated. For purposes of clarity and brevity, some of the components that are less related and thus not described are not shown in the figures.

### First Embodiment

In a live commerce system relating to a first embodiment, a livestream is delivered for the purpose of selling goods and/or services (hereinafter simply referred to as the item for sale) (hereinafter the livestream is referred to as an LC livestream) with a gifting function being realized in addition to the e-commerce function. The gifting function allows a user to give a gift to a livestreamer. A viewer of an LC livestream may perform an operation to place an order for the item for sale. If this operation is detected, the viewer is allowed to use a special gift different from a regular gift. If a viewer uses a particular gift within an LC livestream, the viewer receives a coupon that is available in this LC livestream. These will motivate the viewer to purchase the item for sale in the LC livestream and to give a gift, making the LC livestream more exciting and enjoyable.

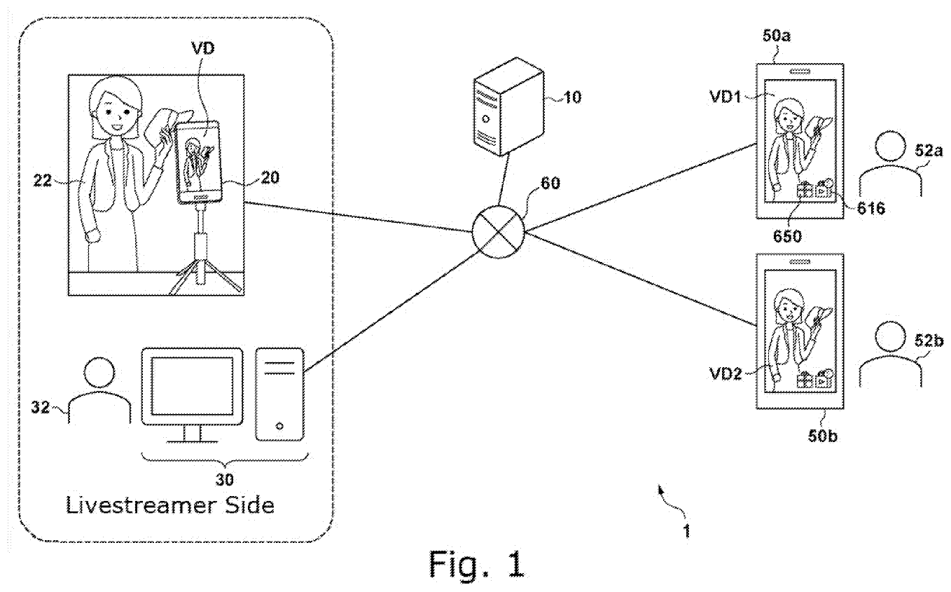

FIG. 1 schematically illustrates a configuration of a live commerce system 1 according to a first embodiment. The live commerce system 1 includes a live commerce (LC) server 10, a livestreamer mobile terminal 20 constituting the livestreamer side, a livestreamer control terminal 30 constituting the livestreamer side, viewer terminals 50 (50a, 50b, . . . ) on the audience (52a, 52b, . . . ) side. The livestreamer and viewers may be collectively referred to as users. The LC server 10, the livestreamer mobile terminal 20, livestreamer control terminal 30, and viewer terminals 50 are interconnected so as to be able to communicate with each other over a network 60 such as the Internet. The LC server 10 may be one or more information processing devices connected to the network 60. The livestreamer mobile terminal 20 may be, for example, a mobile terminal device such as a smartphone, a tablet, a laptop PC, a recorder, a portable gaming device, and a wearable device. The livestreamer control terminal 30 may be a stationary device such as a desktop PC. The viewer terminals 50 may be, for example, mobile terminal devices such as smartphones, tablets, laptop PCs, recorders, portable gaming devices, and wearable devices, or may be stationary devices such as desktop PCs.

The livestreamer mobile terminal 20 and livestreamer control terminal 30 constitute the terminals on the livestreamer side. As for the livestreamer side, a livestreamer 22 faces the livestreamer mobile terminal 20 and presents an item for sale, and a livestream controller 32 controls the content of an LC livestream using the livestreamer control terminal 30. While the livestreamer side includes the livestreamer 22 and livestream controller 32 in the first embodiment, a single livestreamer may use a single terminal to deliver an LC livestream in other embodiments. In this case, the capability of the livestreamer control terminal 30 described below may be performed by the livestreamer mobile terminal 20.

The LC server 10 provides an LC livestream where the livestreamer side can present an item for sale and take orders for it and can receive gifts from the viewers 52. While an LC livestream is taking place, the LC server 10 collects history data, i.e., responses made by the viewer side, such as what comments are made, what is shared, what is added to the cart and the like. The livestream controller 32 determines how to present the item for sale and directs the livestreamer 22 during the LC livestream.

As used herein, the term “livestreaming” or “livestream” may mean a mode of data transmission that allows a content recorded at the livestreamer mobile terminal 20 to be played and viewed at the viewer terminal 50 substantially in real time, or it may mean a live broadcast realized by such a mode of transmission. The livestreaming may be achieved using existing livestreaming technologies such as HTTP Live Streaming, Common Media Application Format, Web Real-Time Communications, Real-Time Messaging Protocol and MPEG DASH. The livestreaming includes a transmission mode in which, while the livestreamer is recording contents, the viewers can view the contents with a certain delay. The delay is acceptable as long as interaction between the livestreamer and the viewers can be at least established. Note that the livestreaming is distinguished from so-called on-demand type transmission, in which contents are entirely recorded and the entire data is once stored on the server, and the server provides users with the data at any subsequent time upon request from the users.

The term “video data” herein refers to data that includes image data (also referred to as moving image data) generated using an image capturing function of the livestreamer mobile terminal 20 and audio data generated using an audio input function of the livestreamer mobile terminal 20. Video data is reproduced in the viewer terminal 50, so that the viewer can view contents. In this embodiment, it is assumed that between video data generation at the livestreamer mobile terminal 20 and video data reproduction at the viewer terminal 50, processing is performed onto the video data to change its format, size, or specifications of the data, such as compression, decompression, encoding, decoding, or transcoding. However, such processing does not substantially change the content (e.g., video images and audios) represented by the video data, so that the video data after such processing is herein described as the same as the video data before such processing. In other words, when video data is generated at the livestreamer mobile terminal 20 and then played back at the viewer terminal 50 via the server 10, the video data generated at the livestreamer mobile terminal 20, the video data that passes through the LC server 10, and the video data received and reproduced at the viewer terminal 50 are all the same video data.

In the example in FIG. 1, the livestreamer 22 presents an item for sale in an LC livestream. The livestreamer mobile terminal 20 of the livestreamer 22 generates video data by recording images and sounds of the livestreamer 22, and the generated data is transmitted to the LC server 10 over the network 60. At the same time, the livestreamer mobile terminal 20 and livestreamer control terminal 30 display the recorded video image VD of the livestreamer 22 on their display to allow the livestreamer side (livestreamer 22 and livestream controller 32) to check what is livestreamed.

The viewer terminals 50a and 50b of the viewers 52a and 52b respectively, who have requested the platform to enable them to view the LC livestream delivered by the livestreamer 22, receive video data related to the LC livestream over the network 60 and reproduce the received video data, to display video images VD1 and VD2 on the displays and output audio through the speakers. The video images VD1 and VD2 displayed at the viewer terminals 50a and 50b, respectively, are substantially the same as the video image VD captured by the livestreamer mobile terminal 20 of the livestreamer 22, and the audio outputted at the viewer terminals 50a and 50b is substantially the same as the audio recorded by the livestreamer mobile terminal 20 of the livestreamer 22.

Recording of the images and sounds at the livestreamer mobile terminal 20 of the livestreamer 22 and reproduction of the video data at the viewer terminals 50a and 50b of the viewers 52a and 52b are performed substantially simultaneously. The viewer 52a may type a question on the viewer terminal 50a about the item for sale presented by the livestreamer 22. The LC server 10 may display in real time the question on the livestreamer mobile terminal 20 of the livestreamer 22 and the livestreamer control terminal 30 of the livestream controller 32 and also display the question on the viewer terminals 50a and 50b of the viewers 52a and 52b, respectively. The livestreamer 22 may answer the question, and the video and sound of the answer are output on the viewer terminals 50a and 50b of the viewers 52a and 52b, respectively. This interactive action is recognized as establishment of a conversation between the livestreamer 22 and the viewer 52a. In this way, the LC livestream enables interactive communication, not one-way communication.

On the video images VD1 and VD2 displayed at the viewer terminals 50a and 50b, superimposed are a cart icon 616 for allowing the viewers 52 to place an order for the item for sale and a gift icon 650 for allowing the viewers 52 to use a gift. Within the same LC livestream, the viewers 52 can order and purchase the item for sale by tapping the cart icon 616 and also send a gift to the livestreamer side by tapping the gift icon 650.

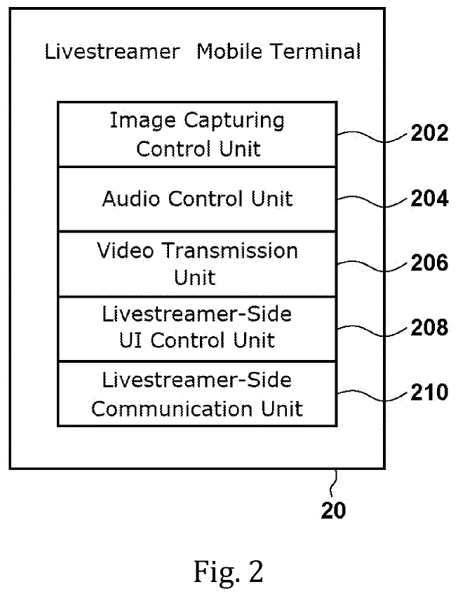

FIG. 2 is a block diagram showing functions and configuration of the livestreamer mobile terminal 20 of FIG. 1. The blocks in FIG. 2 and the subsequent block diagrams may be realized by elements such as a computer CPU or a mechanical device in terms of hardware, and can be realized by a computer program or the like in terms of software. The blocks shown in the drawings are, however, functional blocks realized by cooperative operation between hardware and software. Therefore, it is understood by those skilled in the art that these functional blocks can be realized in various forms by combining hardware and software.

The livestreamer 22 downloads and installs an application program onto the livestreamer mobile terminal 20 from a download site over the network 60. Alternatively, the application program may be pre-installed on the livestreamer mobile terminal 20. When the application program is executed on the livestreamer mobile terminal 20, the livestreamer mobile terminal 20 communicates with the LC server 10 over the network 60 to implement various functions. Hereinafter, the functions implemented by (processors such as CPUs of) the livestreamer mobile terminal 20 by running the application program will be described as functions of the livestreamer mobile terminal 20. These functions are realized in practice by the application program on the livestreamer mobile terminal 20. In any other embodiments, these functions may be realized by a computer program written in a programming language such as HTML (HyperText Markup Language), which is transmitted from the LC server 10 to web browsers of the livestreamer mobile terminal 20 over the network 60 and executed by the web browsers. Similarly, the livestream controller 32 installs the application program on the livestreamer control terminal 30, and the viewer installs the application program on the viewer terminal 50.

The livestreamer mobile terminal 20 generates video data by recording images and sounds of the livestreamer 22 and provides the LC server 10 with the generated data. The livestreamer mobile terminal 20 includes an image capturing control unit 202, an audio control unit 204, a video transmission unit 206, a livestreamer-side UI control unit 208, and a livestreamer-side communication unit 210. The image capturing control unit 202 is connected to a camera (not shown in FIG. 2) and controls image capturing performed by the camera. The image capturing control unit 202 obtains image data from the camera. The audio control unit 204 is connected to a microphone (not shown in FIG. 2) and controls audio input from the microphone. The audio control unit 204 obtains audio data through the microphone. The video transmission unit 206 transmits video data including the image data obtained by the image capturing control unit 202 and the audio data obtained by the audio control unit 204 to the LC server 10 over the network 60. The video data is transmitted by the video transmission unit 206 in real time. That is, the generation of the video data by the image capturing control unit 202 and the audio control unit 204, and the transmission of the generated video data by the video transmission unit 206 are performed substantially at the same time.

The livestreamer-side UI control unit 208 controls a UI for the livestreamer 22. The livestreamer-side UI control unit 208 is connected to a display (not shown in FIG. 2), and displays a video on the display by reproducing the video data that is to be transmitted by the video transmission unit 206. The livestreamer-side UI control unit 208 is also connected to input means (not shown in FIG. 2) such as touch panels, keyboards, and displays, and obtains the input made by the livestreamer 22 via the input means. The livestreamer-side UI control unit 208 superimposes a predetermined frame image on the video image. The frame image may include various user interface objects (hereinafter simply referred to as “objects”) for receiving inputs from the livestreamer 22, comments entered by the viewers, and information obtained from the LC server 10.

The livestreamer-side communication unit 210 controls communication with the LC server 10 during a LC livestream. The livestreamer-side communication unit 210 transmits the content of the input made by the livestreamer 22 and obtained by the livestreamer-side UI control unit 208 to the LC server 10 over the network 60. The livestreamer-side communication unit 210 receives various information associated with the LC livestream from the LC server 10 over the network 60.

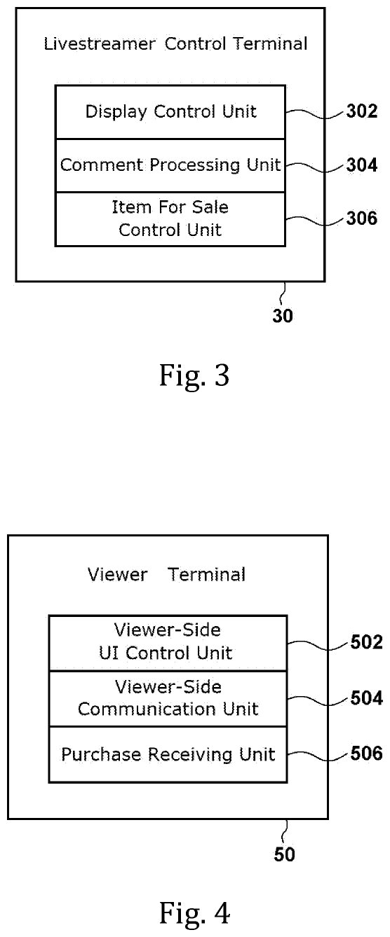

FIG. 3 is a block diagram showing functions and configuration of the livestreamer's control terminal 30 shown in FIG. 1. The livestreamer control terminal 30 works cooperatively with the livestreamer mobile terminal 20 via the network 60 to provide a LC livestream. The livestreamer control terminal 30 includes a display control unit 302, a comment processing unit 304, and an item for sale control unit 306.

The display control unit 302 generates a livestream control screen for controlling the contents of the LC livestream and displays it on the display of the livestreamer control terminal 30. The comment processing unit 304 displays in the livestream control screen the comments entered at the viewer terminals 50 of the viewers 52 watching the LC livestream. The comment processing unit 304 receives a comment input by the livestream controller 32. The comment processing unit 304 generates a comment input signal that includes the livestreamer ID identifying the livestreamer side and the comment entered, and transmits the signal to the LC server 10 over the network 60.

The item for sale control unit 306 controls the item for sale to be presented in the LC livestream. The item for sale control unit 306 receives on the livestream control screen an instruction to start to present an item for sale, generates a presentation start request signal including an item for sale ID identifying the item for sale the livestreamer is to start presenting, and sends it to the LC server 10 via the network 60. The item for sale control unit 306 receives on the livestream control screen an instruction to terminate the presentation of the item for sale, generates a presentation termination request signal including the item for sale ID identifying the item for sale the livestreamer is to terminate presenting, and sends it to the LC server 10 via the network 60.

In the present embodiment, the livestream controller 32 operates the livestreamer control terminal 30 to start and terminate presenting the item for sale or to take care of comments. In other embodiments, the livestreamer control terminal 30 may be configured to issue a coupon and/or deal with a discount.

FIG. 4 is a block diagram showing functions and configuration of the viewer terminal 50 of FIG. 1. The viewer terminal 50 acquires and plays back the video data pertaining to the LC livestream from the LC server 10. The viewer terminal 50 includes a viewer-side UI control unit 502, a viewer-side communication unit 504 and a purchase receiving unit 506. The viewer-side communication unit 504 controls communication with the LC server 10 during the LC livestream. The viewer-side communication unit 504 receives, from the LC server 10 over the network 60, the video data related to the LC livestream.

The viewer-side UI control unit 502 controls the UI for the viewer. The viewer-side UI control unit 502 is connected to a display and a speaker (not shown in FIG. 2), and reproduces the received video data so that video images are displayed on the display and sounds are output through the speaker. The state where the images and sounds are respectively output through the display and speaker can be referred to as “the video data is reproduced”. The viewer-side UI control unit 502 is also connected to input means (not shown in FIG. 2) such as touch panels, keyboards, and displays, and obtains viewer's input via the input means. The viewer-side UI control unit 502 superimposes a predetermined frame image on an image generated from the video data obtained from the LC server 10. The frame image includes various objects such as a cart icon 616 and a gift icon 650 for receiving inputs from the viewer, comments entered by the viewer and livestreamer, and information generated by the LC server 10.

The viewer-side communication unit 504 transmits the content of the viewer's input that is obtained by the viewer-side UI control unit 502 to the LC server 10 over the network 60. The viewer's input can be any of a comment entered, a request to display an effect available for free in the LC livestream (hereinafter, referred to as the LC effect so that it can be distinguished from an effect representing a gift), and a request to share the LC livestream. If the viewer enters a comment, the viewer-side communication unit 504 generates a comment input signal that includes the viewer ID identifying the viewer and the comment entered, and transmits the signal to the LC server 10 over the network 60. If the viewer issues a request to display an LC effect, the viewer-side communication unit 504 generates an effect display request signal including the viewer ID identifying the viewer and an effect ID identifying the LC effect, and sends it to the LC server 10 via the network 60. If the viewer issues a share request, the viewer-side communication unit 504 generates a share request signal including the viewer ID identifying the viewer and sends it to the LC server 10 via the network 60.

The purchase receiving unit 506 receives an operation performed to order the item for sale related to the LC livestream. The viewer watching the LC livestream performs a predetermined operation to order the desired item for sale. The purchase receiving unit 506 interprets the predetermined operation as an instruction to make a purchase. The predetermined operation may be, for example, tapping a thumbnail representing the item for sale displayed on the livestreaming screen showing the LC livestream. Alternatively, the predetermined operation may be selecting the desired item for sale from a list of items for sale. Alternatively, the predetermined operation may be a series of inputs made to add the desired item for sale to a cart (the add-to-cart operation). Alternatively, the predetermined operation may be tapping the cart icon 616 to proceed with the order of the item for sale, ordering the item for sale, or completing payment for the purchase of the item for sale. In response to the predetermined operation, the purchase receiving unit 506 generates a purchase request signal including the viewer ID identifying the viewer who has performed the predetermined operation and the item for sale ID identifying the item for sale relating to the predetermined operation, and sends it to the LC server 10 via the network 60.

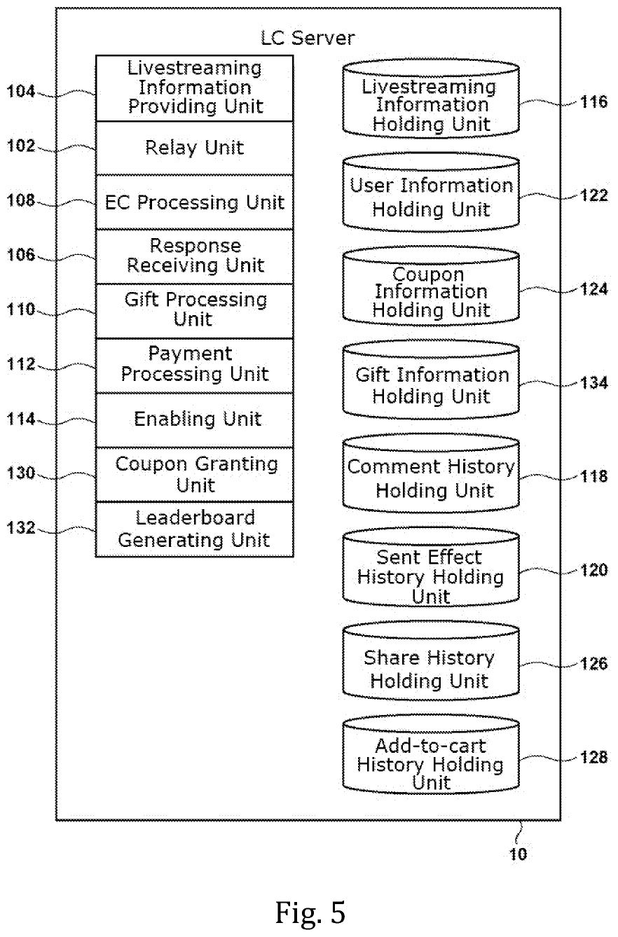

FIG. 5 is a block diagram showing functions and configuration of the LC server 10 of FIG. 1. The LC server 10 includes a livestreaming information providing unit 104, a relay unit 102, an EC processing unit 108, a response receiving unit 106, a gift processing unit 110, a payment processing unit 112, a usage enabling unit 114, a coupon granting unit 130, a leaderboard generating unit 132, a livestreaming information holding unit 116, a user information holding unit 122, a coupon information holding unit 124, a gift information holding unit 134, a comment history holding unit 118, a sent effect history holding unit 120, a share history holding unit 126, and an add-to-cart history holding unit 128.

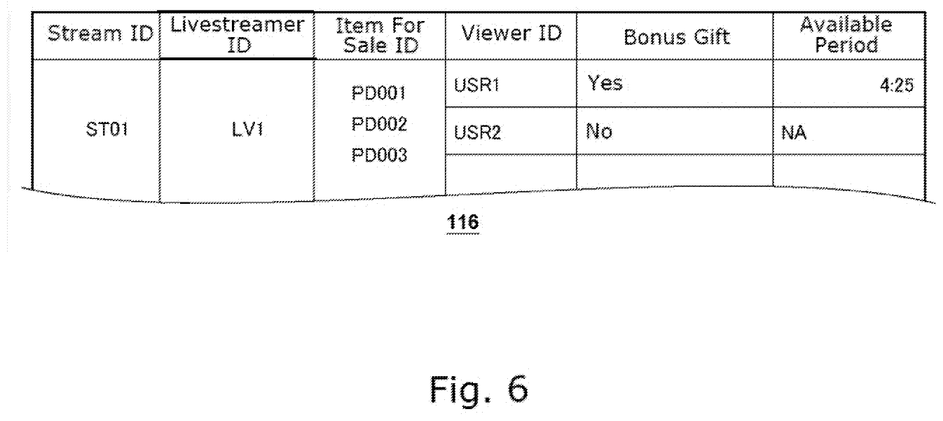

FIG. 6 is a data structure diagram of an example of the livestreaming information holding unit 116 of FIG. 5. The livestreaming information holding unit 116 holds information about an LC livestream currently delivered on the LC platform provided by the live commerce system 1. The livestreaming information holding unit 116 stores a stream ID identifying an LC livestream on the LC platform, a livestreamer ID, which is a user ID for identifying the livestreamer side of the LC livestream, an item for sale ID identifying an item for sale that can be purchased via the LC livestream, a viewer ID, which is a user ID for identifying a viewer of the LC livestream, a flag indicating whether the viewer has a bonus gift, and an available period during which, if the viewer is eligible for using a super random gift, the super random gift is available, in association with each other. The available period is updated periodically.

The livestreamer ID may be configured to identify an individual livestreamer or a group of livestreamers (e.g., a company). If a plurality of items for sale are presented in the LC livestream, a plurality of item for sale IDs are associated with the single stream ID.

The bonus gift is one type of special gifts, which are different from regular gifts. The regular gifts can be used any time during the LC livestream. The bonus gift may be given for free to a viewer watching the LC livestream on a condition that the viewer performs a predetermined operation to order an item for sale. The bonus gift is only available in the LC livestream in which it is granted. In the present embodiment, one type of bonus gifts is provided. In other embodiments, a plurality of types of bonus gifts may be provided that are different from each other in terms of the rarity, effect impressiveness, or reward to be granted to the livestreamer. For example, the bonus gift to be granted may depend on the volume or amount of the orders placed for the item for sale. The effect impressiveness may be determined by several elements including the duration of the effect, the size of the effect, how much the effect can change, the cost of the effect, and whether the effect is a still or animated image. For example, the larger the effect is or the longer the duration of the effect is, the more impressive the effect is.

The super random gift is one type of special gifts. The super random gift corresponds to a random gift, which is one type of regular gifts. Specifically, the super random gift is an upwardly compatible or upgraded version of the random gift. The super random gift has a higher rate of return to the livestreamer than the random gift. More specifically, the reward expected to be given to the livestreamer by the super random gift is higher than the reward expected to be given to the livestreamer by the random gift. Furthermore, on reception of an instruction issued by the viewer to use the super random gift, the viewer is given a coupon available for the item for sale presented in the LC livestream.

In the LC platform provided by the live commerce system 1 of the embodiment, when a user delivers an LC livestream, the user is referred to as a livestreamer, and when the same user views an LC livestream distributed by another user, the user is referred to as a viewer. Therefore, the distinction between a livestreamer and a viewer is not fixed, and a user ID registered as a livestreamer ID at one time may be registered as a viewer ID at another time.

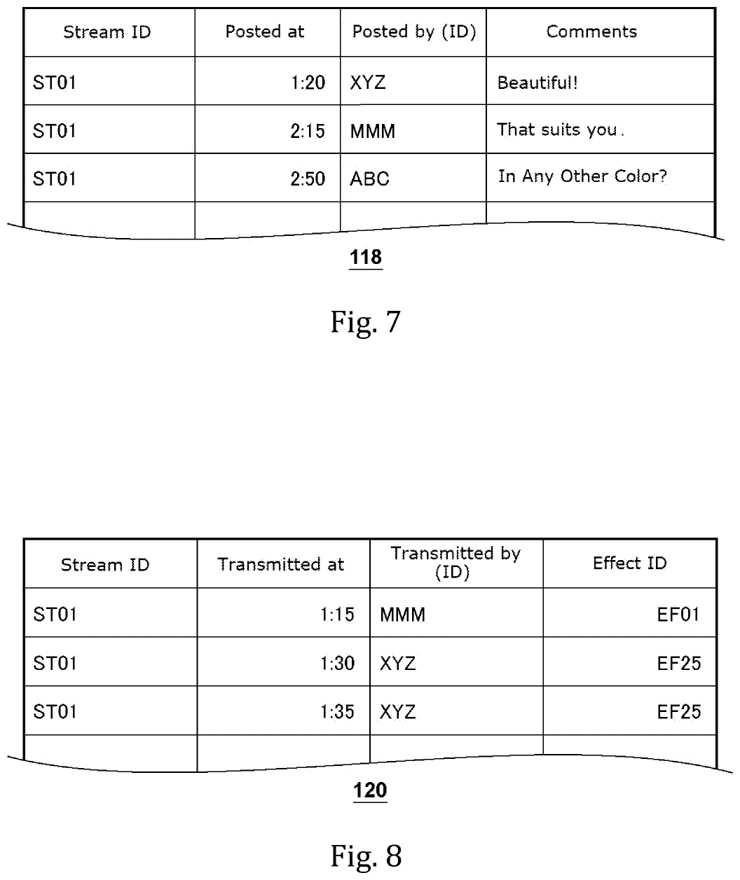

FIG. 7 is a data structure diagram of an example of the comment history holding unit 118 of FIG. 5. The comment history holding unit 118 holds, in association with each other, a stream ID, the time when a comment is posted in the LC livestream identified by the stream ID, a poster ID identifying the viewer or livestreamer who posts the comment, and the comment.

FIG. 8 is a data structure diagram of an example of the sent effect history holding unit 120 of FIG. 5. The sent effect history holding unit 120 holds, in association with each other, a stream ID, the time when an LC effect is sent (used) in the LC livestream identified by the stream ID, a sender ID identifying the viewer or livestreamer who sends the LC effect, and an effect ID identifying the LC effect.

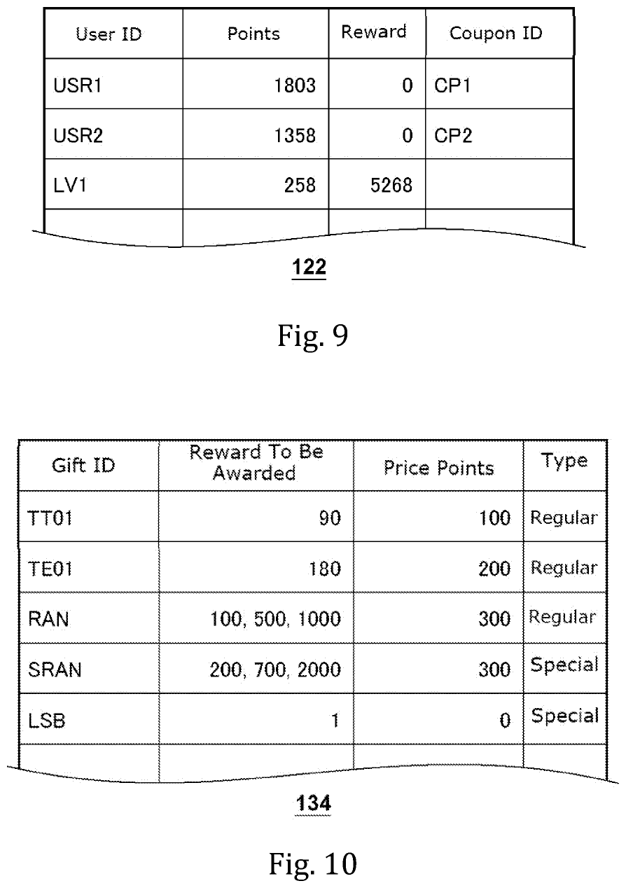

FIG. 9 is a data structure diagram of an example of the user information holding unit 122 of FIG. 5. The user information holding unit 122 holds information regarding users. The user information holding unit 122 stores a user ID identifying a user, points owned by the user, a reward awarded to the user, and a coupon ID identifying a coupon owned by the user, in association with each other.

The points are an electronic representation of value circulated in the LC platform. The user can purchase the points using a credit card or other means of payment. The reward is an electronic representation of value defined in the LC platform and is used to determine the amount of money the livestreamer receives from the administrator of the LC platform. In the LC platform, when a viewer gives a gift to a livestreamer within or outside a LC livestream, the viewer's points are consumed and, at the same time, the livestreamer's reward is increased by a corresponding amount.

FIG. 10 is a data structure diagram of an example of the gift information holding unit 134 of FIG. 5. The gift information holding unit 134 holds information regarding gifts available for viewers in LC livestreams. A gift is electronic data with the following characteristics:
It can be purchased in exchange for the points or money, or can be given for free.
It can be given by a viewer to a livestreamer. Giving a gift to a livestreamer is also referred to as using the gift or throwing the gift.
Some gifts may be purchased and used at the same time, and some gifts may be used by the viewer at any time after purchased.
When a viewer gives a gift to a livestreamer, the livestreamer is given a corresponding reward.
When a gift is used, the use may trigger an effect associated with the gift. For example, an effect corresponding to the gift will appear on the livestreaming room screen.

The gift information holding unit 134 stores: a gift ID for identifying a gift; a reward to be granted, which is a reward to be given to a livestreamer when the gift is given to the livestreamer; price points, which is the amount of points to be paid for use of the gift; and a type indicating whether the gift is a regular or special gift, in association with each other. A viewer is able to give a desired gift to a livestreamer by paying the price points of the desired gift while viewing an LC livestream. The payment of the price points may be made by appropriate electronic payment means. For example, the payment may be made by the viewer paying the price points to the administrator. Alternatively, bank transfers or credit card payments may be available. The administrator can freely determine the relationship between the reward to be awarded and the price points. For example, the administrator may determine that the reward to be awarded=the price points. Alternatively, points obtained by multiplying the reward to be awarded by a predetermined coefficient such as 1.2 may be set as the price points, or points obtained by adding predetermined fee points to the reward to be awarded may be set as the price points.

In the example shown in FIG. 10, the gift identified by the gift ID “RAN” is a random gift that can be used at any time during an LC livestream. A viewer may pay a price of 300 points to use the random gift. Upon the use of the random gift for a livestreamer, a drawing is conducted and either 100, 500, or 1,000 points are granted as a reward to the livestreamer. The gift identified by the gift ID “SRAN” is a special gift, or an upgraded version of the random gift “RAN”. A viewer may pay the same 300-point price as with the case of the random gift to use this super random gift. Upon the use of the super random gift for a livestreamer, a drawing is conducted, and either 200, 700, or 2,000 points are granted as a reward to the livestreamer. The gift identified by the gift ID “LSB” is a bonus gift. As the bonus gift is given for free to any user who orders an item for sale, the price points of the bonus point are zero.

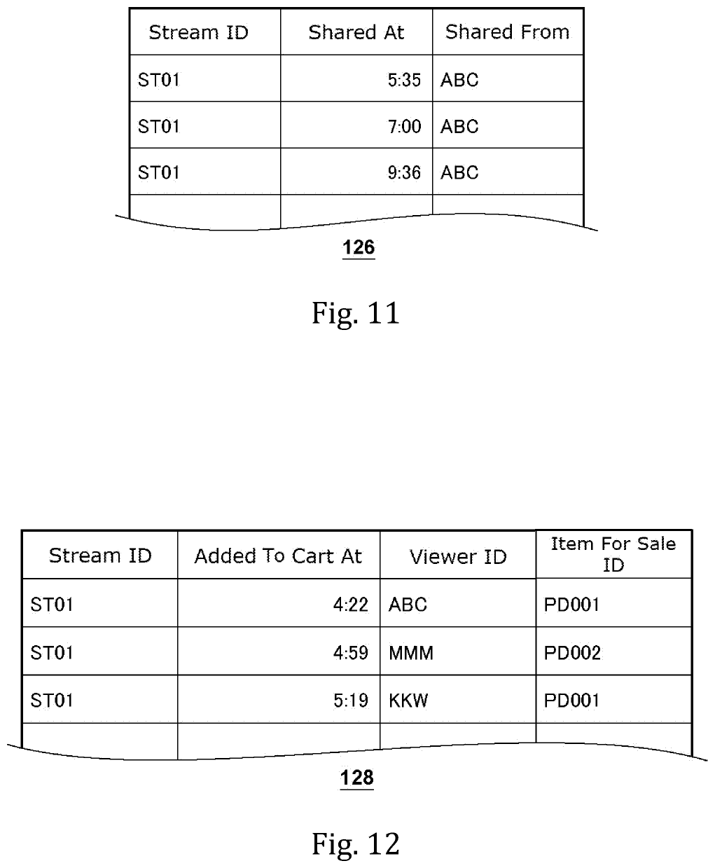

FIG. 11 is a data structure diagram of an example of the share history holding unit 126 of FIG. 5. The share history holding unit 126 holds, in association with each other, a stream ID, the time when the LC livestream identified by the stream ID is shared during the LC livestream, and a share source ID identifying the viewer who shares the LC livestream. By sharing an LC livestream, a viewer provides information about the LC livestream to systems and services (e.g., social network services (SNS), messaging services, push notification services) other than the LC platform. The technique for sharing is publicly known and will not be described herein.

FIG. 12 is a data structure diagram of an example of the add-to-cart history holding unit 128 of FIG. 5. The add-to-cart history holding unit 128 holds, in association with each other, a stream ID, the time when an item is added to the cart during the LC livestream identified by the stream ID, a viewer ID identifying the viewer who adds the item to the cart, and an item for sale ID identifying the item added to the cart. In the example shown in FIG. 12, the data held in the first row indicates that a viewer “ABC” adds an item for sale “PD001” to the cart at 4 minutes and 22 seconds into a LC livestream “ST01”.

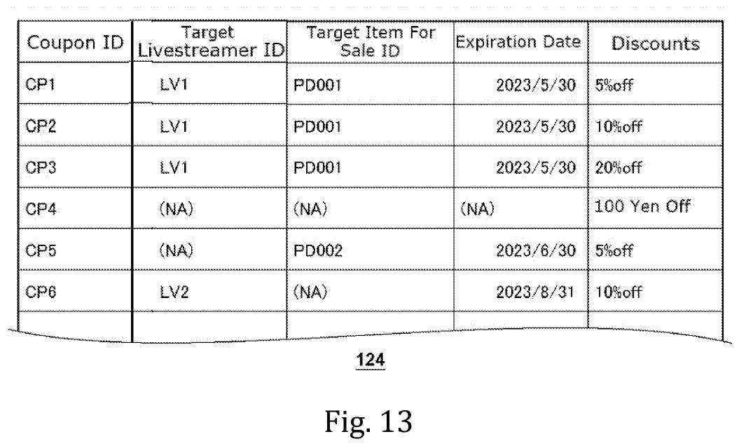

FIG. 13 is a data structure diagram of an example of the coupon information holding unit 124 of FIG. 5. The coupon information holding unit 124 holds information about a plurality of coupons available on the LC platform. The coupons offer different discounts. The coupon information holding unit 124 holds, in association with each other, a coupon ID identifying a coupon, a target livestreamer ID, which is a user ID of a particular livestreamer who delivers an LC livestream for which the coupon is only available if the coupon's availability is limited, a target item for sale ID identifying an item for sale for which the coupon is only available if the coupon's availability is limited, an expiration date of the coupon, and a discount offered by the coupon. The discount may specify, for example, a discount rate or a discount amount.

In the example shown in FIG. 13, three coupons “CP1”, “CP2” and “CP3” offering different discounts are set for the same item for sale “PD001” and the same livestreamer “LV1”. In FIG. 13, the term “(NA)” indicates that there are no applicable conditions. For example, a coupon “CP4” is available for any items for sale presented in LC livestreams delivered by any livestreamers. A coupon “CP5” is available for an item for sale “PD002” presented in LC livestreams delivered by any livestreamers. A coupon “CP6” is available for any items for sale presented by LC livestreams delivered by a livestreamer “LV2”.

The value of the field specifying the expiration date may be set to “until the end of the current livestream.” In this way, the corresponding coupon may be available only within the LC livestream during which the coupon is granted.

Referring again to FIG. 5, upon reception of a notification from the livestreamer mobile terminal 20 that the livestreamer starts an LC livestream over the network 60, the livestreaming information providing unit 104 enters in the livestreaming information holding unit 116 a stream ID identifying this LC livestream and the livestreamer ID of the livestreamer side who delivers the LC livestream. When receiving a request to provide information about LC livestreams from the viewer terminal 50 over the network 60, the livestreaming information providing unit 104 retrieves currently available LC livestreams from the livestreaming information holding unit 116 and makes a list of them. The livestreaming information providing unit 104 transmits the generated list to the requesting viewer terminal 50 over the network 60. The requesting viewer terminal 50 generates an LC livestream selection screen based on the received list and shows the screen on the display of the viewer terminal 50.

Once the viewer terminal 50 receives an LC livestream selected on the livestream selection screen, the viewer terminal 50 generates a livestream request including the stream ID of the selected LC livestream, and transmits the request to the LC server 10 over the network 60. The livestreaming information providing unit 104 starts to provide, to the requesting viewer terminal 50, the LC livestream identified by the stream ID included in the received livestream request. The livestreaming information providing unit 104 updates the livestreaming information holding unit 116 to include the user ID of the viewer of the requesting viewer terminal 50 into the viewer IDs associated with the stream ID.

As the livestreaming information providing unit 104 starts providing the LC livestream, the relay unit 102 relays the video data from the livestreamer mobile terminal 20 to the viewer terminal 50. The relay unit 102 receives from the viewer-side communication unit 504 a signal that represents user input made by the viewer during the LC livestream or reproduction of the video data. The signal that represents user input may be an object specifying signal for specifying an object displayed on the display of the viewer terminal 50, and the object specifying signal includes the viewer ID of the viewer, the stream ID identifying the LC livestream that the viewer watches, the livestreamer ID of the livestreamer of the LC livestream, and an object ID that identifies the object. The object specifying signal may be a gift use signal indicating that the viewer uses a gift for the livestreamer. In this case, the object ID is the gift ID that identifies the gift used. Similarly, the relay unit 102 receives from the livestreamer-side communication unit 210 of the livestreamer mobile terminal 20 a signal that represents user input made by the livestreamer during reproduction of the video data, such as an object specifying signal.

The EC processing unit 108 performs processing related to electronic commerce (e-commerce) in an LC livestream. The EC processing unit 108 enables the viewer to purchase an item for sale in the LC livestream. The EC processing unit 108 performs processing related to the cart in the LC livestream. The EC processing unit 108 may be realized by using known techniques as described in the '034 Publication, the '785 Publication, and “About Live Commerce”, SHOWROOM Inc, URL: https://support.showroom-live.com/hc/ja/articles/900006084866-% E3%83% A9% E3%82% A4% E3%83%96% E3%82% B3% E3%83%9E % E3%83% BC % E3%82% B9% E3%81% AB % E3%81% A4% E3%81%84% E3%81% A6. The known techniques as described in the '034 Publication, the '785 Publication, and “About Live Commerce”, SHOWROOM Inc, URL: https://support.showroom-live.com/hc/ja/articles/900006084866-% E3%83% A9% E3%82% A4% E3%83%96% E3%82% B3% E3%83%9E % E3%83% BC % E3%82% B9% E3%81% AB % E3%81% A4% E3%81%84% E3%81% A6 may be also used to enable comments to be entered and displayed, to enable items for sale to be registered, presented, added to the cart, and ordered, and to enable LC effects to be sent and displayed in the present embodiment.

The response receiving unit 106 receives a signal indicating how the viewer responds in the LC livestream, from the viewer terminal 50 of the viewer via the network 60. The response receiving unit 106 updates the comment history holding unit 118, sent effect history holding unit 120, share history holding unit 126, and add-to-cart history holding unit 128 in response to receiving the signal indicating the response.

The response receiving unit 106 receives a comment input signal from the viewer terminal 50 or livestreamer control terminal 30 via the network 60 during the LC livestream. The received comment input signal includes a viewer ID and a comment. The response receiving unit 106 registers in the comment history holding unit 118 data indicating that a viewer identified by the viewer ID included in the received signal enters during the LC livestream the comment included in the signal at the time when receiving the signal or when the received signal is generated.

The response receiving unit 106 receives an effect display request signal from the viewer terminal 50 via the network 60 during the LC livestream. The received effect display signal includes a viewer ID and an effect ID. The response receiving unit 106 registers in the sent effect history holding unit 120 data indicating that a viewer identified by the viewer ID included in the received signal sends during the LC livestream an LC effect identified by the effect ID included in the signal at the time when receiving the signal or when the received signal is generated.

The response receiving unit 106 receives a share request signal from the viewer terminal 50 via the network 60 during the LC livestream. The received share request signal includes a viewer ID. The response receiving unit 106 registers in the share history holding unit 126 data indicating that a viewer identified by the viewer ID included in the received signal shares, during the LC livestream, the LC livestream at the time when receiving the signal or when the received signal is generated.

The response receiving unit 106 receives a purchase request signal from the viewer terminal 50 via the network 60 during the LC livestream. The received purchase request signal includes a viewer ID and an item for sale ID. The response receiving unit 106 registers in the add-to-cart history holding unit 128 data indicating that a viewer identified by the viewer ID included in the received signal adds, during the LC livestream, to the cart an item for sale identified by the item for sale ID included in the signal at the time when receiving the signal or when the received signal is generated.

The gift processing unit 110 updates the user information holding unit 122 so as to increase the reward for the livestreamer depending on the reward to be awarded of the gift identified by the gift ID included in the gift use signal. Specifically, the gift processing unit 110 refers to the gift information holding unit 134 to specify the reward to be awarded for the gift ID included in the received gift use signal. The gift processing unit 110 then updates the user information holding unit 122 to add the specified reward to be awarded to the reward for the livestreamer ID included in the gift use signal. If the gift ID included in the gift use signal is the gift ID “RAN” identifying a random gift or the gift ID “SRAN” identifying a super random gift, the gift processing unit 110 determines the reward to be granted by conducting a drawing as described above.

The payment processing unit 112 processes payment of a price of the gift by the viewer in response to reception of the gift use signal. Specifically, the payment processing unit 112 refers to the gift information holding unit 134 to specify the price points of the gift identified by the gift ID included in the gift use signal. The payment processing unit 112 then updates the user information holding unit 122 to subtract the specified price points from the points of the viewer identified by the viewer ID included in the gift use signal.

On condition that the viewer of the LC livestream performs an operation to place an order for the item for sale, the enabling unit 114 enables the viewer to use a special gift different from a regular gift. If the EC processing unit 108 completes a purchase finalization process for the item for sale placed in the viewer's cart, the enabling unit 114 gives the viewer a bonus gift (“LSB” in FIG. 10) and starts measuring the period during which a super random gift (“SRAN” in FIG. 10) is available for the viewer. The enabling unit 114 updates the livestreaming information holding unit 116 such that the “Bonus Gift” field associated with the viewer who has completed the purchase finalization process is set to indicate “Yes” and that the available period of a super random gift is set to a default value of “5:00” (five minutes after the current time). Since the value in the “Available Period” field for a super random gift is changed from NA to the default value, the right to use a super random gift is given.

In the present embodiment, if the viewer of the LC livestream performs an operation to place an order for the item for sale, the viewer is given a special gift only available during the LC livestream. The present embodiment is not limited to such. In other embodiments, a special gift may be available in different LC livestreams delivered by the same or another livestreamer or in non-LC livestreams.

Upon receiving an instruction to use a special gift issued by the viewer of the LC livestream, the coupon granting unit 130 grants to the viewer a coupon available for the item for sale presented in the LC livestream. Upon receiving a gift use signal from the viewer terminal 50 indicating that a super random gift is used, the coupon granting unit 130 randomly selects one of the coupons offering different discounts. The coupon granting unit 130 updates the user information holding unit 122 such that the selected coupon is granted to the viewer of the viewer terminal 50 from which the gift use signal is sent. Referring to the example shown in FIGS. 6, 9 and 13, if the viewer “USR1” uses a super random gift in the LC livestream “ST01” delivered by the livestreamer “LV1,” one of the three coupons “CP1”, “CP2” and “CP3” available for the item for sale “PD001” presented in the LC livestream delivered by the livestreamer “LV1” is randomly given to the viewer “USR1.”

The leaderboard generating unit 132 generates a leaderboard ranking livestreamers by the volume of bonus gifts received by the livestreamers.

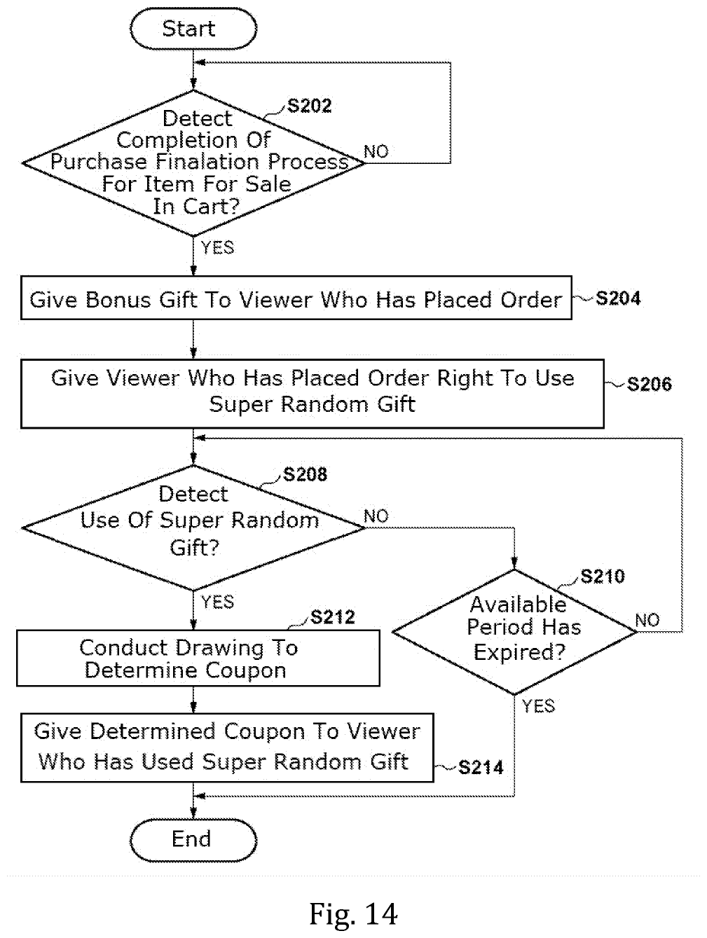

The operation of the live commerce system 1 with the above configuration will be now described. FIG. 14 is a flow chart showing a series of steps performed in the LC server 10 to grant a special gift to a viewer of an LC livestream during the LC livestream. The enabling unit 114 waits until a purchase finalization process is completed for an item for sale placed in the viewer's cart (S202). Upon detecting the completion (Y in S202), the enabling unit 114 grants a bonus gift to the viewer who has ordered the item for sale (S204). The enabling unit 114 gives the viewer who has ordered the item for sale the right to use a super random gift (S206).

The coupon granting unit 130 determines whether the viewer has used the super random gift (S208). If it has not been used (N in S208), the gift processing unit 110 refers to the livestreaming information holding unit 116 to determine whether the super random gift available period for the viewer has expired (S210). If it has not expired, the process returns to the step S208. If it has expired, no coupon is granted and the process ends.

If it has been detected that the super random gift is used (Y in S208), the coupon granting unit 130 conducts a drawing to decide which coupon is to be granted to the viewer (S212). The coupon granting unit 130 grants the coupon determined in the step S212 to the viewer who has used the super random gift (S214).

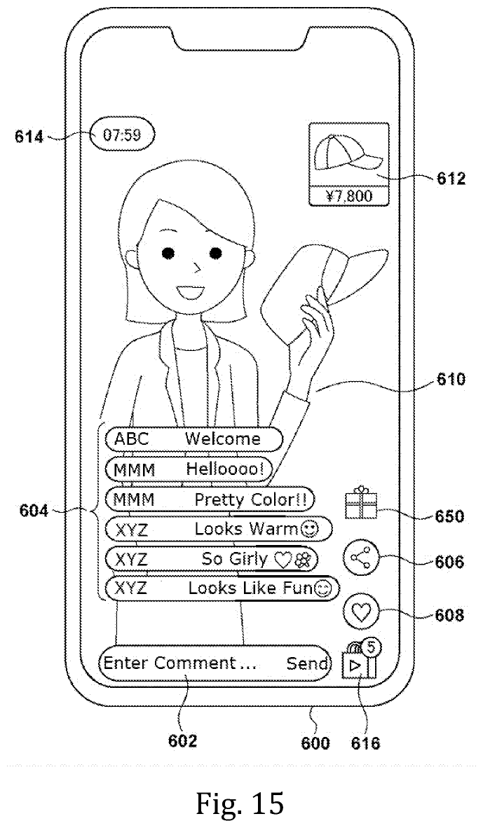

FIG. 15 is a representative screen image of a livestreaming screen 600 on the display of the viewer terminals 50 of the viewers 52. The livestreaming screen 600 displays in real time the video image generated by the livestreamer mobile terminal 20 of the livestreamer 22 and also provides for a cart function to allow the viewer to purchase the item for sale. The livestreaming screen 600 has a comment input area 602, a comment display area 604, a share button 606, a heart button 608, a video image 610 of the livestreamer 22 provided by playing back the video data received from the LC server 10, a thumbnail 612, a time indicating area 614 indicating the time into the LC livestream, a cart icon 616, and a gift icon 650. The viewer-side UI control unit 502 superimposes other objects on the video image 610 provided by reproducing the video data to generate the livestreaming screen 600.

The comment input area 602 receives a comment input by the viewer 52. The viewer 52 enters a comment in the comment input area 602 and then taps the send button. On detection of the tap on the send button, the viewer-side communication unit 504 generates a comment input signal including the comment entered in the comment input area 602, and transmits the signal to the LC server 10 over the network 60.

The comment display area 604 can include comments entered by the viewers, comments entered by the livestreamer side, and notifications from the system. The notifications from the system include a message indicating that a viewer has purchased the item for sale. The viewer-side UI control unit 502 generates the comment display area 604 including comments that are received from the LC server 10 and need be displayed.

The share button 606 is an object for receiving a share request from the viewer. Upon detecting a tap on the share button 606, the viewer-side UI control unit 502 displays on the livestreaming screen 600 possible external services with which the LC livestream can be shared. The viewer-side communication unit 504 generates a share request including the viewer ID identifying the viewer and information about the selected external service, and transmits the share request to the LC server 10 over the network 60.

The heart button 608 is an object for receiving an LC effect display request from the viewer. On detection of a tap on the heart button 608, the viewer-side communication unit 504 generates an effect display request signal including the viewer ID of the viewer and transmits the signal to the LC server 10 over the network 60. On receiving the effect display request signal, the LC server 10 sends an effect display instruction to the terminals of all the participants (including the livestreamer side and viewer side) participating in the LC livestream. On receiving the effect display instruction from the LC server 10, the viewer-side UI control unit 502 displays a heart-shaped effect (LC effect) on the livestreaming screen 600. Such LC effects are used to liven up the LC livestream.

The thumbnail 612 indicates the item for sale currently presented in the LC livestream. The LC server 10 keeps the thumbnail 612, which represents the item for sale, presented on the livestreaming screen 600 of the LC livestream from when it receives a request from the livestreamer side to start presenting the item for sale and to when it receives a request to terminate the presentation. On detection of a tap on the thumbnail 612, the purchase receiving unit 506 generates a purchase request signal to add the corresponding item for sale to the cart and transmits the signal to the LC server 10 over the network 60. Alternatively, on detecting the tap on the thumbnail 612, the purchase receiving unit 506 may display a screen describing the details of the corresponding item for sale on the display and receive an instruction to add the item for sale to the cart via the screen.

The cart icon 616 is an icon for realizing a transition to a screen that displays a list of items for sale that have been placed in the cart. Via this screen, the viewer can proceed with the purchase. If the viewer swipes the livestreaming screen 600 from bottom to top, the viewer-side UI control unit 502 superimposes on the livestreaming screen 600 a list of items for sale that have been or will be presented in the LC livestream and items for sale that have not been or will not be presented but are related to the content of the LC livestream. The viewer may select a desired item for sale from the list, and the purchase receiving unit 506 performs an operation to add the selected item for sale to the cart. The functions related to the cart and purchase procedure may be implemented using the known e-commerce technologies.

On detecting a tap on the gift icon 650, the viewer-side UI control unit 502 generates a gift information request and transmits the request to the LC server 10 over the network 60. Upon receipt of the gift information request, the relay unit 102 of the LC server 10 refers to the gift information holding unit 134 and livestreaming information holding unit 116 to identify gift IDs identifying available gifts. The LC server 10 generates gift information that includes the identified gift IDs, and transmits it to the requesting viewer terminal 50. The viewer-side UI control unit 502 of the viewer terminal 50 generates a gift area 622 for receiving selection of a gift based on the received gift information. The gift area 622 includes gift objects representing the gifts identified by the gift IDs included in the received gift information. The viewer-side UI control unit 502 superimposes the generated gift area 622 on the livestreaming screen 600.

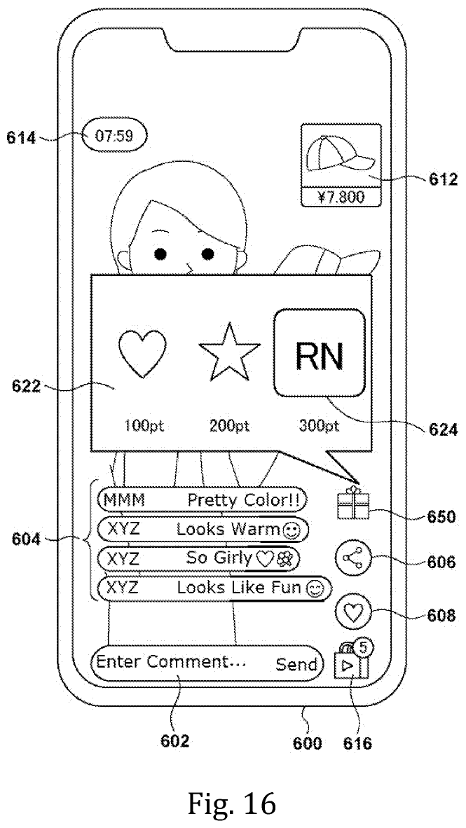

FIG. 16 is a representative screen image of the livestreaming screen 600 having the gift area 622 superimposed thereon, which is shown on the display of the viewer terminals 50. The gift area 622 shown in the example of FIG. 16 appears on the viewer terminal 50 of the viewer for whom the corresponding data in the livestreaming information holding unit 116 indicates that no bonus gift and no available period (Bonus Gift: N, Available Period: NA). The shown gift area 622 includes gift objects representing regular gifts but no gift objects representing special gifts. The gift area 622 includes a gift object 624 representing a random gift “RAN.”

The viewer may tap the gift object in the gift area 622 on the livestreaming screen 600 of FIG. 16, and the viewer-side UI control unit 502 receives designation of the gift object by the viewer. The viewer-side communication unit 504 generates a gift use signal including the gift ID of the gift represented by the designated gift object and transmits it to the LC server 10.

The viewer may tap the cart icon 616 on the livestreaming screen 600 of FIG. 15 and complete a purchase finalization process for the item for sale in the cart. As a result, the viewer is given the right to use the super random gift and the bonus gift as described above. On completion of giving of the right and bonus gift, the enabling unit 114 generates a giving completion signal and transmits it to the viewer terminal 50 over the network 60. On reception of the giving completion signal, the viewer-side UI control unit 502 generates a pop-up notification 626 for notifying the viewer that the viewer is now allowed to use the super random gift and bonus gift since the purchase finalization process has been completed for the item for sale. The viewer-side UI control unit 502 superimposes the generated pop-up notification 626 on the livestreaming screen 600.

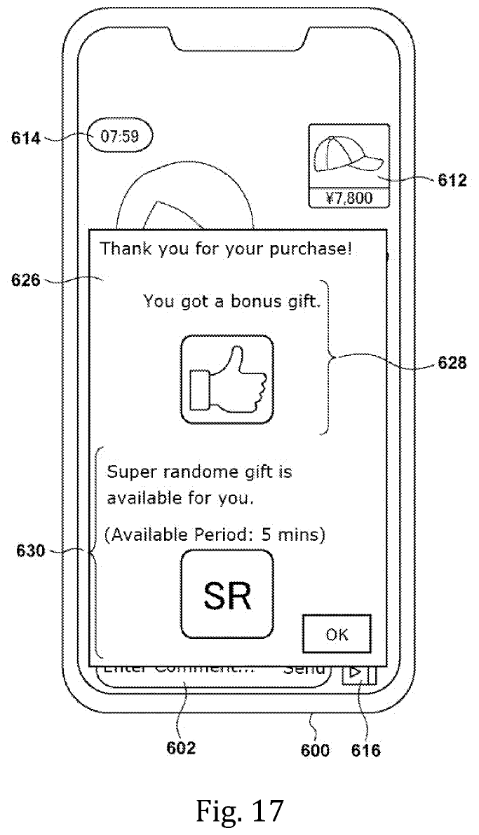

FIG. 17 is a representative screen image of the livestreaming screen 600 having the pop-up notification 626 superimposed thereon, which is shown on the display of the viewer terminal 50. The pop-up notification 626 includes areas 628 and 630. In the area 628, a text indicating that the viewer has been given the bonus gift and an icon representing the bonus gift are displayed. In the area 630, a text indicating that the viewer is now allowed to use the super random gift, the available period and an icon representing the super random gift are displayed.

In the livestreaming screen 600 shown in FIG. 17, the viewer may tap the OK button to close the pop-up notification 626. After this, the viewer may tap the gift icon 650, as a result of which the viewing-side UI control unit 502 generates a gift information request and sends it to the LC server 10. Upon receipt of the gift information request, the relay unit 102 of the LC server 10 refers to the gift information holding unit 134 and livestreaming information holding unit 116 to identify gift IDs identifying available gifts. Here, the data associated with the requesting viewer in the livestreaming information holding unit 116 have the “Bonus Gift” field set to Y and the “Available Period” field set to 4:25. Accordingly, the relay unit 102 identifies the gift ID “LSB” identifying the bonus gift and the gift ID “SRAN” identifying the super random gift as the gift IDs identifying available gifts. The LC server 10 generates gift information that includes the identified gift IDs, and transmits it to the requesting viewer terminal 50. The viewer-side UI control unit 502 of the viewer terminal 50 generates a gift area 632 for receiving selection of a gift based on the received gift information. The gift area 632 includes gift objects representing the gifts identified by the gift IDs included in the received gift information. The viewer-side UI control unit 502 superimposes the generated gift area 632 on the livestreaming screen 600.

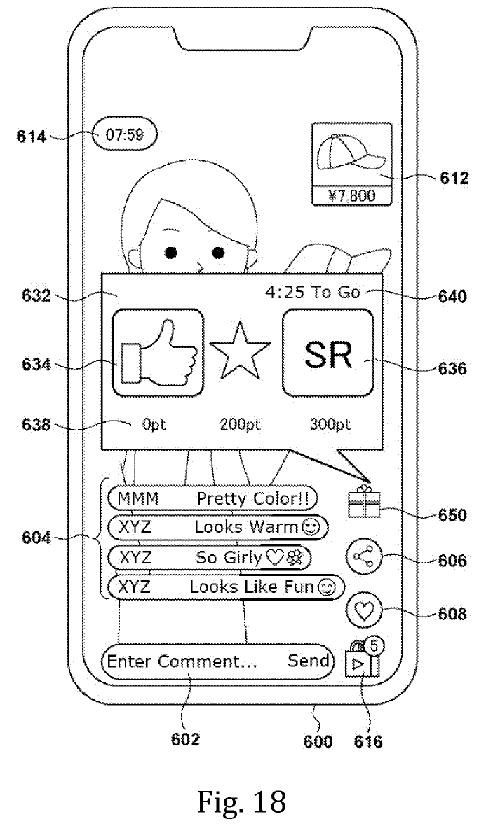

FIG. 18 is a representative screen image of the livestreaming screen 600 having the gift area 632 superimposed thereon, which is shown on the display of the viewer terminal 50. The gift area 632 includes a gift object 634 representing the bonus gift “LSB” and a gift object 636 representing the super random gift “SRAN.” The gift object 634 is associated with a “0 pt” indication 638 indicating that the corresponding gift can be used for free (i.e., has been already granted). The gift object 636 is associated with an indication 640 indicating the available period of the super random gift.

The viewer may tap the gift object 634 in the gift area 632 on the livestreaming screen 600 of FIG. 18, and the viewer-side UI control unit 502 may receive designation of the gift object 634 by the viewer. The viewer-side communication unit 504 generates a gift use signal including the gift ID “LSB” of the bonus gift represented by the designated gift object 634 and transmits it to the LC server 10. At the same time, the viewer-side UI control unit 502 superimposes an effect 642 of the bonus gift “LSB” on the livestreaming screen 600.

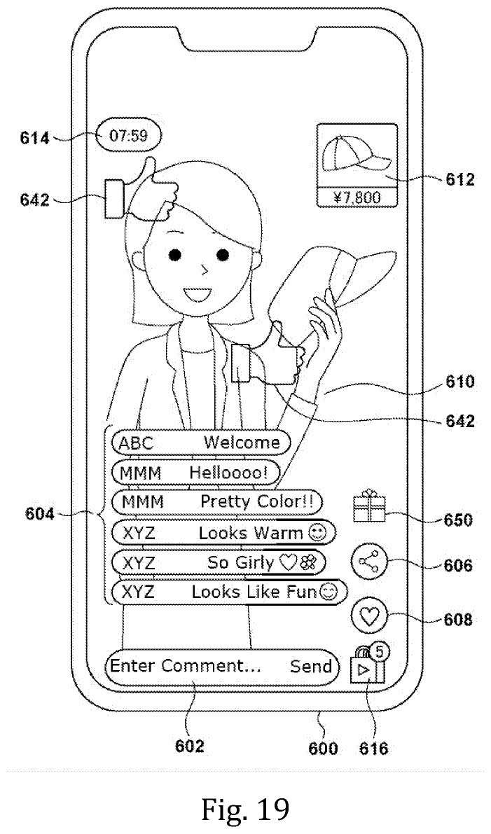

FIG. 19 is a representative screen image of the livestreaming screen 600 having the effect 642 superimposed thereon, which is shown on the display of the viewer terminal 50. The same effect appears on the viewer terminals 50 of other viewers and the livestreamer mobile terminal 20 of the livestreamer.

The viewer may tap the gift object 636 in the gift area 632 on the livestreaming screen 600 of FIG. 18, and the viewer-side UI control unit 502 may receive designation of the gift object 636 by the viewer. The viewer-side communication unit 504 generates a gift use signal including the gift ID “SRAN” of the bonus gift represented by the designated gift object 636 and transmits it to the LC server 10. Upon receiving the gift use signal, the coupon granting unit 130 conducts a drawing as described above to determine the coupon to be granted to the viewer. The coupon granting unit 130 generates a coupon giving signal including information about the determined coupon and transmits it to the viewer terminal 50 over the network 60. Upon receiving the coupon giving signal, the viewer-side UI control unit 502 generates a pop-up notification 644 notifying the viewer that the viewer is given a coupon available for the item for sale presented in the LC livestream. The viewer-side UI control unit 502 superimposes the generated pop-up notification 644 on the livestreaming screen 600.

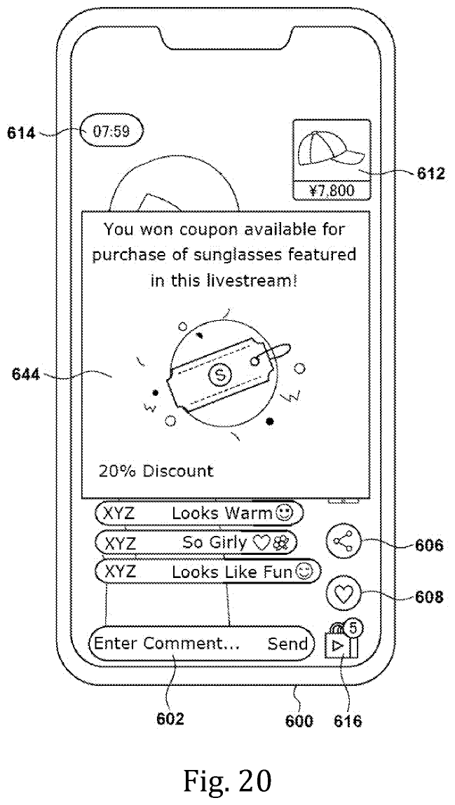

FIG. 20 is a representative screen image of the livestreaming screen 600 having the pop-up notification 644 superimposed thereon, which is shown on the display of the viewer terminal 50. The pop-up notification 644 includes an area for showing a text indicating that the viewer is given a coupon available for a particular item for sale presented in the current LC livestream and also showing a discount.

In the above embodiment, the holding units are, for example, a hard disk or semiconductor memory. It is understood by those skilled in the art that each element or component can be realized by a CPU not shown, a module of an installed application program, a module of a system program, or a semiconductor memory that temporarily stores the contents of data read from a hard disk, and the like.

The live commerce system 1 relating to the present embodiment can allow the e-commerce function and gifting function to work together. If the user orders an item for sale presented in an LC livestream, the user is allowed to use a special gift. In addition, if a user uses a predetermined gift, the user is given a coupon. These can motivate the viewer to get more engaged, thereby livening up LC livestreams.

In the live commerce system 1 relating to the present embodiment, the viewer may order an item for sale in an LC livestream and, as a result, the viewer is granted the right to use a special gift different from a regular gift. The gifting function thus can motivate viewers who desire to help livestreamers to use live commerce. Viewers may participate in LC livestreams as they want to purchase a particular item for sale. Such viewers can experience the gifting function by being given special gifts such as bonus gifts. In this way, they can actually feel what good they can get from the gifting function.

In the live commerce system 1 relating to the present embodiment, the viewer may use a super random gift and resultantly receive a coupon. The gifting thus can motivate viewers who desire to help livestreamers to use live commerce.

In addition, the live commerce system 1 relating to the present embodiment can not only allow the user to just purchase an item for sale but also provide the user with an opportunity to experience a gifting function linked with the purchase. Thus, the live commerce system 1 can provide for highly entertaining live commerce.

In addition, the live commerce system 1 relating to the present embodiment can offer point rebates for purchases of items for sale since bonus gifts have a reward to be granted.

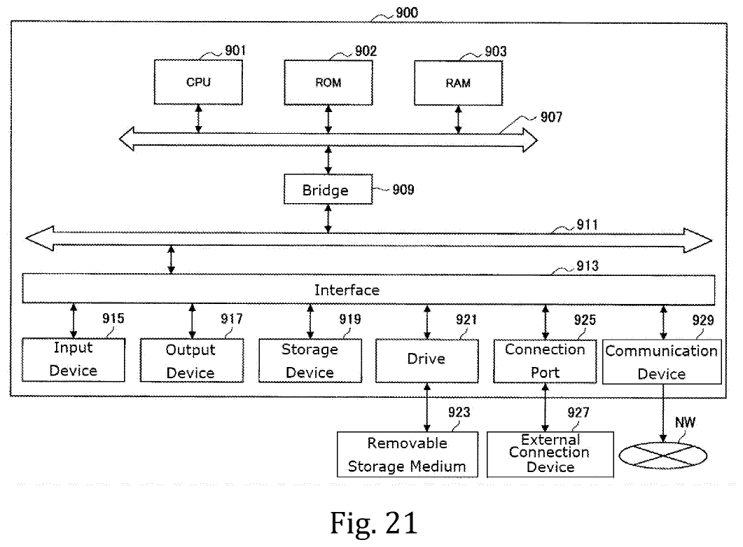

Referring to FIG. 21, the hardware configuration of an information processing device relating to an embodiment of the disclosure will be now described. FIG. 21 is a block diagram showing an example of the hardware configuration of the information processing device according to the embodiment. The illustrated information processing device 900 may, for example, realize the LC server 10, the livestreamer mobile terminal 20, the livestreamer control terminal 30, and the viewer terminal 50 in the embodiment.

The information processing device 900 includes a CPU 901, ROM (Read Only Memory) 902, and RAM (Random Access Memory) 903. The information processing device 900 may also include a host bus 907, a bridge 909, an external bus 911, an interface 913, an input device 915, an output device 917, a storage device 919, a drive 921, a connection port 925, and a communication device 929. In addition, the information processing device 900 includes an image capturing device such as a camera (not shown). The CPU 901 is an example of hardware configuration to realize various functions performed by the components described herein. The functions described herein may be realized by circuitry programmed to realize such functions described herein. The circuitry programmed to realize such functions described herein includes a central processing unit (CPU), a digital signal processor (DSP), a general-use processor, a dedicated processor, an integrated circuit, application specific integrated circuits (ASICs) and/or combinations thereof. Various units described herein as being configured to realize specific functions, including but not limited to the livestreaming information providing unit 104, the relay unit 102, the EC processing unit 108, the response receiving unit 106, the gift processing unit 110, the payment processing unit 112, the usage enabling unit 114, the coupon granting unit 130, the leaderboard generating unit 132, the livestreaming information holding unit 116, the user information holding unit 122, the coupon information holding unit 124, the gift information holding unit 134, the comment history holding unit 118, the sent effect history holding unit 120, the share history holding unit 126, the add-to-cart history holding unit 128, the livestreaming unit 1100, the image capturing control unit 1102, the audio control unit 1104, the video transmission unit 1106, the livestreamer-side UI control unit 1108, the livestreamer-side communication unit 1110, the item for sale control unit 1112, the viewing unit 1200, the viewer-side UI control unit 1202, the viewer-side communication unit 1204, the purchase receiving unit 1206, the livestreaming information providing unit 1302, the relay unit 1304, the EC processing unit 1306, the VS control unit 1308, the group call control unit 1310, the leaderboard generating unit 1312, the livestreaming information holding unit 1314, the user information holding unit 1318, the VS information holding unit 1320, the event information holding unit 1322, the sales history holding unit 1324, the leaderboard information holding unit 1326, the image capturing control unit 202, the audio control unit 204, the video transmission unit, livestreamer-side UI control unit 208, the livestreamer-side communication unit 210, the display control unit 302, the comment processing unit 304, and the item for sale control unit 306, the viewer-side UI control unit 502, the viewer-side communication unit 504, and the purchase receiving unit 506 may be embodied as circuitry programmed to realize such functions.

The CPU 901 functions as an arithmetic processing device and a control device, and controls all or some of the operations in the information processing device 900 according to various programs stored in the ROM 902, the RAM 903, the storage device 919, or a removable recording medium 923. For example, the CPU 901 controls the overall operation of each functional unit included in the server 10 and the user terminals 20 and 30 in the embodiment. The ROM 902 stores programs including sets of instructions, calculation parameters, and the like used by the CPU 901. The RAM 903 serves as a primary storage that stores programs including sets of instructions to be used in the execution of the CPU 901, parameters that appropriately change in the execution, and the like. The CPU 901, ROM 902, and RAM 903 are interconnected to each other by the host bus 907 which may be an internal bus such as a CPU bus. Further, the host bus 907 is connected to the external bus 911 such as a PCI (Peripheral Component Interconnect/Interface) bus via the bridge 909.

The input device 915 may be a user-operated device such as a mouse, keyboard, touch panel, buttons, switches and levers, or a device that converts a physical quantity into an electric signal such as a sound sensor typified by a microphone, an acceleration sensor, a tilt sensor, an infrared sensor, a depth sensor, a temperature sensor, a humidity sensor, and the like. The input device 915 may be, for example, a remote control device utilizing infrared rays or other radio waves, or an external connection device 927 such as a mobile phone compatible with the operation of the information processing device 900. The input device 915 includes an input control circuit that generates an input signal based on the information inputted by the user or the detected physical quantity and outputs the input signal to the CPU 901. By operating the input device 915, the user inputs various data and instructs operations to the information processing device 900.

The output device 917 is a device capable of visually or audibly informing the user of the obtained information. The output device 917 may be, for example, a display such as an LCD, PDP, or OELD, etc., a sound output device such as a speaker and headphones, and a printer. The output device 917 outputs the results of processing by the information processing device 900 as text, video such as images, or sound such as audio.

The storage device 919 is a device for storing data configured as an example of a storage unit of the information processing device 900. The storage device 919 is, for example, a magnetic storage device such as a hard disk drive (HDD), a semiconductor storage device, an optical storage device, or an optical magnetic storage device. This storage device 919 stores programs executed by the CPU 901, various data, and various data obtained from external sources.

The drive 921 is a reader/writer for the removable recording medium 923 such as a magnetic disk, an optical disk, a photomagnetic disk, or a semiconductor memory, and is built in or externally attached to the information processing device 900. The drive 921 reads information recorded in the mounted removable recording medium 923 and outputs it to the RAM 903. Further, the drive 921 writes record in the attached removable recording medium 923.

The connection port 925 is a port for directly connecting a device to the information processing device 900. The connection port 925 may be, for example, a USB (Universal Serial Bus) port, an IEEE1394 port, an SCSI (Small Computer System Interface) port, or the like. Further, the connection port 925 may be an RS-232C port, an optical audio terminal, an HDMI (registered trademark) (High-Definition Multimedia Interface) port, or the like. By connecting the external connection device 927 to the connection port 925, various data can be exchanged between the information processing device 900 and the external connection device 927.

The communication device 929 is, for example, a communication interface formed of a communication device for connecting to the network 60. The communication device 929 may be, for example, a communication card for a wired or wireless LAN (Local Area Network), Bluetooth (trademark), or WUSB (Wireless USB). Further, the communication device 929 may be a router for optical communication, a router for ADSL (Asymmetric Digital Subscriber Line), a modem for various communications, or the like. The communication device 929 transmits and receives signals and the like over the Internet or to and from other communication devices using a predetermined protocol such as TCP/IP. The communication network 60 connected to the communication device 929 is a network connected by wire or wirelessly, and is, for example, the Internet, home LAN, infrared communication, radio wave communication, satellite communication, or the like. The communication device 929 realizes a function as a communication unit.

The image capturing device (not shown) is, for example, a camera for capturing an image of the real space to generate the captured image. The image capturing device uses an imaging element such as a CCD (Charge Coupled Device) or CMOS (Complementary Metal Oxide Semiconductor) and various elements such as lenses that are provided to control image formation of a subject on the imaging element. The image capturing device may capture a still image or may capture a moving image.

The configuration and operation of the live commerce system 1 according to the first embodiment have been described above. This embodiment is merely an example, and it will be understood by those skilled in the art that various modifications are possible by combining the respective components and processes, and that such modifications are also within the scope of the present disclosure.

In the present embodiment, upon completing a purchase of an item for a sale, the viewer is given the right to use a super random gift. If the viewer uses the super random gift, a drawing is conducted and the viewer is given a coupon. The present embodiment is not limited to such. For example, if the viewer uses a predetermined regular gift (for example, a random gift), a drawing may be conducted and the viewer may be given a coupon. In this case, on condition that the viewer uses a random gift, the coupon granting unit 130 grants to the viewer a coupon available for the item for sale presented in the LC livestream. The coupon granting unit 130 randomly selects one of the coupons offering different discounts and grants the selected coupon.

In the present embodiment, on condition that the viewer performs an operation to place an order for the item for sale, the viewer is allowed to use a bonus gift and a super random gift. The present embodiment, however, is not limited to such. For example, a plurality of gifts may be provided that have different rewards to be granted to the livestreamer. The enabling unit 114 may randomly select one of the gifts and grant the selected gift to the viewer. Alternatively, the enabling unit 114 may select one of the gifts based on the amount and/or volume of purchases of the item for sale and grant the selected gift to the viewer. For example, as the amount of purchases increases, the reward to be granted by the gift selected by the enabling unit 114 increases. Alternatively, the bonus gift may be granted under a certain condition, and the use of the super random gift may be enabled under a different condition. For example, the bonus gift may be granted upon completion of a purchase finalization process for a particular item for sales. The right to use the super random gift, on the other hand, may be granted if the total amount of purchases for the item for sale exceeds a threshold. Since a plurality of types of special gifts are granted under different conditions, the viewer can be more motivated to purchase the item for sale.

In the present embodiment, a drawing is conducted to determine which coupon is to be granted to the viewer. The present embodiment, however, is not limited to such. For example, as the volume and/or amount of gifts used by the viewer increases, the advantage achieved by the discount offered by the coupon given to the viewer may increase. Alternatively, the viewer may be granted a predetermined coupon.

In the present embodiment, the coupon to be granted depends on the gifting behavior. The present embodiment, however, is not limited to this. For example, the coupon to be granted may depend on the level of interaction between the livestreamer and the viewer in the LC livestream. The level of interaction may be determined by the volume of gifts used, and also by the number of comments, the number of LC effects, the number of shared livestreams, the number of items placed in the cart, the viewing time, and the missions cleared by the viewer and livestreamer. For example, as the level of interaction between the livestreamer and viewer in the LC livestream increases, the advantage achieved by the discount offered by the coupon given to the viewer may increase.

For example, the LC server may refer to the comment history holding unit 118, sent effect history holding unit 120, share history holding unit 126, and add-to-cart history holding unit 128 to calculate the level of interaction between the viewer and the livestreamer. The LC server may grant to the viewer a coupon offering a discount determined by the calculated level.

In the present embodiment, the coupon is granted and the use of the special gift is enabled in the LC livestream in real time. The present embodiment, however, is not limited to such. For example, a batch process may be performed once a day to grant a coupon and a special gift. The batch process may be performed by referring to the various history holding units.

In the present embodiment, the coupon is used in the LC livestream. The present embodiment, however, is not limited to such. For example, a coupon available at the company's brick and mortar shops may be offered.

In the embodiment, the LC server 10 provides LC livestreams where the livestreamer side can present items for sale and take orders for them and can receive gifts from the viewers. The present embodiment, however, is not limited to such. For example, the LC server may be a server of a livestreaming system that allows the same livestreamer to deliver at different times an LC livestream where the livestreamer side can present items for sale and take orders for them but the gifting function is not provided and a non-LC livestream where the gifting function is provided. In this case, the plat form for the LC livestream and the platform for the non-LC livestream may be managed by the same administrator or different administrators.

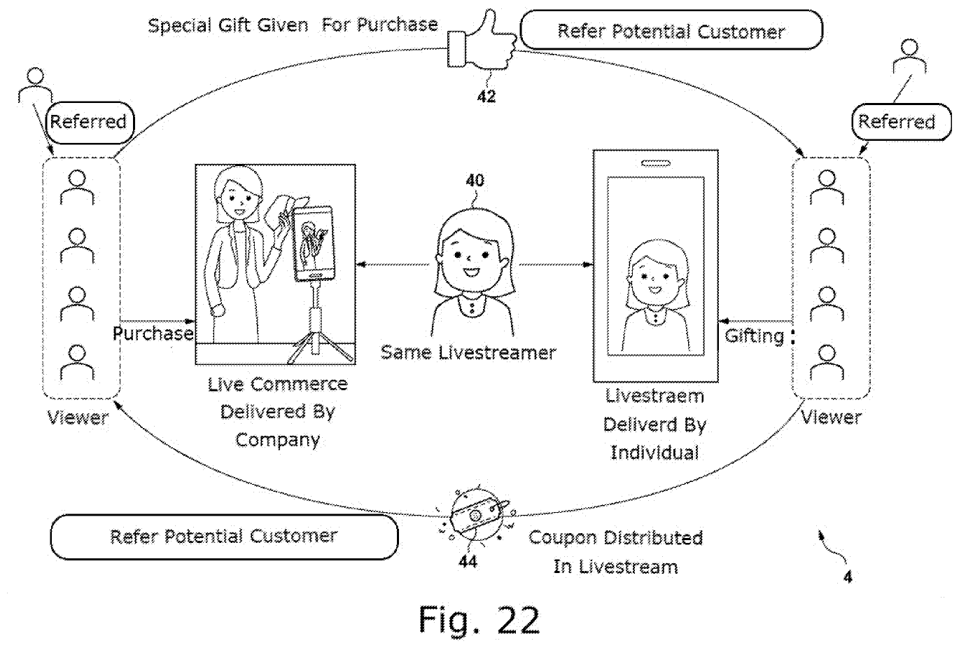

FIG. 22 shows a concept of a live commerce system 4 relating to a modification example. The live commerce system 4 manages an LC platform where companies provide live commerce and a livestream (LS) platform where individuals can deliver livestreams (non-LC livestreams). A single livestreamer 40 uses the LC platform to serve as an influencer who delivers LC livestreams for presenting items for sale available from companies and taking orders for them and also uses the LS platform to serve as a liver who delivers non-LC livestreams. As delivered by the same livestreamer 40, the LC and non-LC livestreams take place at different times. The platforms are configured such that the LC livestreams do not implement a gifting function and the non-LC livestreams do not implement an e-commerce function.

The management server (not shown) of the live commerce system 4 has the same functions as the LC server 10 except for the following points. The management server grants digital items to the viewers in either the LC or non-LC livestreams, while the digital items are available in the other type of livestreams. The digital items can include, for example, gifts, coupons, badges, animations, and effects. According to the example shown in FIG. 22, on condition that a viewer watching an LC livestream performs a predetermined operation to order an item for sale, the management server grants to the viewer a special gift such as a bonus gift 42 available in a non-LC livestream. In a non-LC livestream delivered by a certain livestreamer, the management server grants to a viewer of the non-LC livestream a coupon 44 available for an item for sale presented in an LC livestream delivered by the same livestreamer.

Since a special gift is given to the viewer of the LC livestream of a company in response to a purchase of the item for sale presented in the LC livestream, the viewer of the LC livestream can be referred to the non-LC livestream delivered by the same livestreamer. In addition, since a coupon is given away in the non-LC livestream of an individual, the viewer of the non-LC livestream can be referred to the LC livestream delivered by the same livestreamer. This is how the interaction between the LC and non-LC livestreams can liven up the both. Viewers are motivated to migrate between LC livestreams of companies and non-LC livestreams of individuals. In this way, both LC and non-LC livestreams can acquire more viewers and thus become more enjoyable. New viewers who visit either the LC or non-LC livestreams can be invited into the migration and can be referred to the other type of livestreams.

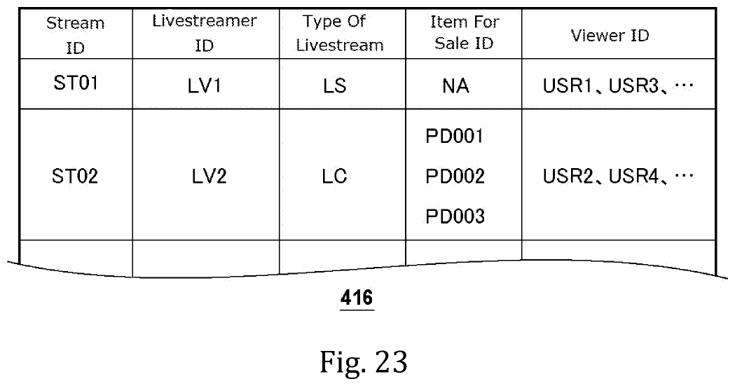

FIG. 23 is a data structure diagram of an example of a livestreaming information holding unit 416 of the managing server relating to the modification example. The livestreaming information holding unit 416 holds information about an LC livestream currently delivered on the LC platform provided by the live commerce system 4 and information about a non-LC livestream currently delivered on the LS platform provided by the live commerce system 4. The livestreaming information holding unit 416 stores, in association with each other, a stream ID identifying a livestream on the live commerce system 4, a livestreamer ID, which is a user ID for identifying the livestreamer who delivers the livestream, a livestream type indicating whether the livestream is an LC livestream or non-LC livestream, an item for sale ID identifying, if the livestream is an LC livestream, an item for sale that can be purchased in the LC livestream, and a viewer ID, which is a user ID for identifying a viewer of the livestream.

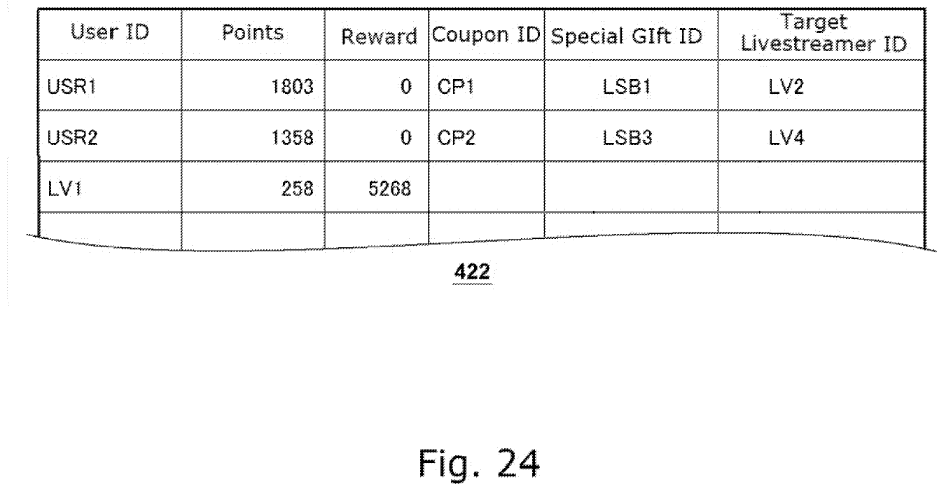

FIG. 24 is a data structure diagram of an example of a user information holding unit 422 of the managing server relating to the modification example. The user information holding unit 422 holds information regarding users of the live commerce system 4. The user information holding unit 422 stores a user ID identifying a user, points owned by the user, a reward awarded to the user, a coupon ID identifying a coupon owned by the user, a special gift ID identifying a special gift owned by the user, and a target livestreamer ID, in association with each other. The user ID, special gift ID, and target livestreamer ID associated with each other indicate that the user identified by the user ID is allowed to use the special gift identified by the special gift ID only in a non-LC livestream delivered by the livestreamer identified by the target livestreamer ID.

In the modification example, a special gift granted to a viewer of an LC livestream is configured such that it is only allowed to be used in a non-LC livestream delivered by the livestreamer who delivers the LC livestream. In other modification examples, a special gift may be configured such that it is allowed to be used in non-LC livestreams delivered by any livestreamers.

In the present modification example, a special gift granted to a viewer of an LC livestream is configured such that it can not be granted in a non-LC livestream delivered by the livestreamer who delivers the LC livestream. Specifically, if a gift icon appearing in a non-LC livestream is tapped, a list of available gifts comes up, but the list includes no special gifts. This will encourage viewers to join LC livestreams.

In the present modification example, as the price of an item for sale ordered or the total amount of purchased made by a viewer in an LC livestream increases, the impressiveness of the special gift granted by the managing server to the viewer increases. This can motivate the viewer to purchase more expensive items for sale or more items for sale.

The managing server relating to the modification example generates a leaderboard that ranks livestreamers by the volume of special gifts the livestreamers receive in non-LC livestreams from viewers of LC livestreams who receive the special gifts in the LC livestreams. This can motivate the livestreamers to deliver both LC and non-LC livestreams.

In the present modification example, as the level of interaction between a livestreamer and a viewer in a non-LC livestream increases, the advantage achieved by a discount offered by a coupon given by the managing server to the viewer may increase. This realizes more active interaction in non-LC livestreams.

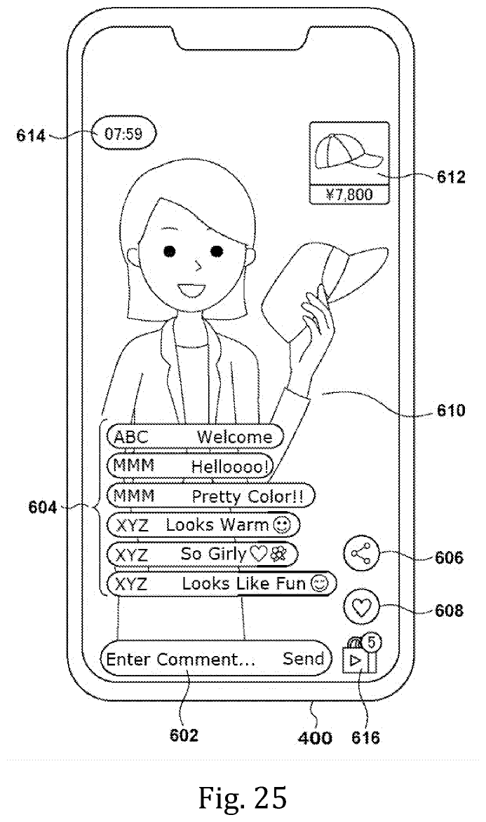

The following describes the series of steps starting from the step where a bonus gift is granted in an LC livestream to the step where the bonus gift is used in a non-LC livestream, with reference to representative screen images. FIG. 25 is a representative screen image of a livestreaming screen 400 of an LC livestream appearing on a display of a viewer terminal of a viewer in the modification example. The livestreaming screen 400 of the LC livestream is equivalent to the livestreaming screen 600 shown in FIG. 15 except for the fact that the gift icon 650 is absent. This means that the LC livestream does not implement the gifting function in the present modification example.

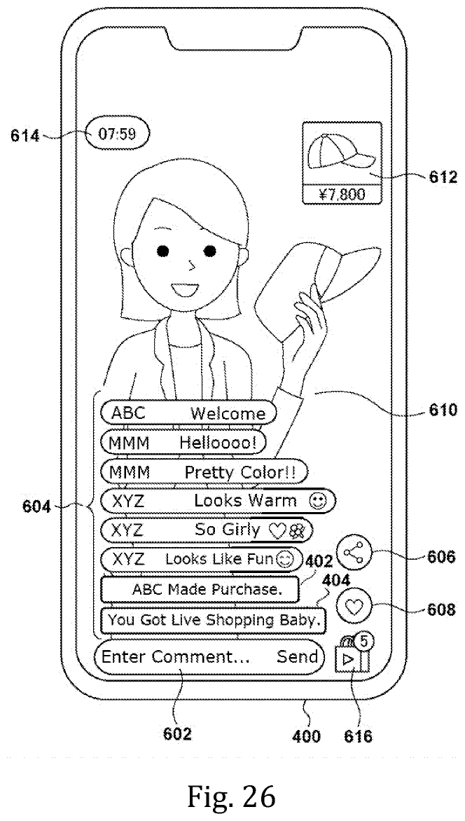

FIG. 26 is a representative screen image of the livestreaming screen 400 of the LC livestream appearing on the display of the viewer terminal of the viewer in the modification example. The livestreaming screen 400 of FIG. 26 is shown on the display once the viewer taps the cart icon 616 on the livestreaming screen 400 of FIG. 25 and completes a purchase finalization process for an item for sale. A comment display area 604 in FIG. 26 notifies the viewer that, in response to completion of the purchase finalization process for the item for sale, the viewer has received a bonus gift that can be used in a non-LC livestream that is different from the LC livestream but delivered by the same livestreamer. Referring to FIG. 26, the comment display area 604 shows a comment 402 indicating that the viewer has purchased the item for sale and a comment 404 indicating that the viewer has won a special gift (in this case, a bonus gift named “Live Shopping Baby”).

Once the viewer completes a purchase finalization process for an item for sale placed in the cart, the managing server gives the viewer a bonus gift. The bonus gift is configured such that it is only allowed to be used in a non-LC livestream delivered by the livestreamer who delivers the LC livestream in which the viewer has purchased the item for sale. The managing server updates the user information holding unit 422 such that the gift ID of the bonus gift is registered as the special gift ID associated with the viewer who has completed the purchase finalization process, and the livestreamer ID of the livestreamer of the LC livestream in which the viewer has purchased the item for sale is registered as the target livestreamer ID.

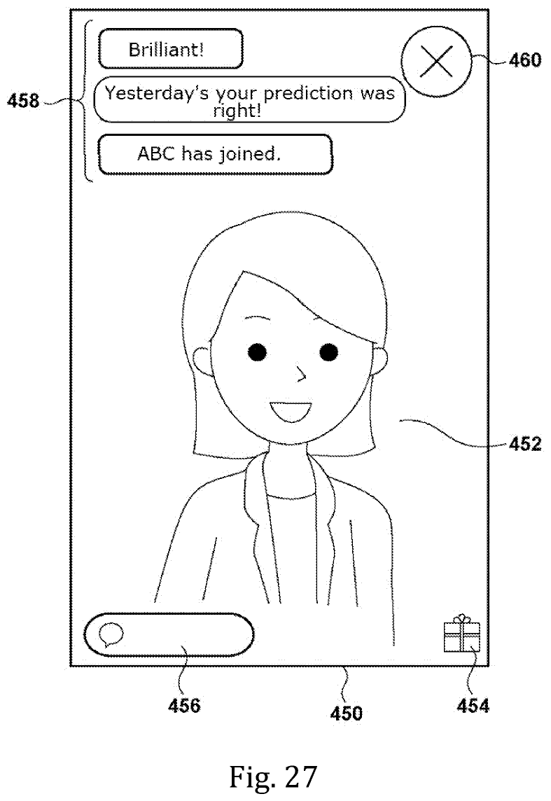

FIG. 27 is a representative screen image of a livestreaming room screen 450 of a non-LC livestream appearing on the display of the viewer terminal of the viewer in the modification example. The livestreaming room screen 450 of the non-LC livestream has objects corresponding to the gifting function, but has no objects corresponding to the e-commerce function. This means that non-LC livestreams do not implement the e-commerce function in the present modification example.

The livestreaming room screen 450 displays a video image generated by the livestreamer mobile terminal 20 of the livestreamer in real time. The livestreaming room screen 450 includes a video image 452 of the livestreamer provided by reproducing the video data received from the managing server, a gift icon 454, a comment input area 456, a comment display area 458, and a quit viewing button 460. The viewer-side UI control unit 502 superimposes various objects such as the gift icon 454, the comment input area 456, the comment display area 458, and the quit viewing button 460 on the video image 452 provided by reproducing the video data, to generate the livestreaming room screen 450.

On detecting a tap on the gift icon 454, the viewer-side UI control unit 502 of the viewer terminal generates a gift information request and transmits the request to the managing server over the network 60. Upon receipt of the gift information request, the managing server refers to the gift information holding unit and user information holding unit 422 to identify gift IDs identifying available gifts. If the pair of viewer ID and livestreamer ID (representing the livestreamer delivering the non-LC livestream being watched by the viewer) in the gift information request matches one of the pairs of user ID and target livestreamer ID in the user information holding unit 422, the managing server retrieves the special gift ID of the corresponding entry in the user information holding unit 422 and includes the retrieved special gift ID in the list of gift IDs identifying available gifts. The managing server generates gift information including the list of identified gift IDs, and sends the gift information to the requesting viewer terminal. The viewer-side UI control unit 502 of the viewer terminal generates a gift area 462 for receiving selection of a gift based on the received gift information. The gift area 462 includes gift objects representing the gifts identified by the gift IDs included in the received gift information. The viewer-side UI control unit 502 displays the generated game area 462 on the livestreaming room screen 450.

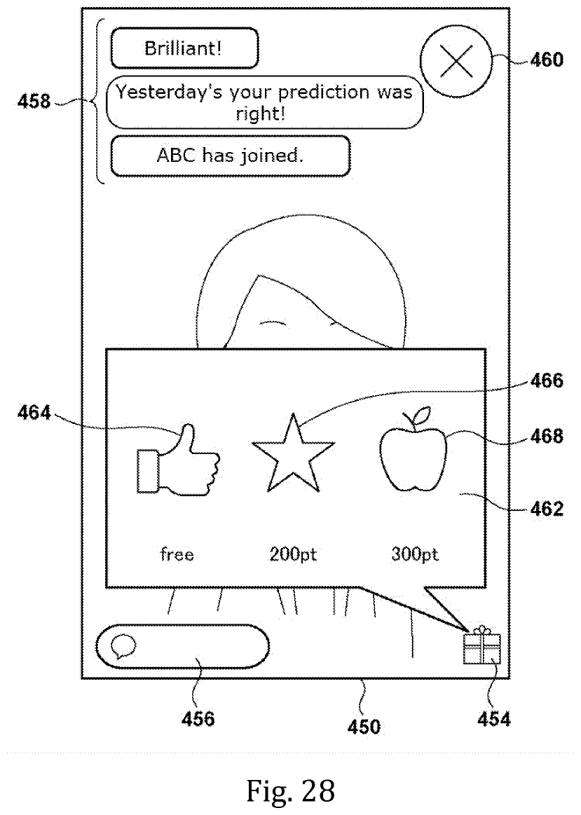

FIG. 28 is a representative screen image of the livestreaming room screen 450 of the non-LC livestream having the gift area 462 superimposed thereon, which appears on the display of the viewer terminal of the viewer in the modification example. The gift area 462 includes gift objects 466 and 468 of regular gifts and a gift object 464 of a bonus gift. The viewer may tap the gift object 464 in the gift area 462 on the livestreaming room screen 450 of FIG. 28, and the viewer-side UI control unit 502 may receive designation of the gift object 464 by the viewer. The viewer-side UI control unit 502 generates an effect 470 corresponding to the bonus gift represented by the designated gift object 464. The viewer-side UI control unit 502 displays the generated effect 470 on the livestreaming room screen 450. At the same time, the viewer-side communication unit 204 generates a gift use signal including the gift ID of the bonus gift represented by the designated gift object 464 and transmits it to the managing server. The managing server sends an effect display instruction signal including the gift ID of the bonus gift to the livestreamer mobile terminal 20 of the livestreamer and the viewer terminals of the other viewers, so that the same effect appears on the terminals of the livestreamer and other viewers participating in the non-LC livestream.

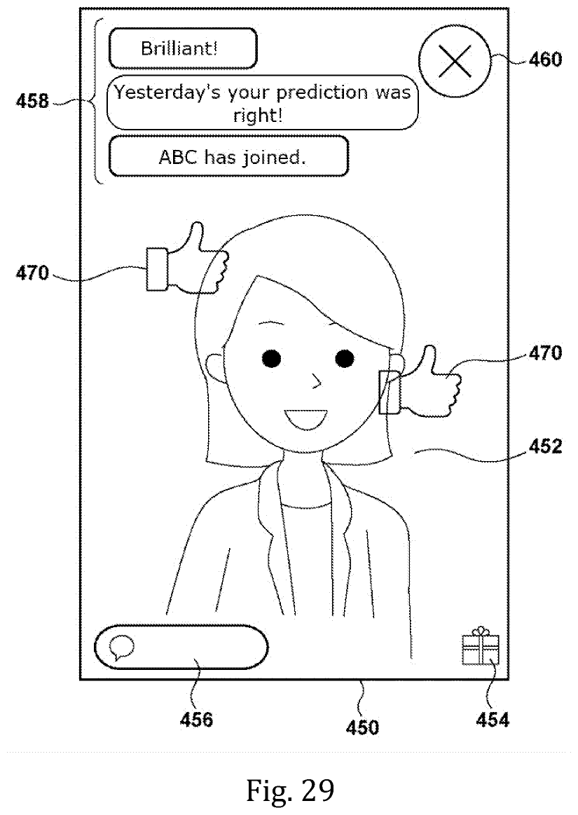

FIG. 29 is a representative screen image of the livestreaming room screen 450 of the non-LC livestream having the effect 470 superimposed thereon, which appears on the display of the viewer terminal of the viewer in the modification example. The comment display area 458 in FIG. 29 may include a system message indicating that the viewer has sent the bonus gift to the livestreamer. This system message may be included in the response to the gift use signal mentioned above. Since the effect corresponding to the bonus gift that can be acquired thorough an LC livestream appears in the non-LC livestream, the live commerce can be recognized by more people. In addition, the livestreamer can know who has used the bonus gift, more specifically, which viewer has made a purchase in an LC livestream. The livestreamer can thank the viewer in the non-LC livestream. Different bonus gifts may be provided for respective items for sale. In this case, the livestreamer can even know which item for sale the viewer has purchased.

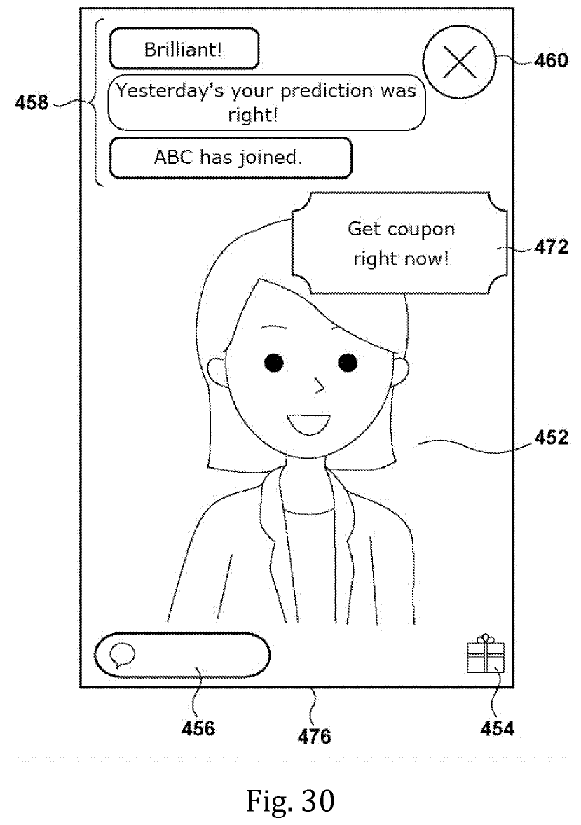

The following describes the series of steps starting from the step where a coupon is granted in a non-LC livestream to the step where the coupon is used in an LC livestream, with reference to representative screen images. FIG. 30 is a representative screen image of a livestreaming room screen 476 of a non-LC livestream appearing on the display of the viewer terminal of the viewer in the modification example. The livestreaming room screen 476 has an object 472 that, when tapped by the viewer, triggers a process of granting a coupon to the viewer. The object 472 may be always displayed on the livestreaming room screen 476 or begin to appear when the viewer meets certain conditions. For example, the object 472 may start appearing when the viewer taps the gift icon 454 to use a predetermined gift or when the accumulated amount of gifts used by the viewer exceeds a predetermined threshold.

On detecting a tap on the object 472, the viewer-side UI control unit 502 of the viewer terminal generates a coupon acquiring request including a coupon ID of a target coupon and transmits the request to the managing server over the network 60. On receiving the coupon acquiring request, the managing server updates the user information holding unit 422 such that the coupon ID included in the request is registered in association with the viewer ID included in the request. The managing server generates a coupon giving completion signal and transmits the signal to the requesting viewer terminal. Based on the received coupon giving completion signal, the viewer-side UI control unit 502 of the viewer terminal generates a notification image 474 notifying the viewer that the viewer receives a coupon available for an item for sale to be presented in an LC livestream delivered by the livestreamer who delivers the non-LC livestream. The notification image 474 includes a description of the coupon given, a discount offered by the coupon, and the expiration date. The viewer-side UI control unit 502 displays the generated notification image 474 on the livestreaming room screen 476.

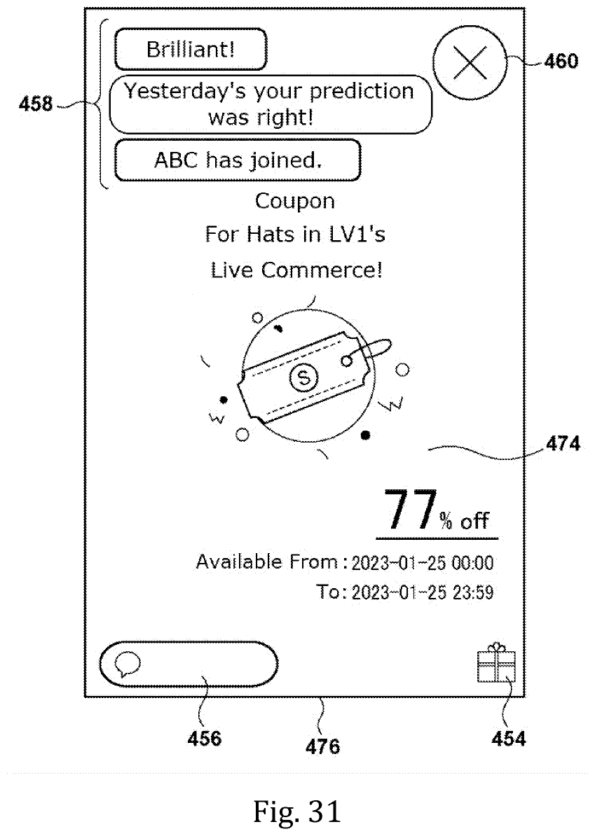

FIG. 31 is a representative screen image of the livestreaming room screen 476 of the non-LC livestream having the notification image 474 superimposed thereon, which appears on the display of the viewer terminal of the viewer in the modification example.

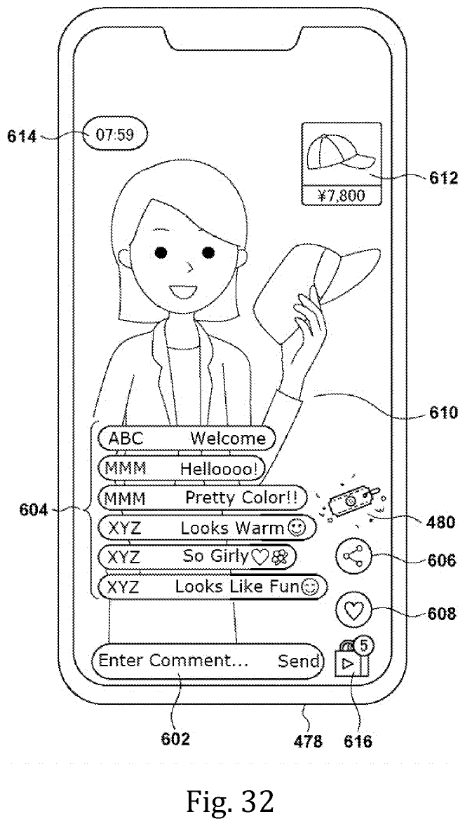

FIG. 32 is a representative screen image of a livestreaming screen 478 of an LC livestream appearing on the display of the viewer terminal of the viewer in the modification example. The livestreamer of the non-LC livestream shown in FIG. 31 will deliver the LC livestream shown in FIG. 32 at a later date. The viewer who has acquired the coupon in the non-LC livestream shown in FIG. 31 may join the LC livestream shown in FIG. 32 as a viewer. The managing server may receive a participation request to participate in the LC livestream from the viewer terminal of this viewer. The managing server may then refer to the user information holding unit 422 to determine whether or not the viewer has been given a coupon that is valid in the LC livestream. If the viewer has a valid coupon, the managing server generates a coupon display request including the coupon ID of the coupon and sends it to the requesting viewer terminal via the network 60. The viewer-side UI control unit 502 of the viewer terminal generates a coupon object 480 representing the coupon identified by the coupon ID included in the received coupon display request and superimposes the generated coupon object 480 on the livestreaming screen 478. The viewer may tap the coupon object 480, which initiates the process of applying the coupon.

In the present modification example described above, a coupon is granted and a special gift is enabled in a livestream in real time. The present modification example, however, is not limited to such. For example, a batch process may be performed once a day to grant a coupon and a special gift. The batch process may be performed by referring to the various history holding units.

The procedures described herein, particularly those described with a flow diagram or a flowchart, are susceptible of omission of part of the steps constituting the procedure, adding steps not explicitly included in the steps constituting the procedure, and/or reordering the steps. The procedure subjected to such omission, addition, or reordering is also included in the scope of the present disclosure unless diverged from the purport of the present invention.

At least some of the functions realized by the server may be realized by a device(s) other than the server, for example, the livestreamer mobile terminal, livestreamer control terminal and viewer terminal. At least some of the functions realized by the livestreamer mobile terminal, livestreamer control terminal and viewer terminal may be realized by a device(s) other than these, for example, the server. For example, there may be a server having the LC functions of the LC server and another server having the remaining functions of the LC server.

The technical ideas relating to the first embodiment may be represented by the following items.

### <Item 1>

A server for providing a livestream where a livestreamer presents and takes an order for an item for sales and receives a gift from a viewer, the server including an enabling unit for, on condition that the viewer performs an operation to place an order for an item for sale, enabling the viewer to use a special gift different from a regular gift.

### <Item 2>

The server of item 1, wherein the special gift has a higher rate of return to the livestreamer than the regular gift.

### <Item 3>

The server of item 1, further including a granting unit for, upon receiving an instruction to use the special gift from the viewer, granting to the viewer a coupon available for an item for sale presented in a livestream.

### <Item 4>

The server of item 3, wherein the granting unit randomly selects one of a plurality of coupons offering different discounts and grants the selected coupon.

### <Item 5>

A server for providing a livestream where a livestreamer presents and takes an order for an item for sale and receives a gift from a viewer, the server including a granting unit for, on condition that the viewer uses a gift, granting to the viewer a coupon available for an item for sale presented in a livestream.

### <Item 6>

The server of item 5, wherein the granting unit randomly selects one of a plurality of coupons offering different discounts and grants the selected coupon.

### <Item 7>

A computer program for use in a terminal of a viewer watching a livestream where a livestreamer presents and takes an order for an item for sale and receives a gift from the viewer, the computer program being configured to cause the terminal to implement functions of:
receiving an operation performed to order an item for sale; and
notifying, in response to receiving the operation performed to order the item for sale, the viewer that the viewer is enabled to use a special gift different from a regular gift.

### <Item 8>

A computer program for use in a terminal of a viewer watching a livestream where a livestreamer presents and takes an order for an item for sale and receives a gift from the viewer, the computer program being configured to cause the terminal to implement functions of:
receiving an instruction to use a gift; and
notifying, in response to receiving the instruction to use the gift, the viewer that the viewer is given a coupon available for an item for sale presented in a livestream.

### <Item 9>

A server of a livestreaming system where a same livestreamer delivers at different times a first livestream where the livestreamer presents and takes order for an item for sale and a second livestream different from the first livestream, the server including
a granting unit for granting to a viewer, in either the first or second livestream, a digital item that is available in the other livestream.

### <Item 10>

The server of item 9, wherein the granting unit grants, on condition that a viewer performs an operation to order an item for sale in the first livestream, a gift available in the second livestream to the viewer.

### <Item 11>

The server of item 10, wherein the gift granted to the viewer of the first livestream is configured such that the gift is allowed to be used only in the second livestream delivered by the livestreamer who delivers the first livestream.

### <Item 12>

The server of item 10, wherein the gift granted to the viewer of the first livestream is configured such that the gift is never obtained by a viewer of the second livestream in the second livestream delivered by the livestreamer who delivers the first livestream.

### <Item 13>

The server of item 10, wherein impressiveness of the gift granted to the viewer increases in proportion to a price of the item for sale ordered.

### <Item 14>

The server of item 10, further including a generating unit for generating a leaderboard that ranks livestreamers by a volume of gifts received by the livestreamers from viewers of the first livestream to whom the gifts are granted.

### <Item 15>

The sever of item 9, wherein the granting unit grants, in the second livestream to a viewer of the second livestream, a coupon available for an item for sale presented in the first livestream delivered by the livestreamer who delivers the second livestream.

### <Item 16>

The server of item 15, wherein a discount offered by the coupon granted by the granting unit to the viewer increases in proportion to a level of interaction between the livestreamer and the viewer in the second livestream.

### <Item 17>

A computer program for use in a terminal of a viewer watching a first livestream where a livestreamer presents and takes an order for an item for sale, the computer program being configured to cause the terminal to implement functions of:
receiving an operation performed to order an item for sale; and
notifying, in response to receiving the operation performed to order the item for sale, the viewer that the viewer is given a gift available in a second livestream different from the first livestream but delivered by the livestreamer who delivers the first livestream.

### <Item 18>

A computer program for use in a terminal of a viewer watching a second livestream where a livestreamer receives a gift from the viewer, the computer program being configured to cause the terminal to implement functions of:
receiving an instruction to use a gift; and
notifying, in response to receiving the instruction to use the gift, the viewer that the viewer is given a coupon available for an item for sale presented in a first livestream different from the second livestream but delivered by the livestreamer who delivers the second livestream.

### Second Embodiment

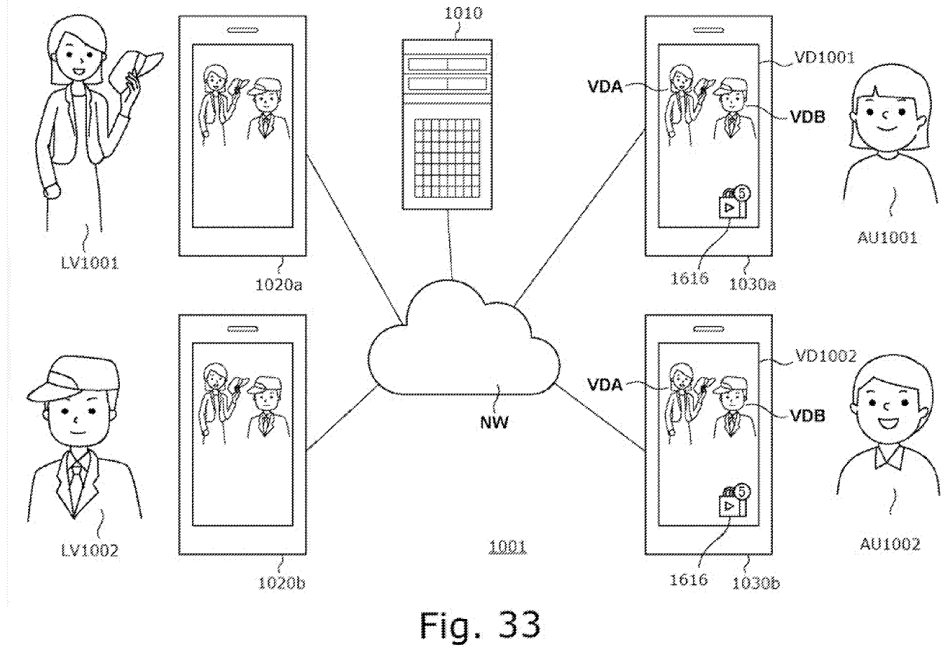

FIG. 33 schematically illustrates a configuration of a live commerce system 1001 according to a second embodiment. The live commerce system 1001 provides livestreams delivered for the purpose of selling goods and/or services (hereinafter simply referred to as “items for sale”) (hereinafter referred to as “LC livestreams”). A LC livestream is an interactive livestream that allows a livestreamer LV (also referred to as a liver or streamer) and a viewer AU (also referred to as audience) to communicate in real time. The live commerce system 1001 includes a live commerce (LC) server 1010, user terminals 1020 (1020a, 1020b, . . . ) on the livestreamer (LV1001, LV1002, . . . ) side, and user terminals 1030 (1030a, 1030b, . . . ) on the audience (AU1001, AU1002, . . . ) side. The livestreamers and viewers may be collectively referred to as users. The LC server 1010, the user terminals 1020 on the livestreamer side, and the user terminals 1030 on the audience side are interconnected so as to be able to communicate with each other over a network NW such as the Internet. The LC server 1010 may be one or more information processing devices connected to the network NW. The user terminals 1020 and 1030 may be, for example, mobile terminal devices such as smartphones, tablets, laptop PCs, recorders, portable gaming devices, and wearable devices, or may be stationary devices such as desktop PCs.

The live commerce system 1001 involves the livestreamers LV who present and sell items for sale or mediate the sales, the viewers AU who order and purchase the items for sale, and an administrator (not shown) who manages the LC server 1010. The livestreamers LV broadcast contents in real time by recording the contents with their user terminal 1020 and uploading them directly to the LC server 1010. The contents may include the livestreamers LV presenting items for sale. The administrator manages the LC server 1010 to provide an LC platform for LC livestreams, and also mediates or manages real-time interactions between the livestreamers LV and the viewers AU and orders and payments for the items for sale between the livestreamers LV and the viewers AU. The viewers AU access the platform at their user terminals 1030 to select and view a desired LC livestream. During the LC livestream, the viewers AU make comments to ask about the items for sale via the user terminals 1030, the livestreamer LV responds to such questions viva voce, and such response is transmitted to the viewers AU via video and/or audio, thereby establishing an interactive communication.

As used herein, the term “livestreaming” or “livestream” may mean a mode of data transmission that allows a content recorded at the user terminals 1020 of the livestreamers LV to be played and viewed at the user terminals 1030 of the viewers AU substantially in real time, or it may mean a live broadcast realized by such a mode of transmission. The livestreaming may be achieved using existing livestreaming technologies such as HTTP Live Streaming, Common Media Application Format, Web Real-Time Communications, Real-Time Messaging Protocol and MPEG DASH. The livestreaming includes a transmission mode in which, while the livestreamers LV are recording contents, the viewers AU can view the contents with a certain delay. The delay is acceptable as long as interaction between the livestreamers LV and the viewers AU can be at least established. Note that the livestreaming is distinguished from so-called on-demand type transmission, in which contents are entirely recorded and the entire data is once stored on the server, and the server provides users with the data at any subsequent time upon request from the users.

The term “video data” herein refers to data that includes image data (also referred to as moving image data) generated using an image capturing function of the user terminals 1020 and 1030 and audio data generated using an audio input function of the user terminals 1020 and 1030. Video data is reproduced in the user terminals 1020 and 1030, so that the users can view LC livestreams. In this embodiment, it is assumed that between video data generation at the live-streamer's user terminal and video data reproduction at the viewer's user terminal, processing is performed onto the video data to change its format, size, or specifications of the data, such as compression, decompression, encoding, decoding, or transcoding. However, such processing does not substantially change the content (e.g., video images and audios) represented by the video data, so that the video data after such processing is herein described as the same as the video data before such processing. In other words, when video data is generated at the live-streamer's user terminal, relayed by the LC server 1010 and then played back at the viewer's user terminal, the video data generated at the live-streamer's user terminal, the video data that passes through the LC server 1010, and the video data received and reproduced at the viewer's user terminal are all the same video data.

In the present embodiment, a plurality of LC livestreams respectively delivered by different livestreamers via different user terminals are provided to the viewers simultaneously via the same single screen. In the following description, this livestreaming mode is referred to as the simultaneous LC livestreaming. The LC livestreams delivered in the simultaneous LC livestreaming are all associated with the same or corresponding items for sale. For example, the LC livestreams delivered in the simultaneous LC livestreaming are provided to present and take orders for the same item for sale. Here, the expression “corresponding items for sale” mean a plurality of different items for sale available from the same manufacturer or seller.

The simultaneous LC livestreaming may be characterized in that the involved livestreamers compete each other or cooperate with each other. The competing simultaneous LC livestreaming may be typified by VSLC livestreams where the involved livestreamers compete for the sales or number of units sold for the item for sale within a predetermined competition period. The cooperating simultaneous LC livestreaming may be typified by group call LC livestreams hosted by a livestreamer entrusted by the seller or manufacturer of an item for sale, where the livestreamer invites at least one other livestreamer as a guest and talk with the guest to present the item for sale. In the case of group call LC livestreams, the LC server 1010 recognizes the viewers as the viewers acquired by the host. This way of recognizing the viewers is only an example, and the viewers can be recognized in other manners in other embodiments.

In the example shown in FIG. 33, the livestreamers LV1001 and LV1002 participate in an VSLC livestream. The livestreamer LV1001 delivers an LC livestream, where the livestreamer LV1001 presents an item for sales. The user terminal 1020a of the livestreamer LV1001 generates video data by recording images and sounds of the livestreamer LV1001, and the generated data is transmitted to the LC server 1010 over the network NW. The livestreamer LV1002 delivers an LC livestream, where the livestreamer LV1002 presents the same item for sales as does the livestreamer LV1001. The user terminal 1020b of the livestreamer LV1002 generates video data by recording images and sounds of the livestreamer LV1002, and the generated data is transmitted to the LC server 1010 over the network NW.

The user terminals 1030a and 1030b of the viewers AU1001 and AU1002 who are watching the LC livestream delivered by the livestreamer LV1001 or the LC livestream delivered by the livestreamer LV1002 receive video data related to the LC livestream delivered by the livestreamer LV1001 and video data related to the LC livestream delivered by the livestreamer LV1002 over the network NW and reproduce the received video data, to display video images VD1001 and VD1002 on the displays and output audio through the speakers. The video images VD1001 and VD1002 displayed on the respective user terminals 1030a and 1030b are substantially the same. The video images VD1001 and VD1002 include an area for displaying a video image VDA captured by the user terminal 1020a of the livestreamer LV1001 and an area for displaying a video image VDB captured by the user terminal 1020b of the livestreamer LV1002. The video VDA and the video VDB are reproduced simultaneously on the user terminals 1030 of the viewers and shown within the same screen on their displays. The audio outputted by the user terminal 1030a is substantially the same as the audio outputted by the user terminal 1030b. The audio outputted by the user terminals 1030a and 1030b include the voices acquired by the user terminal 1020a of the livestreamer LV1001 and the voices acquired by the user terminal 1020b of the livestreamer LV1002. The user terminal 1020a of the livestreamer LV1001 receives the video VDB of the livestreamer LV1002 over the network NW, and displays it on the display together with the video VDA of the livestreamer LV1001. The user terminal 1020b of the livestreamer LV1002 receives the video VDA of the livestreamer LV1001 over the network NW, and displays it on the display together with the video VDB of the livestreamer LV1002.

On the video images VD1001 and VD1002 displayed at the user terminals 1030a and 1030b of the viewers, a cart icon 1616 for allowing the viewers AU1001 and AU1002 to place an order for the item for sale is superimposed. While watching the VSLC livestream, the viewers AU1001 and AU1002 may tap the cart icon 1616 to order and/or purchase the item for sale.

Recording of the images and sounds at the user terminals 1020 of the livestreamers LV and reproduction of the video data at the user terminals 1030 of the viewers AU are performed substantially simultaneously. The livestreamer LV1001 may present an item for sale, and the viewer AU1001 may type a comment on the user terminal 1030a in a responding manner. The LC server 1010 displays the comment on the user terminal 1020a of the livestreamer LV1001 in real time and also displays the comment on the user terminal 1020b of the other livestreamer LV 1002 and the user terminals 1030a and 1030b of the viewers AU1001 and AU1002, respectively. When the livestreamer LV1001 reads the comment and mentions or talks about the contents of the comment, the video and audio of the talk are outputted on the user terminal 1020b of the livestreamer LV1002 and the user terminals 1030a and 1030b of the viewers AU1001 and AU1002, respectively. This is recognized as establishment of a conversation between the livestreamer LV1001 and the viewer AU1001. In this way, the live commerce system 1001 realizes the simultaneous LC livestreaming that enables the interactive communication, not one-way communication.

The live commerce system 1001 relating to the present embodiment can provide for simultaneous LC livestreaming, where a plurality of livestreamers can present and/or sell the same or corresponding items for sale simultaneously via the same screen. By observing the communication and interaction between the livestreamers, the viewers can get a lot of information about the items for sale from more than one perspective. The viewers can feel more satisfaction through their shopping experience. The simultaneous LC livestreaming can involve competition. Since the competitors are seen in the same screen, the livestreamers feel more motivated and concentrated. This may be translated into enhanced quality of the LC livestreams, thereby improving the sales. The simultaneous LC livestreaming can not only allow the users to experience selling items through livestreams but also provide competition for the sales or a brand-new type of entertainment. The simultaneous LC livestreaming can be of cooperation. The host may listen to what the guests want to know or think about the items for sale in real time and answer to or comment on the guests' remarks in real time. This can deepen the viewers' understanding of the items for sale, thereby allowing the viewers feel more satisfied through their shopping experience. A loyal user who loves the items for sale can be invited as a guest. The user's favorable comments can directly reach the viewers.

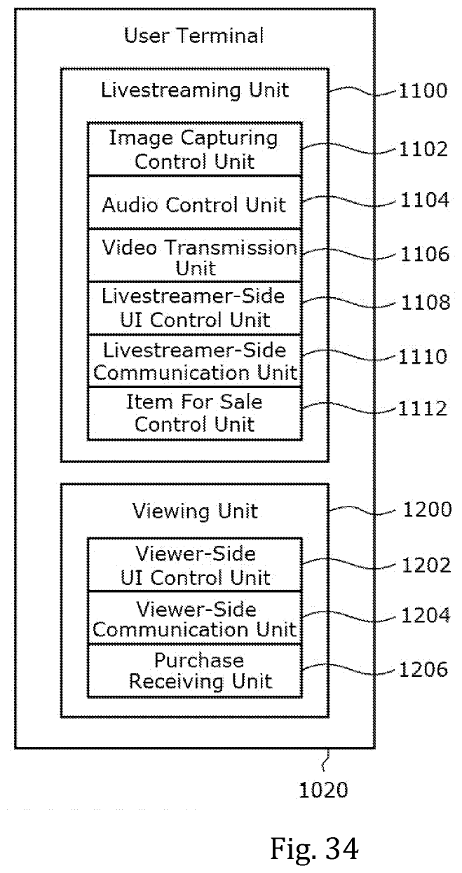

FIG. 34 is a block diagram showing functions and configuration of the user terminals 1020 of FIG. 33. The user terminals 1030 have the same functions and configuration as the user terminal 1020. The blocks in FIG. 34 and the subsequent block diagrams may be realized by elements such as a computer CPU or a mechanical device in terms of hardware, and can be realized by a computer program or the like in terms of software. The blocks shown in the drawings are, however, functional blocks realized by cooperative operation between hardware and software. Therefore, it is understood by those skilled in the art that these functional blocks can be realized in various forms by combining hardware and software.

The livestreamers LV and the viewers AU download and install an LC livestreaming application program (hereinafter referred to as the LC application), onto the user terminals 1020 and 1030 from a download site over the network NW. Alternatively, the LC application may be pre-installed on the user terminals 1020 and 1030. When the LC application is executed on the user terminals 1020 and 1030, the user terminals 1020 and 1030 communicate with the LC server 1010 over the network NW to implement various functions. Hereinafter, the functions implemented by (processors such as CPUs of) the user terminals 1020 and 1030 by running the LC application will be described as functions of the user terminals 1020 and 1030. These functions are realized in practice by the LC application on the user terminals 1020 and 1030. In any other embodiments, these functions may be realized by a computer program written in a programming language such as HTML (HyperText Markup Language), which is transmitted from the LC server 1010 to web browsers of the user terminals 1020 and 1030 over the network NW and executed by the web browsers.

The user terminals 1020 each include a livestreaming unit 1100 that generates video data in which the user's image and sound are recorded and provides the video data to the LC server 1010 and manages items for sale during LC livestreams, and a viewing unit 1200 to which the video data is provided from the LC server 1010 to reproduce the video data and that receives operations performed to order items for sale during LC livestreams. The user activates the livestreaming unit 1100 when the user performs livestreaming, and activates the viewing unit 1200 when the user views a video. The user terminal in which the livestreaming unit 1100 is activated is the livestreamer's terminal, i.e., the user terminal that generates the video data or sells items for sale, and the user terminal in which the viewing unit 1200 is activated is the viewer's terminal, i.e., the user terminal in which the video data is reproduced and played or that buys items for sale.

The livestreaming unit 1100 includes an image capturing control unit 1102, an audio control unit 1104, a video transmission unit 1106, a livestreamer-side UI control unit 1108, a livestreamer-side communication unit 1110 and an item for sale control unit 1112. The image capturing control unit 1102 is connected to a camera (not shown in FIG. 34) and controls image capturing performed by the camera. The image capturing control unit 1102 obtains image data from the camera. The audio control unit 1104 is connected to a microphone (not shown in FIG. 34) and controls audio input from the microphone. The audio control unit 1104 obtains audio data through the microphone. The video transmission unit 1106 transmits video data including the image data obtained by the image capturing control unit 1102 and the audio data obtained by the audio control unit 1104 to the LC server 1010 over the network NW. The video data is transmitted by the video transmission unit 1106 in real time. That is, the generation of the video data by the image capturing control unit 1102 and the audio control unit 1104, and the transmission of the generated video data by the video transmission unit 1106 are performed substantially at the same time.

The livestreamer-side UI control unit 1108 controls the UI for the livestreamer. The livestreamer-side UI control unit 1108 is connected to the display, which is not shown in FIG. 34. The livestreamer-side UI control unit 1108 reproduces the video data that is to be transmitted from the video transmission unit 1106 and the video data received via the LC server 1010 from the user terminal of the other livestreamer participating in the simultaneous LC livestreaming, so that a simultaneous LC livestream screen including the video images of the livestreamers participating in the simultaneous LC livestreaming appears on the display. The livestreamer-side UI control unit 1108 is connected to input means (not shown in FIG. 34) such as touch panels, keyboards, and displays, and obtains the livestreamer's input via the input means. The livestreamer-side UI control unit 1108 incorporates a predetermined frame image into the simultaneous LC livestream screen. The frame image may include various user interface objects (hereinafter simply referred to as “objects”) for receiving inputs from the livestreamer, comments entered by the viewers and other livestreamer, and information obtained from the LC server 1010. The livestreamer-side UI control unit 1108 receives comments input by the livestreamer.

The livestreamer-side communication unit 1110 controls communication with the LC server 1010 in the simultaneous LC livestreaming. The livestreamer-side communication unit 1110 transmits the content of the livestreamer's input (for example, comments and the like) that has been obtained by the livestreamer-side UI control unit 1108 to the LC server 1010 over the network NW. The livestreamer-side communication unit 1110 receives various information associated with the simultaneous LC livestreaming from the LC server 1010 over the network NW.

The item for sale control unit 1112 works with the LC server 1010 via the network NW to provide the e-commerce functionality in the simultaneous LC livestreaming. The item for sale control unit 1112 controls the items for sale to be presented in the simultaneous LC livestreaming.

The viewing unit 1200 includes a viewer-side UI control unit 1202, a viewer-side communication unit 1204 and a purchase receiving unit 1206. The viewer-side communication unit 1204 controls communication with the LC server 1010 in the simultaneous LC livestreaming. The viewer-side communication unit 1204 receives, from the LC server 1010 over the network NW, the video data generated by the user terminals of the respective livestreamers participating in the simultaneous LC livestreaming.

The viewer-side UI control unit 1202 controls the UI for the viewer. The viewer-side UI control unit 1202 is connected to a display and a speaker (not shown in FIG. 34), and reproduces the received video data so that the video images are displayed on the display and the sounds are output through the speaker. The state where the images and sounds are respectively output through the display and speaker can be referred to as “the video data is reproduced”. The viewer-side UI control unit 1202 receives from the LC server 1010 and reproduces the video data generated at the user terminals of the respective livestreamers participating in the simultaneous LC livestreaming, so that a simultaneous LC livestream screen including the video images of the livestreamers participating in the simultaneous LC livestreaming appears on the display.

The viewer-side UI control unit 1202 is also connected to input means (not shown in FIG. 34) such as touch panels, keyboards, and displays, and obtains the viewer's input via the input means. The viewer-side UI control unit 1202 incorporates a predetermined frame image into the simultaneous LC livestream screen. The frame image includes various objects such as the cart icon 1616 for receiving inputs from the viewer, comments entered by the viewers and livestreamers, and information obtained from the LC server 1010. The viewer-side communication unit 1204 transmits the content of the viewer's input obtained by the viewer-side UI control unit 1202 to the LC server 1010 over the network NW.

The purchase receiving unit 1206 receives an operation performed to order the items for sale related to the LC livestreams delivered by the livestreamers participating in the simultaneous LC livestreaming. The viewer watching the simultaneous LC livestreaming may perform a predetermined operation to order a desired item for sale. The purchase receiving unit 1206 interprets this predetermined operation as an instruction to make a purchase. The predetermined operation may be, for example, tapping a thumbnail representing the desired item for sale displayed on the simultaneous LC livestream screen. Alternatively, the predetermined operation may be selecting the desired item for sale from a list of items for sale. Alternatively, the predetermined operation may be a series of inputs made to add the desired item for sale to the cart (add-to-cart). Alternatively, the predetermined operation may be tapping the cart icon 1616 to proceed with the order of the item for sale, ordering the item for sale, or completing payment for the purchase of the item for sale. In response to the predetermined operation, the purchase receiving unit 1206 generates a purchase request signal including the viewer ID identifying the viewer who has performed the predetermined operation, the livestreamer ID identifying the livestreamer delivering the LC livestream being watched by the viewer (in the case of an VSLC livestream, the livestreamer ID identifying one of the livestreamers, in the case of a group call LC Livestream, the livestreamer ID identifying the host), and the item for sale ID identifying the item for sale for which the predetermined operation is performed, and sends it to the LC server 1010 via the network NW.

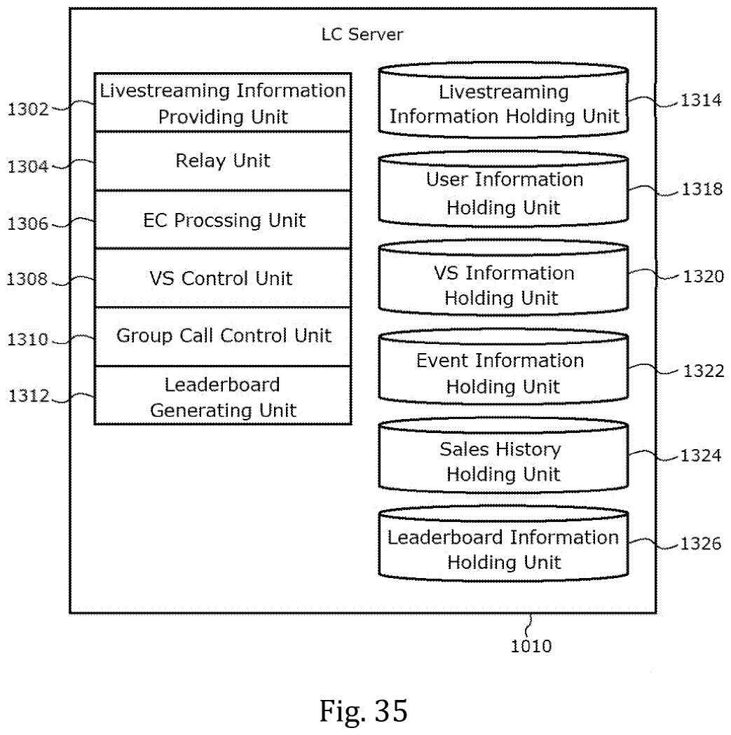

FIG. 35 is a block diagram showing functions and configuration of the LC server 1010 of FIG. 33. The LC server 1010 provides LC livestreams. The LC server 1010 includes a livestreaming information providing unit 1302, a relay unit 1304, an EC processing unit 1306, a VS control unit 1308, a group call control unit 1310, a leaderboard generating unit 1312, a livestreaming information holding unit 1314, a user information holding unit 1318, a VS information holding unit 1320, an event information holding unit 1322, a sales history holding unit 1324, and a leaderboard information holding unit 1326.

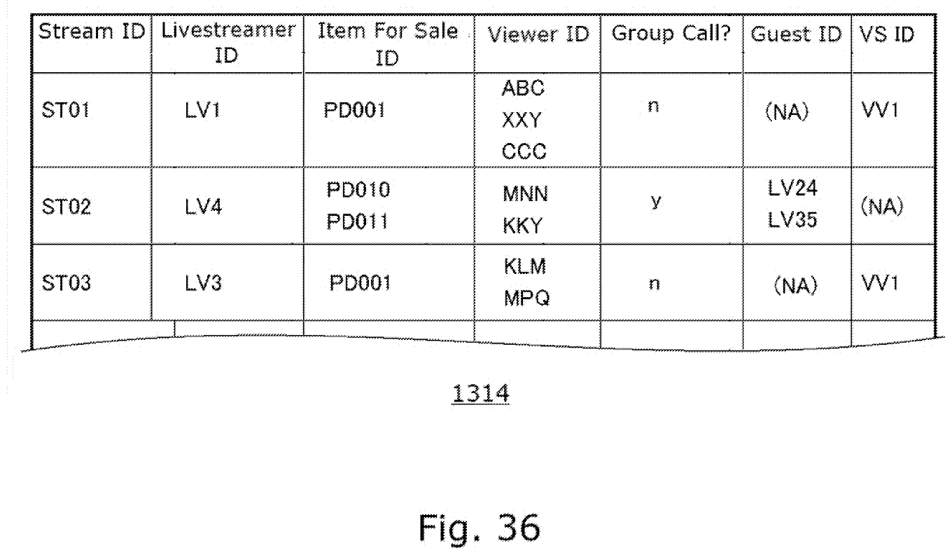

FIG. 36 is a data structure diagram of an example of the livestreaming information holding unit 1314 of FIG. 35. The livestreaming information holding unit 1314 holds information about LC livestreams currently delivered on the LC platform provided by the live commerce system 1001. The livestreaming information holding unit 1314 stores, in association with each other, a stream ID identifying an LC livestream on the LC platform, a livestreamer ID, which is a user ID for identifying the livestreamer of the LC livestream, an item for sale ID identifying an item for sale that can be purchased via the LC livestream, a viewer ID, which is a user ID for identifying a viewer of the LC livestream, a flag indicating whether the LC livestream is a group call LC livestream, a guest ID identifying, if the LC livestream is a group call LC livestream, a guest of the group call LC livestream, and a VSID identifying, if the livestreamer of the LC livestream participates in a VSLC livestream, the VSLC livestream. If the LC livestream is a group call LC livestream, the livestreamer identified by the livestreamer ID is the host.

The livestreamer ID may be configured to identify an individual livestreamer or a group of livestreamers (e.g., a company). If a plurality of items for sale are presented in an LC livestream, a plurality of item for sale IDs are associated with a single stream ID.

In the LC platform provided by the live commerce system 1001 of the embodiment, when a user delivers an LC livestream, the user is referred to as a livestreamer, and when the same user views an LC livestream delivered by another user, the user is referred to as a viewer. Therefore, the distinction between a livestreamer and a viewer is not fixed, and a user ID registered as a livestreamer ID at one time may be registered as a viewer ID at another time.

When the LC livestream is a VSLC livestream, the LC server 1010 recognizes the viewer of the VSLC livestream as the viewer for one of the livestreamers. Taking the example shown in FIG. 33, although watching both of the LC livestreams delivered by the livestreamers LV1001 and LV1002 in a VSLC livestream, the viewer AU1 is recognized as the viewer for the livestreamer LV1001 but not as the viewer for the livestreamer LV1002. The LC server 1010 can recognize the viewers in this way since the livestreaming information holding unit 1314 holds entries each of which associate together an LC livestream, a livestreamer ID, a viewer ID and a VSID. More specifically, in the livestreaming information holding unit 1314, the same VSID is associated with two livestreamer IDs (=two stream IDs), which means that those two livestreamers compete in the VSLC livestream. Furthermore, in the livestreaming information holding unit 1314, these two livestreamer IDs are each associated with at least one viewer ID. The viewers associated with the same VSID in the livestreaming information holding unit 1314 can each watch the VSLC livestream identified by the VSID via a simultaneous LC livestream screen 1620, which will be described later, as the viewer of the VSLC livestream. In the livestreaming information holding unit 1314, on the other hand, each of these viewers is associated with one of the livestreamers competing in the VSLC livestream. This means that the LC server 1010 can recognize each viewer as a viewer of the LC livestream delivered by the associated one of the livestreamers. Referring to the example in FIG. 36, a VSLC livestream “VV1” is currently taking place, where livestreamers “LV1” and “LV3” compete. The VSLC livestream “VV1” is watched by viewers “ABC”, “XXY”, “CCC”, “KLM” and “MPQ”, of which the viewers “ABC”, “XXY” and “CCC” are recognized as the viewers of the LC livestream “ST01” (the livestreamer “LV1”), and the viewers “KLM” and “MPQ” are recognized as the viewers of the LC livestream “ST03” (the livestreamer “LV3”).

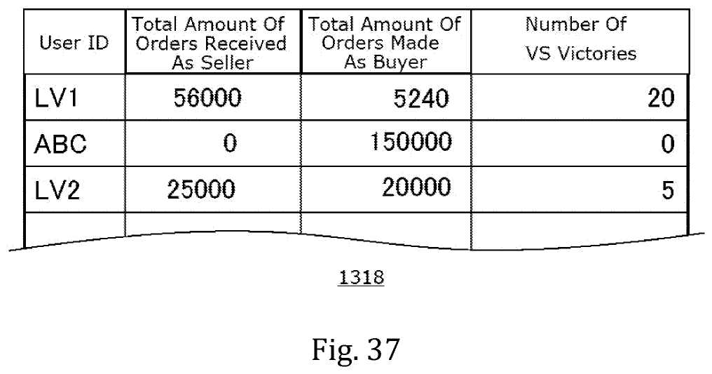

FIG. 37 is a data structure diagram of an example of the user information holding unit 1318 of FIG. 35. The user information holding unit 1318 holds information regarding users. The user information holding unit 1318 holds, in association with each other, a user ID identifying a user, the total amount of orders placed in all of the LC livestreams delivered by the user as the livestreamer or in some of them delivered within a certain period of time, the total amount of orders made in all of the LC livestreams in which the user participates as the viewer or in some of them delivered within a certain period of time, the number of victories won by the user in all of the VSLC livestreams in which the user participates as the livestreamer or some of them delivered within a certain period of time.

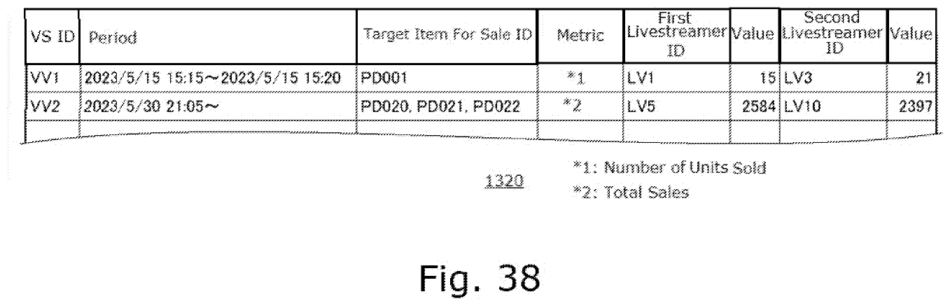

FIG. 38 is a data structure diagram of an example of the VS information holding unit 1320 of FIG. 35. The VS information holding unit 1320 holds, in association with each other, a VSID identifying a VSLC livestream delivered on the LC platform, a competition period during which the VSLC livestream takes place, a target item for sale ID identifying an item for sale designated in the VSLC livestream, a metric serving as a benchmark based on which a winner of the VSLC livestream is determined, a first livestreamer ID identifying a first one of the two livestreamers participating in the VSLC livestream, a value of the metric of the first livestreamer, a second livestreamer ID identifying a second one of the two livestreamers participating in the VSLC livestream, and a value of the metric of the second livestreamer.

The information recorded as the competition period during which the VSLC livestream takes place varies depending on whether the VSLC livestream took place in the past or is currently taking place. In the former case, a set of a start time and an end time of the VSLC livestream is recorded, and a start time of the VSLC livestream is recorded for the latter.

The benchmark to determine the winner of the VSLC livestream indicates the volume of orders placed for the target item for sale through the LC livestream delivered by the corresponding livestreamer. According to the e-commerce function of the LC platform, items for sale may be sold through the following series of steps.
(1) An item for sale is added to the cart.
(2) The order for the item for sale in the cart is finalized.
(3) Payment is made.
(4) The order is shipped.

In the present embodiment, once the step (2) of finalizing the order is completed, the purchase is deemed to be completed. The benchmark represents the number of units, for the target item for sale, for which the purchase is completed. For example, the benchmark may represent (i) the number of units, for the target item for sale, for which the purchase is completed (hereinafter, referred to as the number of units sold) from among the units added to the cart via the LC livestream delivered by the corresponding livestreamer in the VSLC livestream, or (ii) the total amount of units, for the target item for sale, for which the purchase is completed (hereinafter, referred to as the total sales) from among the units added to the cart via the LC livestream delivered by the corresponding livestreamer in the VSLC livestream. Alternatively, the benchmark may represent the number of viewers who add the target item for sale to the cart and complete the purchase via the LC livestream delivered by the corresponding livestreamer in the VSLC livestream. In other embodiments, the benchmark may represent the number of viewers who add the target item for sale into the cart via the LC livestream delivered by the corresponding livestreamer in the VSLC livestream. Alternatively, the benchmark may represent the number of viewers who comment on the target item for sale via the LC livestream delivered by the corresponding livestreamer in the VSLC livestream. In every case, the benchmark can represent the volume of orders placed for the target item for sale via the LC livestream delivered by the corresponding livestreamer.

In the example shown in FIG. 38, the second entry indicates that a VSLC livestream identified by a VSID “VV2” started at 21:05 on May 30, 2023 and is currently taking place, that livestreamers “LV5” and “LV10” are competing for the total sales of the items for sale “PD020”, “PD021,” and “PD022” (a group of products available from the same seller), and that the livestreamer “LV5” has so far achieved a total sales of “2584” and the livestreamer “LV10” has so far achieved a total sales of “2397”.

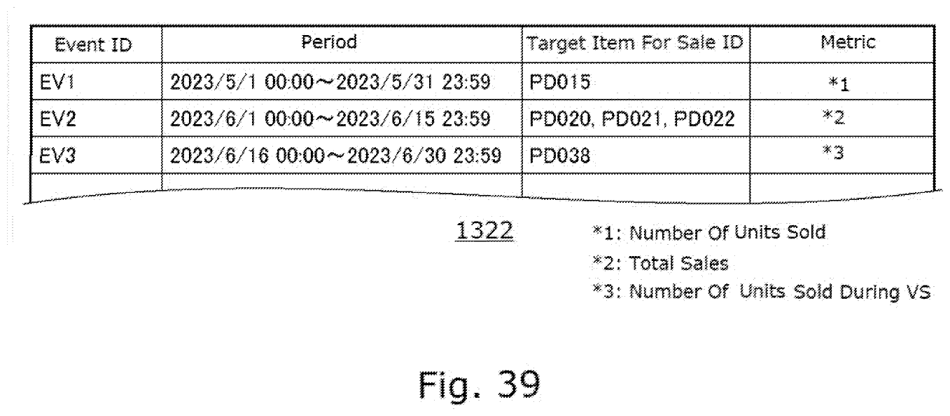

FIG. 39 is a data structure diagram of an example of the event information holding unit 1322 of FIG. 35. The event information holding unit 1322 stores information about LC events held on the LC platform. The event information holding unit 1322 holds, in association with each other, an event ID identifying an event, the duration of the event, a target item for sale ID identifying an item for sales designated in the event, and a metric serving as the benchmark to determine the rank in the event.

The benchmark to determine the rank in the event can be any of various factors depending on the event design. For example, the benchmark may be the number of units sold or the total sales for the target item for sale during the duration of the event. Alternatively, the benchmark may be the number of viewers who add the target item for sale to the cart via LC livestreams delivered during the duration of the event. Alternatively, the benchmark may be the number of units sold or the total sales via simultaneous LC livestreaming (VSLC livestreams and/or group call LC livestreams delivered) during the duration of the event. Alternatively, the benchmark may be the number of victories won in VSLC livestreams delivered during the duration of the event. Prizes may be awarded to livestreamers who perform well, e.g., rank high, in events.

In the example in FIG. 39, the first entry indicates that an event “EV1” is held starting on May 1, 2023 at 0:00:00 and ends on May 31, 2023 at 23:59, and that the livestreamers are ranked by the number of units sold for an item for sale “PD015” via LC livestreams delivered during the duration of the event.

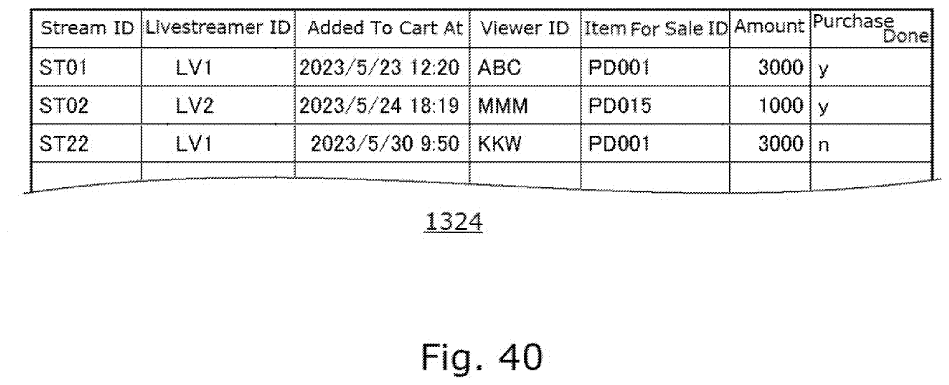

FIG. 40 is a data structure diagram of an example of the sales history holding unit 1324 of FIG. 35. The sales history holding unit 1324 holds, in association with each other, a stream ID, a livestreamer ID identifying a livestreamer delivering the LC livestream identified by the stream ID, the time when an item for sale is added to the cart in the LC livestream identified by the stream ID, a viewer ID identifying the viewer who adds the item for sale to the cart, an item for sale ID identifying the item for sale added to the cart, the price of the item for sale, and a flag indicating whether the purchase of the item for sale is completed.

Referring to the example in FIG. 40, the first entry indicates that, in an LC livestream “ST01” delivered by a livestreamer “LV1,” a viewer “ABC” adds an item for sale “PD001” in the cart at 12:20 on May 23, 2023, that the price of the item for sale is “3000”, and that the purchase of the item for sale “PD001” by the viewer “ABC” is completed.

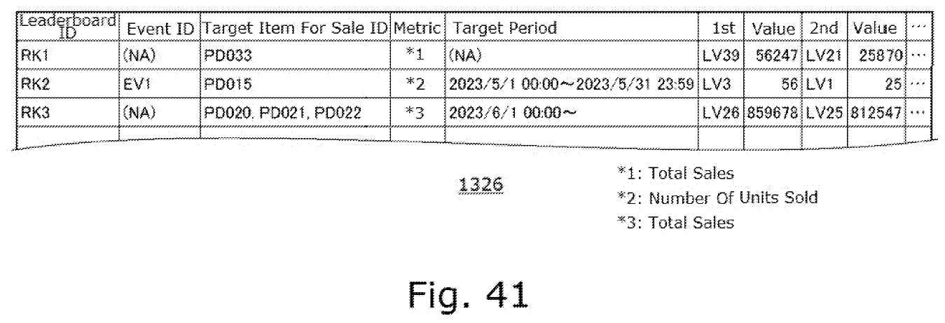

FIG. 41 is a data structure diagram of an example of the leaderboard information holding unit 1326 of FIG. 35. The leaderboard information holding unit 1326 stores information on a leaderboard that is generated by the LC platform and ranks livestreamers. The leaderboard information holding unit 1326 holds, in association with each other, a leaderboard ID identifying a leaderboard, an event ID identifying, if the leaderboard is generated in an event, the event, a target item for sale ID identifying an item for sale designated for the leaderboard, a metric serving as a benchmark to determine a place in the leaderboard, a period of time for which the leaderboard is generated, a livestreamer ID identifying a livestreamer who is top in the leaderboard and the value of the metric of the livestreamer, a livestreamer ID identifying a livestreamer who is the second in the leaderboard and the value of the metric of the livestreamer, and livestreamer IDs identifying the other livestreamers who are mentioned in the leaderboard and the values of the metric of the livestreamers.

The information recorded as the period of time for which the leaderboard is generated varies depending on whether the leaderboard is based on past or current information. In the former case, a set of a start time and an end time of the counting is recorded, and a start time of the counting is recorded for the latter. If the leaderboard is not restricted to any particular period of time, NA (none) is recorded.

If the leaderboard is generated in an event, the values recorded as the target item for sale ID, metric, and period of time in the leaderboard information holding unit 1326 are the same as the values recorded in association with the corresponding event ID as the target item for sale ID, metric and period of time in the event information holding unit 1322. This can be demonstrated by observing the second entry in FIG. 41 (event ID “EV1”) and the first entry in FIG. 39 (event ID “EV1”).

The benchmark to determine a place in the leaderboard can be equivalent to that used in the event.

Referring to the example shown in FIG. 41, the first entry indicates that a leaderboard “RK1” is generated by the total sales of the item for sale “PD0033” via LC livestreams regardless of any events, and has no value recorded as the period of time. In the leaderboard “RK1,” a livestreamer “LV39” is currently in the first place with a total sales of “56247,” and a livestreamer “LV21” is in the second place with a total sales of “25870.”

Referring again to FIG. 35, upon reception of a notification from any one of the user terminals 1020 of the livestreamers over the network NW indicating that the livestreamer starts an LC livestream, the livestreaming information providing unit 1302 registers in the livestreaming information holding unit 1314 the stream ID identifying the LC livestream and the livestreamer ID of the livestreamer who delivers the LC livestream. When receiving a request to provide information about LC livestreams from any one of the user terminals 1030 of the viewers over the network NW, the livestreaming information providing unit 1302 refers to the livestreaming information holding unit 1314 to make a list of currently available LC livestreams. The livestreaming information providing unit 1302 transmits the generated list to the requesting viewer's user terminal 1030 over the network NW. The requesting viewer's user terminal 1030 generates an LC livestream selection screen based on the received list and shows the screen on the display.

Once the user terminal 1030 of the viewer receives an LC livestream selected on the LC livestream selection screen, the user terminal 1030 of the viewer generates a livestreaming request including the stream ID of the selected LC livestream, and transmits the request to the LC server 1010 over the network NW. The livestreaming information providing unit 1302 starts to provide, to the requesting viewer's user terminal 1030, the LC livestream identified by the stream ID included in the received livestreaming request. The livestreaming information providing unit 1302 updates the livestreaming information holding unit 1314 to include the user ID of the requesting viewer into the viewer IDs associated with the stream ID.

The relay unit 1304 relays the video data from the livestreamer-side user terminal 1020 to the viewer-side user terminal 1030 in the LC livestream started by the livestreaming information providing unit 1302. The relay unit 1304 receives from the viewer-side communication unit 1204 a signal that represents user input by a viewer during the LC livestream or reproduction of the video data. The signal that represents user input may be an object specifying signal for specifying an object displayed on the display of the user terminal 1030 of the viewer, and the object specifying signal includes the viewer ID of the viewer, the stream ID identifying the LC livestream that the viewer watches, the livestreamer ID of the livestreamer of the LC livestream, and an object ID that identifies the object. Similarly, the relay unit 1304 receives from the livestreamer-side communication unit 1110 of the user terminal 1020 of the livestreamer a signal that represents user input by the livestreamer during reproduction of the video data, such as an object specifying signal.

In the case of simultaneous LC livestreaming, the relay unit 1304 relays video data from the user terminals of the livestreamers to the user terminals of the viewers, the video data being related to the LC livestreams delivered by the respective livestreamers participating in the simultaneous LC livestreaming. In the case of a VSLC livestream in which two livestreamers participate, the relay unit 1304 relays video data from the user terminal of a first one of the livestreamers to the user terminals of the viewers of the VSLC livestream, the video data being related to the LC livestream delivered by the first livestreamer. At the same time, the relay unit 1304 relays video data from the user terminal of a second one of the livestreamers to the user terminals of the viewers of the VSLC livestream, the video data being related to the LC livestream delivered by the second livestreamer. In the case of a group call LC livestream, the relay unit 1304 relays video data from the user terminal of the host of the group call LC livestream to the user terminals of the viewers of the group call LC livestream, the video data being related to the LC livestream delivered by the host. At the same time, the relay unit 1304 relays video data from the user terminal of the guest of the group call LC livestream to the user terminals of the viewers of the group call LC livestream, the video data being related to the LC livestream delivered by the guest.

The EC processing unit 1306 performs processing related to electronic commerce (e-commerce) in LC livestreams. The EC processing unit 1306 enables the viewers to purchase items for sale in LC livestreams. The EC processing unit 1306 performs processing related to a cart in LC livestreams. The EC processing unit 1306 may be realized by using known techniques as described in International Publication No. WO 2021/106034, Japanese Patent Application Publication No. 2019-109785, and “About Live Commerce”, SHOWROOM Inc, URL: https://support.showroom-live.com/hc/ja/articles/900006084866-% E3%83% A9% E3%82% A4% E3%83%96% E3%82% B3% E3%83%9E % E3%83% BC % E3%82% B9% E3%81% AB % E3%81% A4% E3%81%84% E3%81% A6.

On reception of a purchase request signal from any of the user terminals 1030 of the viewers of an LC livestream over the network NW, the EC processing unit 1306 performs an add-to-cart operation for an item for sale identified by the item for sale ID included in the received purchase request signal. The EC processing unit 1306 registers, in the sales history holding unit 1324, the addition to the cart of the item for sale identified by the item for sale ID included in the received purchase request signal.

The EC processing unit 1306 works with the user terminal 1030 of the viewer of the LC livestream to finalize the order for the item for sale in the cart and processes electronic payment for the order. Upon completion of the purchase of the item for sale, the EC processing unit 1306 sets the corresponding flag in the sales history holding unit 1324 to indicate that the purchase is completed.

The VS control unit 1308 may receive a VS setting request to request that a VSLC livestream be set from any of the user terminals 1020 of the livestreamers over the network NW and newly issue a VSIC. The VS setting request is designed to request that an invitation be sent to a designated competitor, the invitation being configured to invite the designated competitor to deliver a livestream together with the requesting livestreamer on the same screen. The VS control unit 1308 newly registers the target item for sale ID included in the VS setting request in the VS information holding unit 1320 in association with the issued VSID. The VS control unit 1308 selects as a metric the number of units sold or total sales and registers the metric in the corresponding entry in the VS information holding unit 1320. The number of units sold is selected if the VS setting request includes a single target item for sale ID, and the total sales is selected if the VS setting request includes a plurality of target item for sale IDs or a company ID. In other embodiments, the metric may be designated by the requesting livestreamer, the metric and target item for sale designated in an ongoing event or an event in which the requesting livestreamer participates may be used, or the metric may be designated by the administrator.

The VS control unit 1308 sends an invitation for a VSLC livestream to the user terminal 1020 of the livestreamer identified by the livestreamer ID of the competitor selected by the requesting livestreamer, which is included in the VS setting request. Sending an invitation for a VSLC livestream, and starting, keeping and controlling a VSLC livestream, which are performed by the VS control unit 1308, may be realized using the VS functionality techniques described in, for example, “How to use the ‘VS Function’!”, 17LIVE Corporation, URL: https://jp.17.live/userguide/19206/. If the invitation is accepted, the VS control unit 1308 registers the livestreamer ID of the requesting livestreamer and the livestreamer ID of the competitor who has accepted the invitation in the VS information holding unit 1320 in association with the above-mentioned VSID. Once the VSLC livestream starts, the VS control unit 1308 registers the start time as the period of time in the VS information holding unit 1320.

Upon detecting an operation to order the target item for sale via the LC livestream delivered by the first one of the livestreamers participating in the VSLC livestream, the VS control unit 1308 updates the value of the metric of the first livestreamer. If the metric is the number of units sold, the VS control unit 1308 updates the VS information holding unit 1320 upon completion of the purchase of the target item for sale added to the cart via the LC livestream delivered by a first one of the livestreamers participating in the VSLC livestream, such that the value of the metric of the first livestreamer increases by an amount corresponding to the purchased units of the target item for sale. If the metric is the total sales, the VS control unit 1308 updates the VS information holding unit 1320 such that the value of the metric of the first livestreamer increases by an amount corresponding to the purchased amount of the target item for sale. If an operation to order the target item for sale via the LC livestream delivered by the second one of the livestreamers participating in the VSLC livestream is detected, the VS information holding unit 1320 is updated in the same manner.

If a predetermined VS end criterion is satisfied, the VS control unit 1308 determines the winner of the competition based on the values of the metric of the livestreamers involved. The VS control unit 1308 ends the VSLC livestream upon elapse of a predetermined competition period (for example, 5 minutes) since the start of the VSLC livestream. The VS control unit 1308 refers to the VS information holding unit 1320 to identify and compare the values of the metric of the livestreamers at the end of the competition. The VS control unit 1308 deems one of the livestreamers having the larger value as the winner of the VSLC livestreamer. The VS control unit 1308 updates the user information holding unit 1318 such that the number of VS victories of the livestreamer who has won the VSLC livestream increases.

In the present embodiment, the VS end criterion is satisfied upon elapse of the competition period. The present embodiment, however, is not limited to such. For example, the VSLC livestream may end if the value of the metric of either one of the livestreamers participating in the VSLC livestream reaches a threshold value. Alternatively, the VSLC livestream may end at any time when one or both of the livestreamers participating in the VSLC livestream agree.

The group call control unit 1310 may receive a group call setting request to request that a group call LC livestream be set from any one of the user terminals 1020 of the livestreamers over the network NW and register in the livestreaming information holding unit 1314 the target item for sale ID included in the group call setting request in association with the livestreamer ID of the requesting livestreamer. This can result in associating the screen of the group call LC livestream with the target item for sale. The group call control unit 1310 also sets, to Y (indicating that the livestream is a group call), the flag indicating whether or not the livestream associated with the livestreamer ID of the requesting livestreamer is a group call.

The group call setting request is designed to request that an invitation be sent to a designated guest, the invitation being configured to invite the designated competitor to deliver a livestream together with the requesting livestreamer on the same screen. The group call control unit 1310 sends an invitation for a group call LC livestream to the user terminal 1020 of the livestreamer identified by the livestreamer ID of the guest selected by the requesting livestreamer, which is included in the group call setting request. Sending an invitation to a group call LC livestream and starting, keeping and controlling a group call LC livestream, which are performed by the group call control unit 1310, may be realized using the free group call functionality techniques described in, for example, “Free group call feature “Group Call” that allows up to 6 people to participate is finally available!, 17LIVE Corporation, URL: https://jp.17.live/news/11655/. If the invitation is accepted, the group call control unit 1310 updates the livestreaming information holding unit 1314 such that the livestreamer ID of the guest who has accepted the invitation is recorded as the guest ID associated with the livestreamer ID of the requesting livestreamer.

The leaderboard generating unit 1312 generates a leaderboard by ranking the livestreamers for each item for sale or each seller of items for sale based on the benchmark representing the volume of orders made for the item(s) for sale through their LC livestreams. The leaderboard generating unit 1312 generates a leaderboard by referring to the user information holding unit 1318 and sales history holding unit 1324, and registers the generated leaderboard in the leaderboard information holding unit 1326. The leaderboard generating unit 1312 periodically updates the leaderboard registered in the leaderboard information holding unit 1326. Upon reception of a leaderboard request from the user terminals 1020 and 1030, the leaderboard generating unit 1312 retrieves from the leaderboard information holding unit 1326 the information about the requested leaderboard and transmits the retrieved information to the requesting user terminals 1020 and 1030. Based on the received leaderboard information, the requesting user terminals 1020 and 1030 displays a screen showing the leaderboard on the display.

The examples of the benchmark used to generate the leaderboard include, in addition to the aforementioned ones, the total amount of orders received by the seller, the total amount of orders placed by the buyer, and the number of VS victories. The leaderboard generating unit 1312 calculates the value of the benchmark for each livestreamer by statistically processing the data held in the user information holding unit 1318 and sales history holding unit 1324 in a predetermined manner. The statistical processing performed to generate the leaderboard is known and not described in detail herein. The leaderboard generating unit 1312 ranks the livestreamers based on their values of the benchmark. The leaderboard generating unit 1312 registers in the leaderboard information holding unit 1326 the livestreamer IDs of the livestreamers in association with their ranks in the leaderboard.

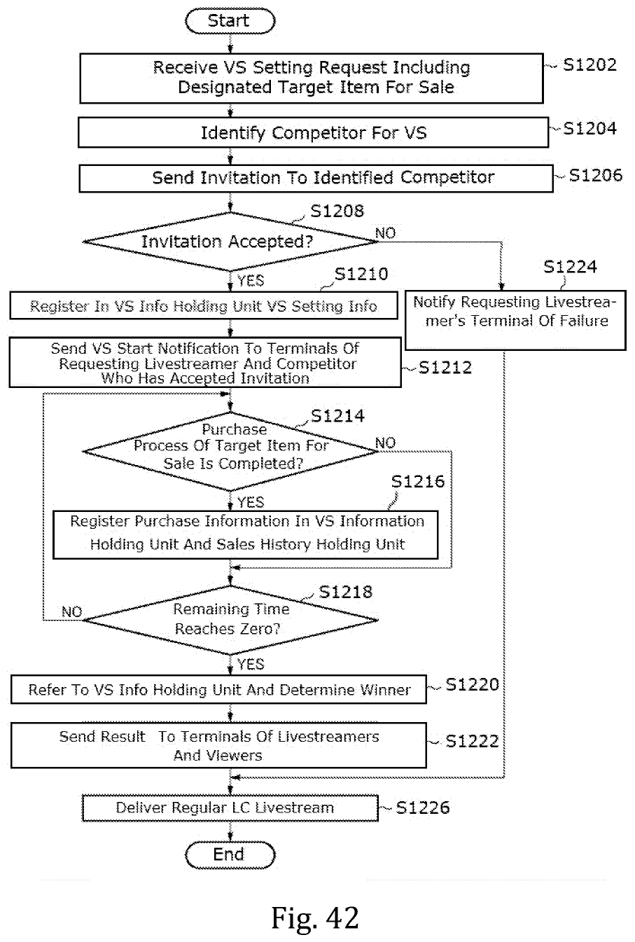

The operation of the live commerce system 1001 with the above configuration will be now described. FIG. 42 is a flowchart showing a series of steps performed for a VSLC livestream. While delivering an LC livestream or when starting an LC livestream, a livestreamer inputs into his/her user terminal a VSLC livestream setting instruction. The user terminal generates a VS setting request and sends the request to the LC server 1010 over the network NW. The LC server 1010 receives from the user terminal 1020 of the livestreamer via the network NW the VS setting request including designation of a target item for sale and a competitor (S1202). The LC server 1010 identifies the competitor designated in the received VS setting request as the competitor to compete against the requesting livestreamer in the VSLC livestream (S1204). The LC server 1010 sends an invitation to the identified competitor (S1206).

The LC server 1010 determines whether the invitation sent in the step S1206 is accepted or not (S1208). If the invitation is not accepted, e.g., gets rejected or expired (N in S1208), the LC server 1010 notifies the user terminal 1020 of the requesting livestreamer that an attempt to set a VSLC livestream has failed (S1224). The process thereafter proceeds to a step S1226, which will be described below. In the present embodiment, the livestreamer designates the competitor when requesting that the VSLC livestream be set. The present embodiment, however, is not limited to such. For example, the livestreamer may designate a plurality of possible competitors, and an invitation may be sent to the candidates in turn until accepted. Alternatively, the livestreamer may designate no competitor, and the LC server 1010 may determine the competitor randomly or according to a predetermined algorithm.

If the invitation is accepted in the step S1208 (Y in S1208), the LC server 1010 registers VSLC livestream setting information, i.e., the VSID, start time, target item for sale ID, metric, and livestreamer IDs of the two livestreamers who will compete, in the VS information holding unit 1320 (S1210). The LC server 1010 sends via the network NW a VS start notification to the user terminal 1020 of the requesting livestreamer, the user terminal of the competitor who has accepted the invitation, and the user terminal of the viewer of the VSLC livestream (S1212). The VS start notification includes the start time of the VSLC livestream designated by the LC server 1010. Upon receiving the VS start notification, the user terminals start displaying a simultaneous LC livestream screen for the VSLC livestream when the current time reaches the designated start time.

After the current time reaches the designated start time, the LC server 1010 updates the corresponding values of the metric held in the VS information holding unit 1320 for every operation performed to order the target item for sale via the LC livestreams delivered by the respective livestreamers. While the VSLC livestream is taking place, the LC server 1010 determines whether or not a purchase process is completed for the target item for sale (S1214). If the completion of the purchase process is not detected (N in S1214), the LC server 1010 determines whether the competition period of the VSLC livestream has elapsed (S1218). If the competition period is set to have a duration of five minutes, the LC server 1010 sets a timer to count the five minutes. The LC server 1010 starts counting down the timer when the VSLC livestream starts in the step S1212. The LC server 1010 determines whether the remaining time indicated by the timer has reached zero in the step S1218. If the competition period has not elapsed yet (N in S1218), the process returns to the step S1214. If the competition period has elapsed (Y in S1218), the process proceeds to a step S1220.

If the completion of the purchase process is detected in the step S1214 (Y in S1214), the LC server 1010 registers purchase information in the sales history holding unit 1324 and updates the values of the metric in the VS information holding unit 1320 based on the purchase information (S1216). The purchase information indicates the livestreamer delivering the LC livestream via which the target item for sale is added to the cart and the purchase process is completed, the number of units purchased for the target item for sale, and the total amount of the purchased units. The process thereafter proceeds to a step S1218.

If the remaining time reaches zero in the step S1218 (Y in S1218), the LC server 1010 refers to the VS information holding unit 1320 to determine the winner of the VSLC livestream (S1220). The LC server 1010 sends the result of the competition determined in the step S1220 to the user terminals of the livestreamers participating in the VSLC livestream and the user terminals of the viewers of the VSLC livestream (S1222). The LC server 1010 stops providing the VSLC livestream and registers the end time of the VSLC livestream in the VS information holding unit 1320. The LC server 1010 now provides regular LC livestreams to the viewers who has been watching the VSLC livestream (S1226). More specifically, the LC server 1010 refers to the livestreaming information holding unit 1314 to identify the LC livestream associated with each viewer and provides the identified LC livestream to the user terminal of each viewer (a regular LC livestream, not a VSLC livestream).

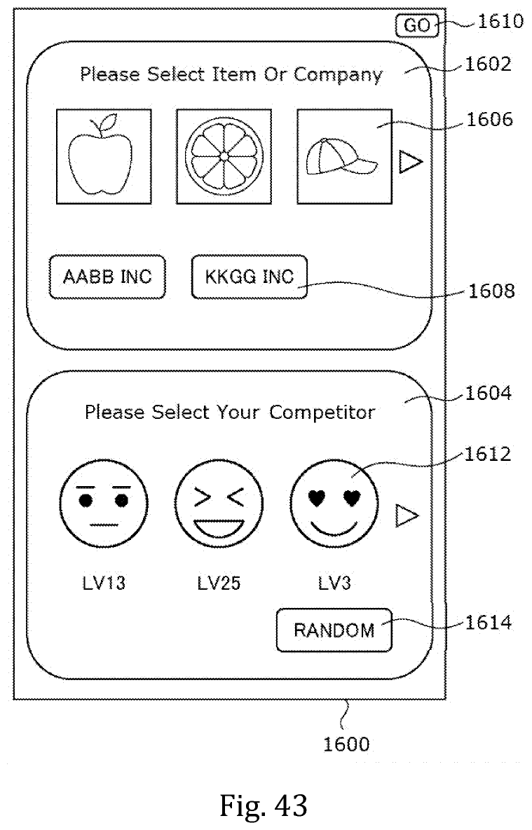

FIG. 43 is a representative screen image of a VSLC livestream setting screen 1600 displayed on the display of the user terminal of the livestreamer. The VSLC livestream setting screen 1600 has a target item for sale selection area 1602 for receiving a selection made by the livestreamer and indicting a target item for sale for a VSLC livestream, a competitor selection area 1604 for receiving a selection made by the livestreamer and indicating a competitor, and a GO button 1610. The target item for sale selection area 1602 has thumbnails 1606 indicating items for sales any of which can be selected as a target item for sale and objects 1608 representing companies any of which can be selected. In the target item for sale selection area 1602, one or more target items for sale can be selected. If any one of the objects 1608 representing companies is selected, one or more items for sale presented by the corresponding company on the LC platform are set as the target items for sale. The target item for sale selection area 1602 may be generated based on information obtained via the network NW from a holding unit (not shown) on the LC server 1010 that holds information about item for sales handled by the LC platform.

The competitor selection area 1604 has icons 1612 representing livestreamers any of which can be selected as the competitor, their names, and a random button 1614. In the competitor selection area 1604, a specific livestreamer can be selected as the competitor, or the random button 1614 may be tapped to allow the LC server 1010 to randomly determine the competitor.

The livestreamer can select a desired target item for sale in the target item for sale selection area 1602, select a desired competitor in the competitor selection area 1604, and tap the GO button 1610. On detecting a tap on the GO button 1610, the user terminal of the livestreamer generates a VS setting request including the target item for sales ID identifying the target item for sale selected in the target item for sale selection area 1602 and the livestreamer ID identifying the competitor selected in the competitor selection area 1604, and sends it via the network NW to LC server 1010. Upon reception of the VS setting request, the LC server 1010 sets up a VSLC livestream by, for example, sending an invitation as described above, and sends a VS start notification. At a time corresponding to the start time included in the VS start notification, the user terminal of the requesting livestreamer, the user terminal of the competitor, and the user terminals of the viewers all start displaying on the display the simultaneous LC livestream screen 1620 for the VSLC livestream.

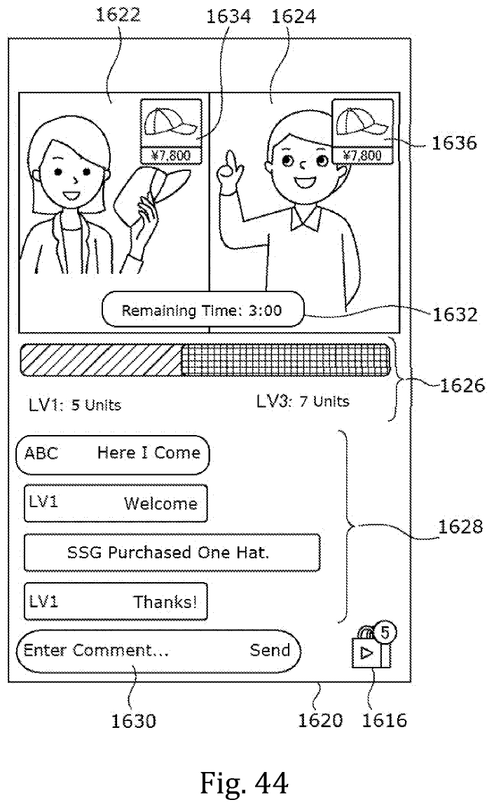

FIG. 44 is a representative screen image of the simultaneous LC livestream screen 1620 displayed on the display of any of the user terminals of the viewers of the VSLC livestream. The simultaneous LC livestream screen 1620 displays, in real time and in the same screen, the video images generated by the user terminals of the respective livestreamers participating in the VSLC livestream, and also receives orders for the target item for sale and visually displays who is winning. The simultaneous LC livestream screen 1620 has a first video display area 1622 displaying the video image of the LC livestream delivered by a first one of the two livestreamers participating in the VSLC livestream, a second video display area 1624 displaying the video image of the LC livestream delivered by a second one of the two livestreamers participating in the VSLC livestream, a remaining time display area 1632 indicating the remaining time of the competition period, a benchmark display area 1626 indicating the number of units sold for the target item for sale through the LC livestreams delivered by the respective livestreamers participating in the VSLC livestream, a comment display area 1628, a comment input area 1630, and a cart icon 1616. The simultaneous LC livestream screen 1620 displays the first and second video image display areas 1622 and 1624 in a predetermined layout. The first video image display area 1622 displays the video image obtained by reproducing the video data of the LC livestream delivered by the first livestreamer received from the LC server 1010. The second video image display area 1624 displays the video image obtained by reproducing the video data of the LC livestream delivered by the second livestreamer received from the LC server 1010.

The LC livestream delivered by the first livestreamer participating in the VSLC livestream and the LC livestream delivered by the second livestreamer participating in the VSLC livestream are both associated with the same target item for sale. Referring to the example in FIG. 44, the respective livestreamers treat the same “hat” as the target item for sale, and their video images respectively show icons 1634 and 1636 representing the target item for sale. The viewer watching the simultaneous LC livestream screen 1620 shown in FIG. 44 may be the viewer of the LC livestream delivered by the first livestreamer. In this case, the icon 1634 associated with the LC livestream delivered by the first livestreamer is configured as responsive to a tap, but the icon 1636 associated with the LC livestream delivered by the second livestreamer is configured as not responsive to a tap. On detecting a tap on the icon 1634, the user terminal of the viewer generates a purchase request signal including the viewer ID identifying the viewer who has tapped the icon 1634, the livestreamer ID of the first livestreamer, and the item for sale ID identifying the target item for sale, and sends it to the LC server 1010 via the network NW. On reception of the purchase request signal, the LC server 1010 performs the add-to-cart process as described above. The viewer watching the simultaneous LC livestream screen 1620 shown in FIG. 44 may be the viewer of the LC livestream delivered by the second livestreamer. In this case, the LC server 1010 similarly performs the add-to-cart process in response to a tap on the icon 1636. Accordingly, the icons 1634 and 1636 can be referred to as objects for ordering the item for sale.

According to the present embodiment, the livestreamers participating in the VSLC livestream present the same target item for sale. The present embodiment, however, is not limited to such. For example, the target item for sale presented by the first livestreamer participating in the VSLC livestream may be equivalent to but different from the target item for sale presented by the second livestreamer. In this case, when the VSLC livestream is set up, the competitor may be allowed to designate a desired target item for sale before accepting the invitation.

The benchmark display area 1626 shows the number of units sold by the first livestreamer and the number of units sold by the second livestreamer in association with each other. In the example in FIG. 44, the benchmark display area 1626 has a text indicating the number of units sold by each livestreamer and an object that visually displays the difference in the number of units sold. The user terminal of each viewer refers to the VS information holding unit 1320 of the LC server 1010 via the network NW to update the information indicated by the icons 1634 and 1636, remaining time display area 1632, and benchmark display area 1626.

The comment input area 1630 receives a comment input by the viewer. The viewer enters a comment in the comment input area 1630 and then taps the send button. On detection of the tap on the send button, the user terminal of the viewer generates a comment input signal including the comment entered in the comment input area 1630, and transmits the signal to the LC server 1010 over the network NW.

The comment display area 1628 can include comments entered by the viewers, comments entered by the livestreamers, and notifications from the system. The notifications from the system include messages indicating that the viewers have purchased the item for sale. The user terminal of the viewer generates the comment display area 1628 including comments that are received from the LC server 1010 and should be displayed.

The cart icon 1616 is an icon for realizing a transition to a screen that displays the target item for sale that has been placed in the cart. Via this screen, the viewer can proceed with a purchase procedure. The functions related to the cart and purchase procedure may be implemented using the known e-commerce technologies. The cart icon 1616 can be referred to as an object for ordering the target item for sale. The viewer watching the simultaneous LC livestream screen 1620 shown in FIG. 44 may be the viewer of the LC livestream delivered by the first livestreamer. In this case, on detection of a tap on the cart icon 1616 by the viewer, the user terminal of the viewer may finalize the order or complete the purchase of the target item for sale placed in the cart via the LC livestream delivered by the first livestreamer.

As the competition of the VSLC livestream proceeds and the remaining time reaches zero, the LC server 1010 determines the winner as described above and notifies the user terminals of the participants (livestreamers and viewers) in the VSLC livestream of the result of the competition. On receiving the result of the competition, the user terminals of the participants generate an object 1638 indicating the result and superimposes the object 1638 on the simultaneous LC livestream screen 1620.

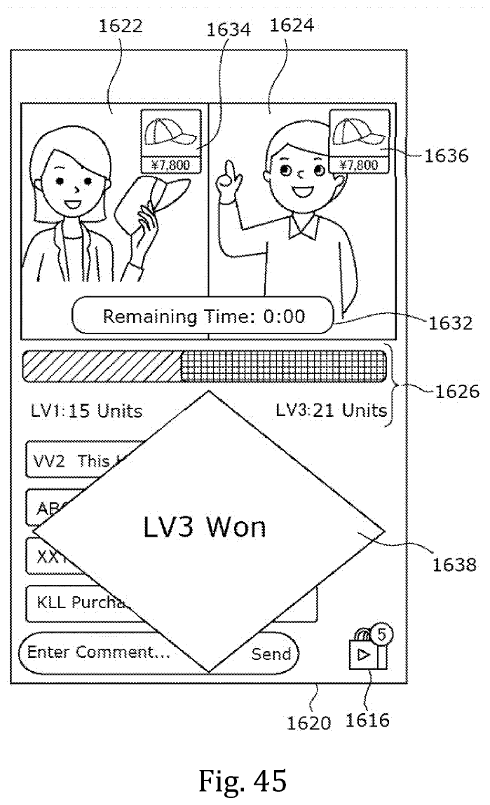

FIG. 45 is a representative screen image of the simultaneous LC livestream screen 1620 having the object 1638 indicating the result of the competition superimposed thereon, which appears on the display of the user terminal of the viewer of the VSLC livestream. FIG. 45 corresponds to the end of the competition period of the VSLC livestream shown in FIG. 44.

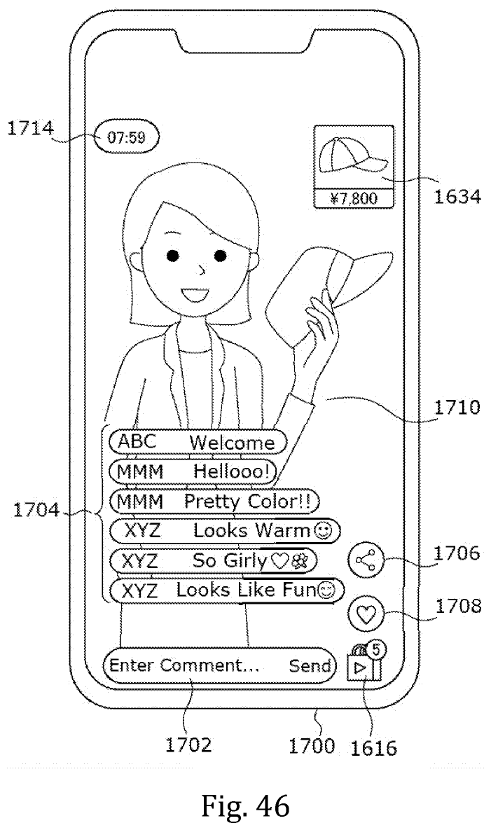

FIG. 46 is a representative screen image of an LC livestream screen 1700 appearing on the display of the user terminal of the viewer. As the competition of the VSLC livestream relating to the simultaneous LC livestream screen 1620 in FIG. 45 ends, the screen appearing on the display transitions from the simultaneous LC livestream screen 1620 in FIG. 45 to the LC livestream screen 1700 in FIG. 46. The LC livestream screen 1700 is a livestream screen showing the LC livestream delivered by one of the two livestreamers competing against each other in the VSLC livestream relating to the simultaneous LC livestream screen 1620 in FIG. 45 who is associated with the viewer watching the simultaneous LC livestream screen 1620 in FIG. 45. The LC livestream screen 1700 shows the video image 710 of the LC livestream delivered by the associated livestreamer but no longer shows the video image of the LC livestream delivered by the other livestreamer.

The LC livestream screen 1700 has a comment input area 1702, a comment display area 1704, a share button 1706, a heart button 1708, a video image 1710 of the livestreamer provided by playing back the video data received from the LC server 1010, an icon 1634 representing the item for sale, a time indicating area 1714 indicating the time into the LC livestream, and a cart icon 1616. The video image 1710 appearing on the LC livestream screen 1700 corresponds to the video image displayed in the video image display area of the associated livestreamer, from among the first and second video image display areas 1622 and 1624 appearing on the simultaneous LC livestream screen 1620 relating to the VSLC livestream.

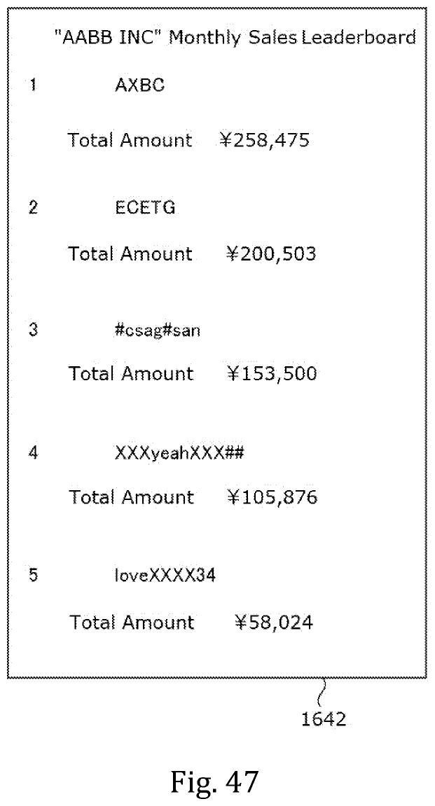

FIG. 47 is a representative screen image of a leaderboard display screen 1642 appearing on the display of the user terminal of any user. The user designates a desired leaderboard via the user terminal. The user terminal generates a leaderboard request including a leaderboard ID identifying the designated leaderboard and sends the request to the LC server 1010 over the network NW. The LC server 1010 acquires from the leaderboard information holding unit 1326 information about the leaderboard associated with the leaderboard ID included in the received leaderboard request. The LC server 1010 generates a leaderboard response including the acquired information about the leaderboard and transmits the response to the requesting user terminal over the network NW. Based on the received leaderboard response, the user terminal generates and shows the leaderboard display screen 1642 on the display. Referring to the example shown in FIG. 47, the leaderboard ranks livestreamers by the monthly total sales for items for sale available from a specific company. FIG. 47 shows, for example, that the livestreamer “AXBC” presents the products available from the company “AABB INC” as items for sale in his/her LC livestreams, and has sold a total amount of 258,475 yen since the beginning of the month, which ranks first by the sales of the products available from the company “AABB INC”.

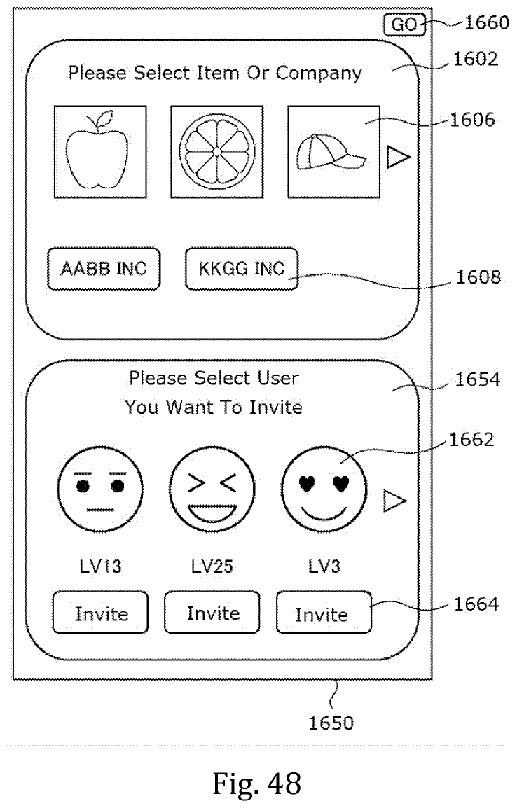

FIG. 48 is a representative screen image of a group call LC livestream setting screen 1650 appearing on the display of the user terminal of any livestreamer. The group call LC livestream setting screen 1650 has a target item for sale selection area 1602 for receiving a selection made by the host and indicting a target item for sale for a group call LC livestream, a guest selection area 1654 for receiving a selection made by the host and indicating a guest, and a GO button 1660.

The guest selection area 1654 has icons 1662 representing livestreamers available as guests, their names, and invite objects 1664. The host can select one or more livestreamers as guests by tapping invite objects 1664 corresponding to the desired one or more livestreamers in the guest selection area 1654.

The host is a livestreamer who can take orders for the target item for sale. The guest may be a livestreamer who is invited to support the host selling the target item for sale. The host can select a desired target item for sale in the target item for sale selection area 1602, select a desired guest in the guest selection area 1654, and tap the GO button 1660. On detecting the tap on the GO button 1660, the user terminal of the host generates a group call setting request including the target item for sales ID identifying the target item for sale selected in the target item for sale selection area 1602 and the livestreamer ID identifying the guest selected in the guest selection area 1654, and sends it via the network NW to LC server 1010. Upon reception of the group call setting request, the LC server 1010 sets up a group call LC livestream by, for example, sending an invitation to the user terminal of the guest as described above, and sends a group call start notification. On reception of the group call start notification, the user terminal of the requester or host, the user terminal of the guest, and the user terminal of the viewer all start displaying on the display a simultaneous LC livestream screen 1670 for the group call LC livestream.

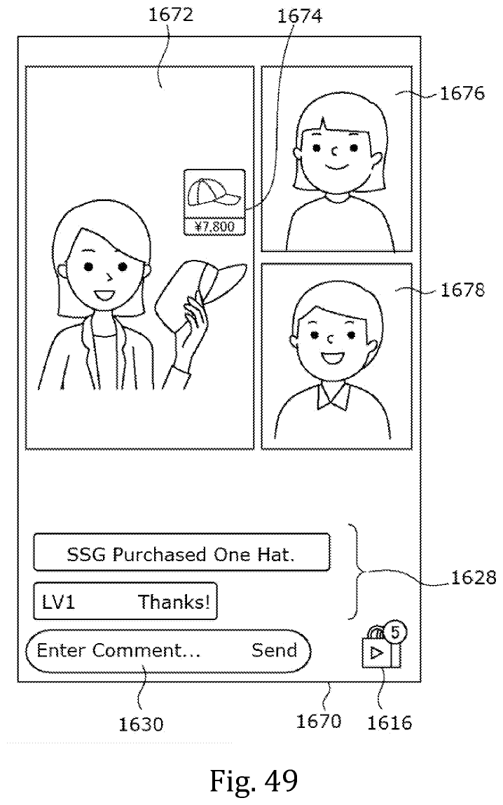

FIG. 49 is a representative screen image of the simultaneous LC livestream screen 1670 displayed on the display of the user terminal of the viewer of the group call LC livestream. The simultaneous LC livestream screen 1670 displays, in real time and in the same screen, the video images generated by the user terminals of the respective livestreamers participating in the group call LC livestream, and also receives orders for the target item for sale. The simultaneous LC livestream screen 1670 has a third video image display area 1672 displaying a video image of an LC livestream delivered by the host of the group call LC livestream, a fourth video image display area 1676 displaying a video image of an LC livestream delivered by the guest of the group call LC livestream, a fifth video image display area 1678, a comment display area 1628, a comment input area 1630, and a cart icon 1616. The simultaneous LC livestream screen 1670 displays the third, fourth and fifth video image display areas 1672, 1676 and 1678 in a predetermined layout. The third video image display area 1672 displays the video image provided by reproducing the video data received from the LC server 1010 and generated by the user terminal of the host. The fourth and fifth video display areas 1676 and 1678 respectively display the video images provided by reproducing the video data received from the LC server 1010 and generated by the user terminals of the respective guests.

The group call LC livestream is associated with the target item for sale designated by the host on the group call LC livestream setting screen 1650. Referring to the example in FIG. 49, the host treats the “hat” as the target item for sale, and his/her video image shows an icon 1674 representing the target item for sale. On detecting a tap on the icon 1674, the user terminal of the viewer generates a purchase request signal including the viewer ID identifying the viewer who has tapped the icon 1674, the livestreamer ID of the host, and the item for sale ID identifying the item for sale, and sends it to the LC server 1010 via the network NW. On reception of the purchase request signal, the LC server 1010 performs the add-to-cart process as described above. Accordingly, the icon 1674 can be referred to as an object for ordering the item for sale.

In the above embodiment, the holding units are a hard disk or semiconductor memory, for example. It is understood by those skilled in the art that each element or component can be realized by a CPU not shown, a module of an installed application program, a module of a system program, or a semiconductor memory that temporarily stores the contents of data read from a hard disk, and the like.

The live commerce system 1001 relating to the present embodiment can provide simultaneous LC livestreams in which a plurality of livestreamers participate to present and take orders for items for sale. The livestreamers may talk about the items for sale or compete against each other for the volume of orders for the items for sale. This can result in boosting the sales of items for sale through live commerce. By cooperating with or competing against each other for the sales of items for sale, the livestreamers may motivate themselves to sell the items for sale. The viewers can see the livestreamers presenting and elaborating the items for sale in a single livestream, which can improve their satisfaction through the shopping experience.

The live commerce system 1001 relating to the present embodiment can provide opportunities of sales competition between influencers, who have a significant impact on sales of goods and services. Two influencers may compete for the same item for sale in a VSLC livestream. The synergy between them can increase the sales. The influencers can also exploit the VSLC livestream. Competing against each other for sales of goods and services, the influencers can get more excited than when they individually deliver LC livestreams for selling the goods and services, thereby achieving improved sales.

In the present embodiment, the item for sale to be presented in the simultaneous LC livestreaming can be directly designated. In addition, a particular company or brand can be also designated. For this feature, companies can see more advantages in employing the live commerce system 1001. The administrator of the LC platform can plan events and measures featuring particular companies and brands. Such events and measures may include an event where a livestreamer is offered a chance to get a special product from a brand if he/she achieves the highest sales of the brand's products in a month.

The live commerce system 1001 relating to the present embodiment can provide a group call LC livestream where the host may talk with the guest about the item for sale. Thus, the viewer can know more about the item for sale. The host may invite as the guest a livestreamer who likes the item for sale, so that the host can less intentionally draw the viewer's attention to the good points of the item for sale. The host may let the guest use the item for sale in the livestream and talk what the guest thinks about the item for sale. This can communicate an objective opinion about the item for sale to the viewer.

While the host and guest talk, the guest may mention a certain item for sale as his/her favorite. The host may offer a coupon for the item for sale to the viewer in the same livestream. The guest may talk the host into giving a coupon. This is what makes livestreams special. Real-time interaction can give rise to dynamic responses.

The information processing device 900 illustrated in FIG. 21 may, for example, realize the LC server 1010 and the user terminals 1020 and 1030 in the present embodiment.

The configuration and operation of the live commerce system 1001 according to the second embodiment have been described above. This embodiment is merely an example, and it will be understood by those skilled in the art that various modifications are possible by combining the respective components and processes, and that such modifications are also within the scope of the present disclosure.

In the embodiments, digital prizes (e.g., comment frames, badges, etc.) may be awarded to livestreamers who have metric values exceeding a predetermined threshold in events and leaderboards (e.g., livestreamers who finish in the top ten places). Digital prizes may be also awarded to livestreamers who win VSLC livestreams.

According to the embodiments, the leaderboard ranks the livestreamers. The embodiments, however, are not limited to such. and the leaderboard may rank the viewers by the volume of orders for the items for sale. The benchmark to rank the viewers may include the total amount of purchases or number of units purchased for a specific item for sale or company, or for all items for sale.

The procedures described herein, particularly those described with a flow diagram or a flowchart, are susceptible of omission of part of the steps constituting the procedure, adding steps not explicitly included in the steps constituting the procedure, and/or reordering the steps. The procedure subjected to such omission, addition, or reordering is also included in the scope of the present disclosure unless diverged from the purport of the present invention.

At least some of the functions realized by the server may be realized by a device(s) other than the server, for example, the user terminals. At least some of the functions realized by the user terminals may be realized by a device(s) other than the user terminals, for example, the server. For example, there may be a server having the LC functions of the LC server and another server having the remaining functions of the LC server.

The technical ideas relating to the second embodiment may be represented by the following items.

### <Item 1>

A computer program for causing a terminal to realize a function of displaying on a display a livestream screen including:
a first area displaying a video image of a first livestream associated with a first item for sale;
a second area displaying a video image of a second livestream associated with a second item for sale that is same as or equivalent to the first item for sale;
a third area displaying a first benchmark and a second benchmark in association with each other, the first benchmark indicating a volume of orders placed for the first item for sale via the first livestream, the second benchmark indicating a volume of orders placed for the second item for sale via the second livestream; and
an object for ordering the first or second item for sale.

### <Item 2>

The computer program of item 1, wherein, if a viewer watches the first livestream on the terminal, further causing the terminal to realize a function of performing an operation to order the first item for sale on detection of that the viewer designates the object.

### <Item 3>

The computer program of item 2, further causing the terminal to implement functions of:
starting to display the livestream screen on the display at a predetermined time;
displaying, if a predetermined end condition is satisfied, on the display a result of a competition determined based on the first and second benchmarks,
wherein, after the predetermined time, the first benchmark is updated every time an operation is performed to order the first item for sale via the first livestream, and
wherein, after the predetermined time, the second benchmark is updated every time an operation is performed to order the second item for sale via the second livestream.

### <Item 4>

The computer program of item 3, further causing the terminal to implement a function of
displaying, if the competition related to the livestream screen ends, on the display another livestream screen that shows the video image of the first livestream but does not show the video image of the second livestream.

### <Item 5>

A server including:
a unit for relaying video data relating to a first livestream associated with a first item for sale from a first livestreamer terminal to a viewer terminal and relaying video data related to a second livestream associated with a second item for sale that is same as or equivalent to the first item for sale from a second livestreamer terminal to the viewer terminal;
a unit for updating a first benchmark if an operation to order the first item for sale via the first livestream is detected and updating a second benchmark if an operation to order the second item for sale via the second livestream is detected; and
a unit for determining, if a predetermined end condition is satisfied, a result of a competition based on the first and second benchmarks.

### <Item 6>

A computer program for causing a terminal to implement a function of displaying on a display a livestream screen including:
a first area displaying a plurality of video images of a plurality of livestreamers in a predetermined layout; and
an object for ordering an item for sale.

### <Item 7>

The computer program of item 6, wherein one of the livestreamers is a livestreamer to take an order for the item for sale.

### <Item 8>

A server including:
a unit for receiving a request, from a terminal of a livestreamer over a network, to request that an invitation is to be transmitted to another livestreamer to allow the other livestreamer and the livestreamer to deliver a livestream together via a same screen; and
a unit for designating an item for sale associated with the same screen.

### <Item 9>

A server including:
a unit for delivering a livestream associated with an item for sale; and
a unit for generating a leaderboard based on a benchmark indicating a volume of orders for an item for sale via a livestream by ranking livestreamers for each item for sale or each seller of an item for sale.

What is claimed is:

1. A server for providing a livestream where a livestreamer presents and takes an order for an item for sale and receives a gift from a viewer, the server comprising a circuitry configured to
enable a viewer to use a special gift different from a regular gift on condition that the viewer performs an operation to order an item for sale.

2. The server of claim 1, wherein the special gift has a higher rate of return to the livestreamer than the regular gift.

3. The server of claim 1, wherein the circuitry is further configured to, upon receiving an instruction to use the special gift from the viewer, grant to the viewer a coupon available for an item for sale presented in a livestream.

4. The server of claim 3, wherein the circuit is configured to randomly select one of a plurality of coupons offering different discounts and grant the selected coupon.

5. A server of a livestream system where a first livestream and a second livestream are delivered by a same livestreamer at different times, the first livestream being designed to present and take an order for an item for sale, the first and second livestreams being different from each other, the server comprising a circuitry configured to
grant to a viewer, in either the first or second livestream, a digital item that is available in the other livestream.

6. The server of claim 5, wherein the circuitry is configured to grant, on condition that a viewer performs an operation to order an item for sale in the first livestream, a gift available in the second livestream to the viewer.

7. The server of claim 6, wherein the gift granted to the viewer of the first livestream is configured such that the gift is allowed to be used only in the second livestream delivered by the livestreamer who delivers the first livestream.

8. The server of claim 6, wherein the gift granted to the viewer of the first livestream is configured such that the gift is never obtained by a viewer of the second livestream in the second livestream delivered by the livestreamer who delivers the first livestream.

9. The server of claim 6, wherein impressiveness of the gift granted to the viewer increases in proportion to a price of the item for sale ordered.

10. The server of claim 6, wherein the circuitry is further configured to generate a leaderboard that ranks livestreamers by a volume of gifts received by the livestreamers from viewers of the first livestream to whom the gifts are granted.

11. The server of claim 5, wherein the circuitry is configured to grant, in the second livestream to a viewer of the second livestream, a coupon available for an item for sale presented in the first livestream delivered by the livestreamer who delivers the second livestream.

12. The server of claim 11, wherein a discount offered by the coupon granted to the viewer increases in proportion to a level of interaction between the livestreamer and the viewer in the second livestream.

13. A method for a livestream system where a first livestream and a second livestream are delivered by a same livestreamer at different times, the first livestream being designed to present and take an order for an item for sale, the first and second livestreams being different from each other, the method comprising
granting to a viewer, in either the first or second livestream, a digital item that is available in the other livestream.

14. The method of claim 13, wherein the granting includes granting, on condition that a viewer performs an operation to order an item for sale in the first livestream, a gift available in the second livestream to the viewer.

15. The method of claim 14, wherein the gift granted to the viewer of the first livestream is configured such that the gift is allowed to be used only in the second livestream delivered by the livestreamer who delivers the first livestream.

16. The method of claim 14, wherein the gift granted to the viewer of the first livestream is configured such that the gift is never obtained by a viewer of the second livestream in the second livestream delivered by the livestreamer who delivers the first livestream.

17. The method of claim 14, wherein impressiveness of the gift granted in the granting to the viewer increases in proportion to a price of the item for sale ordered.

18. The method of claim 14, further comprising generating a leaderboard that ranks livestreamers by a volume of gifts received by the livestreamers from viewers of the first livestream to whom the gifts are granted.

19. The method of claim 13, wherein the granting includes granting, in the second livestream to a viewer of the second livestream, a coupon available for an item for sale presented in the first livestream delivered by the livestreamer who delivers the second livestream.

20. The method of claim 19, wherein a discount offered by the coupon granted to the viewer increases in proportion to a level of interaction between the livestreamer and the viewer in the second livestream.
